(19) United States
(12) Patent Application Publication
(10) Pub. No.: US 2016/0143080 A1
(43) Pub. Date: May 19, 2016

(54) COMMUNICATION CONTROL METHOD, TERMINAL DEVICE, AND BASE STATION APPARATUS

(71) Applicant: SHARP KABUSHIKI KAISHA, Osaka (JP)

(72) Inventors: MASAYUKI ENOMOTO, OSAKA (JP); MASAFUMI ARAMOTO, OSAKA (JP)

(73) Assignee: SHARP KABUSHIKI KAISHA, OSAKA (JP)

(21) Appl. No.: 14/903,260

(22) PCT Filed: Jun. 30, 2014
(86) PCT No.: PCT/JP2014/067356

§ 371 Date: Jan. 6, 2016

(30) Foreign Application Priority Data
Jul. 9, 2013 (JP) 2013-143425

(51) Int. Cl. H04W 76/02; H04W 8/00; H04W 72/08

(52) U.S. Cl. CPC H04W 76/023; H04W 72/085; H04W 8/005

(57) ABSTRACT

There is provided a communication control method of a first terminal device for causing the first terminal device and a second terminal device positioned in the proximity of the first terminal device to establish a direct communication path. The communication control method includes: a step of monitoring a signal which is transmitted from the second terminal device so as to allow a proximity terminal device to discover the second terminal device; a step of receiving the signal to detect that the second terminal device is positioned in proximity; a step of acquiring coverage information which is included in the signal and indicates whether or not the second terminal device is served in a LTE base station; and a step of detecting whether or not the second terminal device is served based on the coverage information.

### TECHNICAL FIELD

The present invention relates to a mobile communication system that includes a communication control method, a terminal device, and a base station apparatus.

The present application claims priority to Japanese Patent Application No. 2013-143425 filed in the Japanese Patent Office on Jul. 9, 2013, the disclosure of which is herein incorporated by reference in its entirety.

### BACKGROUND ART

In the 3GPP (the 3rd Generation Partnership Project) which is the standardization organization for a mobile communication system, the specifications for an EPS (Evolved Packet System) described in NPL 1 as a next-generation mobile communication system have been developed, and a wireless LAN (WLAN) as well as LTE (Long Term Evolution) has been examined as an access system connected to the EPS.

In the 3GPP, as described in NPL 2, a proximity service (proximity-based service, ProSe) in which it is discovered that user equipments (UEs) are in proximity or communication is performed by establishing a direct communication path between the proximity UEs has been examined. Here, the communication path between the UEs in the related art is established via a base station to which the UEs are connected and a core network to which the base station is connected, whereas the direct communication path between the UEs in the ProSe is a communication path capable of directly transmitting and receiving data without using the base station or the core network between the proximity UEs.

In the ProSe, since communication can be performed without using an access network including a LTE base station or a WLAN base station or a core network to which the access network is connected, it is possible to expect an offload effect (congestion avoidance) of avoiding the traffic concentration of the access network or the core network.

In the ProSe, two methods using the direct communication path between the UEs have been examined. One method is a method of establishing the direct communication path between the UEs by using a LTE access technology (hereinafter, referred to as LTE Direct), and the other method is a method of establishing the direct communication path by using a wireless LAN access technology.

In the ProSe, in order to transmit and receive data through the LTE Direct or the WLAN Direct, the necessity for the UE to search for a communication target UE and detect that the communication target UE is present in proximity is used as a service requirement.

In order for the direct communication between the UEs to serve as a service provided by a mobile communication provider, the direct communication between the UEs is defined as requiring an approval of the mobile communication provider at the time of searching for the communication target UE.

As mentioned above, the ProSe is used to define a communication service in which the proximity UE is discovered and communication is performed by establishing the direct communication path between the proximity UEs.

In the ProSe, non-Public Safety and Public Safety are defined. In the non-Public Safety, a commercially available service provided by the mobile communication provider is assumed, and can be used in only a case where the UE is served in the LTE base station. Meanwhile, in the Public Safety, the use of a disaster prevention wireless system is assumed, and can be also used in a case where the UE is not served in the LTE base station (eNB) in addition to the case where the UE is served in the LTE base station.

That is, in LTE Direct, there are a method of directly transmitting and receiving data between the UEs by using a LTE communication technology in the commercially available service (non-Public Safety), and a method of directly transmitting and receiving data between the UEs by using the LTE communication technology in the Public Safety.

In WLAN Direct, there is a method of directly transmitting and receiving data between the UEs by using a WLAN communication technology in the commercially available service, and there is a possibility that data will be directly transmitted and received between the UEs by using the WLAN communication technology in the Public Safety.

### CITATION LIST

### Patent Literature

### Non Patent Literature

NPL 1: 3GPP TS23.401 Technical Specification Group Services and System Aspects, General Packet Radio Service (GPRS) enhancements for Evolved Universal Terrestrial Radio Access Network (e-UTRAN) access
NPL 2: 3GPP TR22.803 Technical Specification Group Services and System Aspects, Feasibility study for Proximity Services (ProSe)

### SUMMARY OF INVENTION

### Technical Problem

In order to determine whether or not to use the non-Public Safety, it is necessary to detect that a communication source UE and a communication destination UE are served in the LTE base station. In order to determine whether or not to use the Public Safety, it is necessary to detect that the communication source UE or the communication destination UE is not served in the LTE base station. Since the non-Public Safety can be used only in the case where the communication source UE and the communication destination UE are served in the eNB, a communication path establishment procedure of establishing the communication path based on the network authentication has been examined. Meanwhile, since the Public Safety can be used in the case where the communication source UE or the communication destination UE is not served in the eNB, a communication path establishment procedure of establishing the communication path without obtaining the authentication from the network whenever the communication is established has been examined. As stated above, in the communication path establishment procedure in the non-Public Safety and the communication path establishment in the Public Safety, there has been examined that different procedures are used.

Here, in order to detect that the UE is served in the LTE base station, it is necessary to detect that the communication source UE is served in the LTE base station and the communication destination UE is served in the LTE base station. The communication source UE may be served in the LTE base station or may not be served in the LTE base station. The communication destination UE may be served in the LTE base station or may not be served in the LTE base station. That is, the states of the communication source UE and the communication destination UE are changed to four states of one state in which the communication source UE is served in the LTE base station and the communication destination UE is served in the LTE base station, one state in which the communication source UE is not served in the LTE base station and the communication destination UE is served in the LTE base station, one state in which the communication source UE is served in the LTE base station and the communication destination UE is not served in the LTE base station, and one state in which the communication source UE is not served in the LTE base station and the communication destination UE is not served in the LTE base station.

As described above, it is necessary to detect that the states of these UEs correspond to any one of the four states by detecting the communication source UE is served in the LTE base station and the communication destination UE is served in the LTE base station.

However, how to determine whether or not the communication source UE is served in the LTE base station or the communication destination UE is served in the LTE base station and how the UEs use determination information indicating that the communication source UE or communication destination UE is served in the LTE base station are not apparent.

More specifically, a method of detecting that the communication source UE or the communication destination UE is served in the LTE base station or a method of using information indicating that the communication source UE or the communication destination UE is served in the LTE base station are not apparent. Since there is no specific implementation means for such a problem, it is difficult to start the communication path establishment procedure for performing the direct communication between the communication source UE and the communication destination UE, and it is difficult to use a ProSe service.

In the case where the communication source UE is served in the LTE base station and the communication destination UE is served in the LTE base station, the communication source UE and the communication destination UE are not able to perform the communication path establishment procedure based on the network authentication. In the case where the communication source UE is not served in the LTE base station and the communication destination UE is served in the LTE base station, the communication source UE and the communication destination UE are not able to perform the communication path establishment procedure based on the network authentication. In the case where the communication source UE is served in the LTE base station and the communication destination UE is not served in the LTE base station, the communication source UE and the communication destination UE are not able to perform the communication path establishment procedure based on the network authentication. In the case where the communication source UE is not served in the LTE base station and the communication destination UE is not served in the LTE base station, the communication source UE and the communication destination UE are not able to perform the communication path establishment procedure without obtaining the authentication from the network whenever the communication path is established.

The present invention has been made in view of such circumstances, and an object of the present invention is to provide a mobile communication system which detects that a UE is served in a LTE base station in ProSe and uses information indicating that the UE is served in LTE.

### Solution to Problem

In order to achieve the above-described object, according to a first aspect of the present invention, there is provided a communication control method of a first terminal device for causing the first terminal device and a second terminal device which is positioned in the proximity of the first terminal device to establish a direct communication path. The communication control method includes: a step of monitoring a signal which is transmitted from the second terminal device so as to allow a proximity terminal device to discover the second terminal device; a step of receiving the signal to detect that the second terminal device is positioned in proximity; a step of acquiring coverage information which is included in the signal and indicates whether or not the second terminal device is served in a LTE base station; and a step of detecting whether or not the second terminal device is served based on the coverage information.

According to a second aspect of the present invention, the communication control method described in the first aspect may further include: a step of transmitting an establishment request for the direct communication path including information for requesting the acquisition of a resource of the direct communication path to the second terminal device, in a case where it is detected that the second terminal device is served based on the coverage information.

According to a third aspect of the present invention, in a case where it is detected that the second terminal device is not served based on the coverage information, the communication control method described in the first aspect may further include a step of transmitting an establishment request for the direct communication path to the second terminal device; and a step of transmitting a request for a resource of the direction communication path to the LTE base station.

According to a fourth aspect of the present invention, in a case where it is detected that the second terminal device is not served based on the coverage information, the control method described in the first aspect may further include a step of transmitting an establishment request for the direct communication path to the second terminal device; and a step of transmitting a request for a resource of the direction communication path to a core network to which the serving LTE base station is connected.

According to a fifth aspect of the present invention, the communication control method described in the first aspect may further include: a step of discovering whether or not the first communication terminal is served in the LTE base station. In a case where it is detected that both the first communication terminal and the second terminal device are not served, the communication control method may further include: a step of assigning a resource previously retained in the first terminal device to the direct communication path; and a step of transmitting an establishment request for the direct communication path including information related to the resource to the second terminal device.

According to a sixth aspect of the present invention, the communication control method described in any one of the first to fifth aspects may further include: a step of transmitting a signal for allowing a proximity terminal device to discover the first terminal device.

According to a seventh aspect of the present invention, in the communication control method described in any one of the first to sixth aspects, the request for the establishment of the direct communication path may indicate that a direct communication path based on LTE is to be established.

According to an eighth aspect of the present invention, in the communication control method described in any one of first to sixth aspects, the request for the establishment of the direct communication path may indicate that a direct communication path based on a wireless LAN is to be established.

According to a ninth aspect of the present invention, there is provided a terminal device that is a first terminal device establishing a direct communication path with a second terminal device positioned in the proximity of the first terminal device. The first terminal device is adapted to: monitor a signal which is transmitted from the second terminal device to allow a proximity terminal device to discover the second terminal device; receive the signal to detect that the second terminal device is positioned in proximity; acquire coverage information which is included in the signal and indicates whether or not the second terminal device is served in a LTE base station; and detect whether or not the second terminal device is served based on the coverage information.

According to a tenth aspect of the present invention, in the terminal device described in the ninth aspect, in a case where it is detected that the second terminal device is served based on the coverage information, the first terminal device may be adapted to transmit an establishment request for the direct communication path including information for requesting the acquisition of a resource of the direct communication path to the second terminal device.

According to an eleventh aspect of the present invention, in the terminal device described in the ninth aspect, in a case where it is detected that the second terminal device is not served based on the coverage information, the first terminal device may be adapted to: transmit an establishment request for the direct communication path to the second terminal device; and transmit a request for a resource of the direct communication path to the LTE base station.

According to a twelfth aspect of the present invention, in the terminal device described in the ninth aspect, in a case where it is detected that the second terminal device is not served based on the coverage information, the first terminal device may be adapted to: transmit an establishment request for the direct communication path to the second terminal device; and transmit a request for a resource of the direct communication path to a core network to which the serving LTE base station is connected.

According to a thirteenth aspect of the present invention, in the terminal device described in the ninth aspect, the first terminal device may be adapted to: detect whether or not the first communication terminal is served in a LTE base station. In a case where it is detected that the first terminal device and the second terminal device are not served, the first communication terminal may be adapted to: assign a resource previously retained in the first terminal device to the direct communication path; and transmit an establishment request for the direct communication path including information related to the resource to the second terminal device.

According to a fourteenth aspect of the present invention, in the terminal device described in any one of the ninth to thirteenth aspects, the first terminal device may be adapted to transmit a signal for allowing a proximity terminal device to detect the first terminal device.

According to a fifteenth aspect of the present invention, in the terminal device described in any one of the ninth to fourteenth aspects, the request for establishing the direct communication path may indicate that a direct communication path based on LTE is to be established.

According to a sixteenth aspect of the present invention, in the terminal device described in any one of described in any one of the ninth to fourteenth aspects, the request for establishing the direct communication path may indicate that a direct communication path based on a wireless LAN is to be established.

According to a seventeenth aspect of the present invention, there is provided a base station apparatus included in a LTE access network. The base station apparatus is adapted to: manage a communication resource used for public safety and a communication resource used for commercially available service; assign a communication resource based on identification information which is included in a message which is transmitted from a terminal device to request the permission for the establishment of the direct communication path and identifies whether or not to request the permission for the establishment of a communication path used for the public safety or whether or not to request the permission for the establishment of a communication path used for the commercially available service; and notify the terminal device of information related to the communication resource.

According to an eighteenth aspect of the present invention, in the base station apparatus described in the seventeenth, in a case where the identification information requests the establishment of the communication path used for the public safety, the base station apparatus may be adapted to assign a resource from the communication resource used for the public safety, and notify the terminal device of information related to the resource.

According to a nineteenth aspect of the present invention, in the base station apparatus described in the seventeenth aspect, in a case where the identification information requests the establishment of the communication path used for the commercially available service, the base station apparatus may be adapted to assign a resource from the communication resource used for the commercially available service, and notify the terminal device of information related to the resource.

### Advantageous Effects of Invention

According to the aspects of the present invention, it is possible to detect that a communication source UE and a communication destination UE are served in a LTE base station. In a case where the communication source UE or the communication destination UE is served in the LTE base station, it is possible to perform a communication path establishment procedure under the control of a mobile communication provider.

In a case where the communication source UE and the communication destination UE are not served in the LTE base station, it is possible to perform the communication path establishment procedure without obtaining the authentication of the mobile communication provider whenever a communication path is established.

### BRIEF DESCRIPTION OF DRAWINGS

FIG. 1 is a diagram for describing the outline of a mobile communication system 1 according to a first embodiment.

FIG. 2 is a diagram for describing the structure of an IP mobile communication network.

FIG. 3 is a diagram for describing a functional structure of a UE according to the first embodiment.

FIG. 4 is a diagram showing an example of a functional structure managed in a storage unit of the UE.

FIG. 5 is a diagram for describing a functional structure of a ProSe server.

FIG. 6 is a diagram for describing an example of a functional structure managed in a storage unit of the ProSe server.

FIG. 7 is a diagram for describing a functional structure of an APP server.

FIG. 8 is a diagram for describing an example of a functional structure managed in a storage unit of the APP server.

FIG. 9 is a diagram for describing a notification procedure of coverage information and proximity discovery according to the first embodiment.

FIG. 10 is a diagram for describing four states of the coverage information according to the first embodiment.

FIG. 11 is a diagram for describing a communication path establishment procedure according to the first embodiment.

FIG. 12 is a diagram for describing a communication path establishment procedure according to the first embodiment.

FIG. 13 is a diagram for describing a communication path establishment procedure according to the first embodiment.

FIG. 14 is a diagram for describing a communication path establishment procedure according to the first embodiment.

FIG. 15 is a diagram for describing a network authentication procedure according to the first embodiment.

FIG. 16 is a diagram for describing a direct communication termination-side procedure according to the first embodiment.

FIG. 17 is a diagram for describing a notification procedure of coverage information and proximity discovery according to a second embodiment.

FIG. 18 is a diagram for describing a functional structure of a UE according to a third embodiment.

FIG. 19 is a diagram showing an example of a functional structure managed in a storage unit of the UE according to the third embodiment.

FIG. 20 is a diagram for describing a functional structure of a ProSe server according to the third embodiment.

FIG. 21 is a diagram for describing an example of a functional structure managed in a storage unit of the ProSe server according to the third embodiment.

FIG. 22 is a diagram for describing a notification procedure of coverage information and proximity discovery according to the third embodiment.

FIG. 23 is a diagram for describing a notification procedure of coverage information and proximity discovery according to the third embodiment.

FIG. 24 is a diagram for describing a notification procedure of coverage information and proximity discovery according to the third embodiment.

FIG. 25 is a diagram for describing the outline of a mobile communication system 1 according to a fourth embodiment.

FIG. 26 is a diagram for describing a notification procedure of coverage information and proximity discovery according to the fourth embodiment.

FIG. 27 is a diagram for describing a notification procedure of coverage information and proximity discovery according to a fifth embodiment.

### DESCRIPTION OF EMBODIMENTS

Hereinafter, embodiments for implementing the present invention will be described with reference to the drawings.

For example, in the present embodiment, embodiments of a mobile communication system to which the present invention is applied will be described in detail with reference to the drawings. In ProSe, there are non-Public Safety and Public Safety. In the non-Public Safety, a commercially available service provided by a mobile communication provider is assumed, and can be used in only a case where a UE is served in a LTE base station. Meanwhile, in the Public Safety, the use of a disaster prevention wireless system is assumed, and can be also used in a case where the UE is not served in the LTE base station (eNB) in addition to the case where the UE is served in the LTE base station.

In LTE Direct, data can be directly transmitted and received between UEs by using a LTE communication technology in the commercially available service (non-Public Safety), and data can be directly transmitted and received between the UEs by using the LTE communication technology in the Public Safety.

In WLAN Direct, there is a method of directly transmitting and receiving data between the UEs by using a WLAN communication technology in the commercially available service, and there is a possibility that data will be directly transmitted and received between the UEs by using the WLAN communication technology in the Public Safety.

### 1. First Embodiment

It will be described that the UE being served in a LTE base station apparatus is referred to as in coverage and the UE not being served in the LTE base station apparatus is referred to as out of coverage. Initially, a first embodiment to which the present invention is applied will be described with reference to the drawings.

### 1.1 Outline of Mobile Communication System

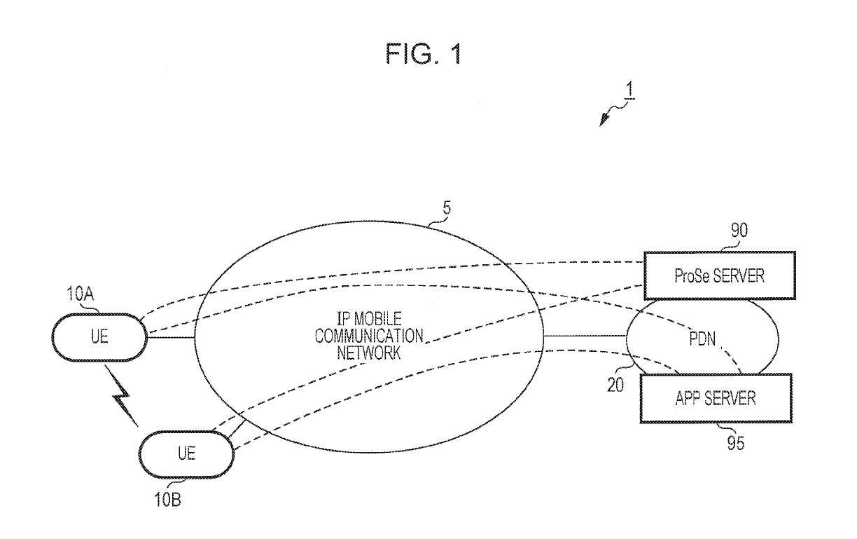

FIG. 1 is a diagram for describing the outline of a mobile communication system 1 according to the present embodiment. As shown in this drawing, the mobile communication system 1 includes a UE (mobile station device or terminal device) 10A, a UE (mobile station device or terminal device) 10B, and a PDN (Packet Data Network) 20, which are connected via an IP mobile communication network 5. A ProSe server 90 and an application server 95 are arranged in the PDN 20. Here, the ProSe server 90 is an authentication server managed by a mobile communication provider of a network in which the UE 10A or the UE 10B performs proximity discovery, and the application server 95 is a server that provides a service of an application (APP 1) used by the UE 10A or the UE 10B. Although it has been in this drawing that the ProSe server 90 is a device outside the mobile communication network 5, the ProSe server may be a device within the mobile communication network. The ProSe server 90 may be a part of the function of a MME 40, or may be a separate device.

The ProSe server 90 and the application server 95 may be included in the PDN 20, or may be included in a core network 7.

The UE 10A and the UE 10B may be connected to a network of the same mobile communication provider, or may be connected to networks of different mobile communication providers within a unitary state. For example, the IP mobile communication network 5 may be a network which includes a core network and a wireless access network operated by the mobile communication provider, or may be a broadband network operated by a fixed-line communication provider. The IP mobile communication network operated by the mobile communication provider will be described below in detail.

The broadband network refers to an IP communication network operated by a communication provider that is connected through ADSL (Asymmetric Digital Subscriber Line) and provides high-speed communication using a digital line such as an optical fiber. The broadband network is not limited to the above example, but may be a network that allows for wireless access using WiMAX (Worldwide Interoperability for Microwave Access).

The UE 10A is a communication terminal that is connected using an access system such as LTE or WLAN, and can be connected to the IP access network by being connected using a built 3GPP LTE communication interface or a WLAN communication interface.

As a specific example, the UE is a portable telephone terminal or a smartphone, or the UE is a household electrical appliance, a tablet computer, or a personal computer, which has a communication function.

The PDN 20 refers to a network that provides a network service for transmitting and receiving data in packets, and is, for example, the internet or an IMS.

The PDN 20 is connected to the IP access network by using a wired line. For example, the PDN is established by ADSL (Asymmetric Digital Subscriber Line) or an optical fiber. However, the PDN is not limited to the above example, but may be a wireless access network such as LTE (Long Term Evolution), WLAN (Wireless LAN), or WiMAX (Worldwide Interoperability for Microwave Access).

### 1.1.1 Structure Example of IP Mobile Communication Network

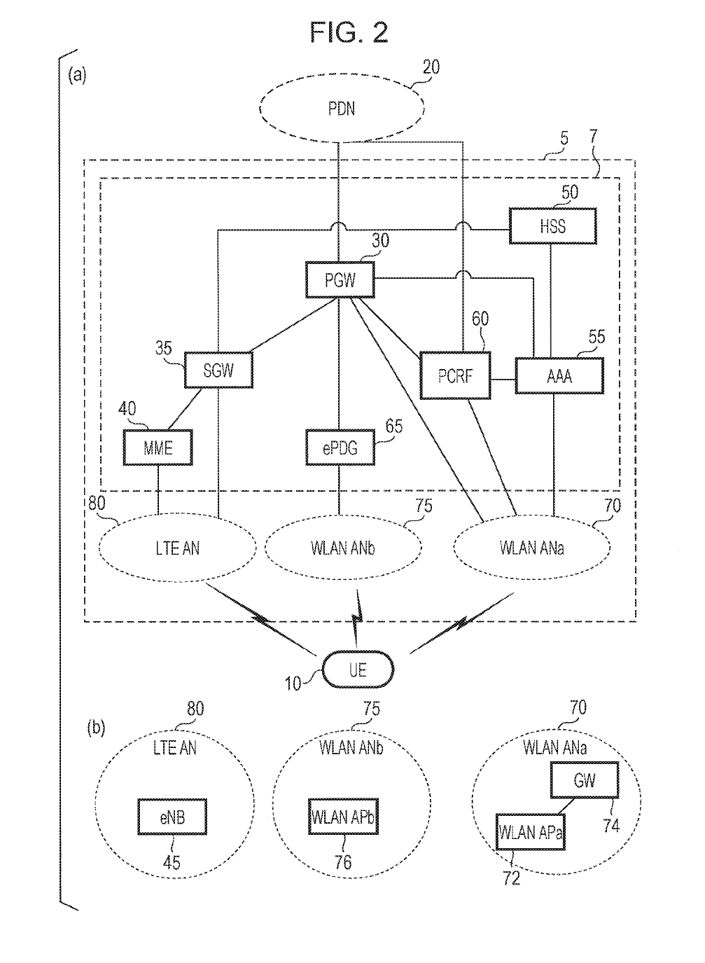

As shown in FIG. 2, the mobile communication system 1 includes the UE 10A, the IP mobile communication network 5, and the PDN 20 (Packet Data Network). The UE 10B is a UE different from the UE 10A and has the same structure as that of the UE 10A, and thus, the description thereof will be omitted. In addition to the UE 10A or the UE 10B, a plurality of UEs may be connected to the IP mobile communication network 5, but will be omitted for the sake of simplification in the drawings. The IP mobile communication network 5 includes the core network 7 and the respective wireless access networks. The detailed structure of the core network 7 is illustrated in FIG. 2(a).

The PDN 20 is a network that provides a network service for transmitting and receiving data in packets as described in FIG. 1, and is, for example, the Internet or an IMS.

The core network 7 includes a PGW (access control device) 30 (Packet Data Network Gateway), a SGW 35 (Serving Gateway), the MME 40 (Mobile Management Entity), a HSS 50 (Home Subscriber Server), an AAA 55 (Authentication, Authorization, and Accounting), a PCRF 60 (Policy and charging rules Function), and an ePDG 65 (enhanced Packet Data Gateway).

The wireless access network may include a plurality of different access networks. The respective access networks are connected to the core network 7. The UE 10A can be wirelessly connected to the wireless access network.

The wireless access network may be implemented using an LTE access network (LTE AN 80) that can be connected by an LTE access method, or an access network that can be connected in a WLAN access method.

The access network that can be connected in the WLAN access system may include a WLAN access network b (WLAN ANb 75) that is connected using the ePDG 65 as a connection device to the core network 7, and a WLAN access network a (WLAN ANa 70) that is connected to the PGW 30, the PCRF 60 and the AAA 55.

The devices have the same structures as those of the devices of the related art in the mobile communication system using an EPS, and thus, the detailed description thereof will be omitted. However, the functions thereof will be briefly described below. The PGW 30 is connected to the PDN 20, the SGW 35, the ePDG 65, the WLAN ANa, the PCRF 60 and the AAA 55, and serves as a gateway device between the core network 7 and the PDN 20 to deliver user data.

The SGW 35 is connected to the PGW 30, the MME 40, and the LTE AN 80, and serves as a gateway device between the LTE AN 80 and the core network 7 to deliver user data.

The MME 40 is connected to the SGW 35 and the LTE AN 80, and is an access control device that performs access control of the UE 10A via the LTE AN 80. The MME 40 may retain the function of the ProSe server 90.

The HSS 50 is connected to the SGW 35 and the AAA 55, and manages subscriber information. The AAA 55 is connected to the PGW 30, the HSS 50, the PCRF 60 and the WLAN ANa 70, and performs access control of the UE 10A which is connected via the WLAN ANa 70. The PCRF 60 is connected to the PGW 30, the WLAN ANa 70 and the AAA 55, and manages QoS for the delivery of data.

The ePDG 65 is connected to the PGW 30 and the WLAN ANb 75, and serves as a gateway device between the core network 7 and the WLAN ANb 75 to deliver user data.

As shown in FIG. 2(b), each of the wireless access networks includes a device (for example, base station apparatus or access point device) to which the UE 10A is actually connected. Although various devices compliant with the wireless access networks are considered as a device used for the connection, the LTE AN 80 includes the eNB 45 in the present embodiment. The eNB 45 is a wireless base station to which the UE 10A is connected by the LTE access method, and the LTE AN 80 may include one wireless base station or a plurality of wireless base stations.

The WLAN ANa 70 includes a WLAN APa 72, and a GW 74 (Gateway). The WLAN AP 72 is a wireless base station to which the UE 10A is connected in the WLAN access system, and the WLAN AN 70 may include one wireless base station or a plurality of wireless base stations. The GW 74 is a gateway device between the core network 7 and the WLAN ANa 70. The WLAN APa 72 and the GW 74 may be implemented by a single device.

As stated above, the gateway included in the WLAN ANa 70 can be connected to the plurality of devices within the core network 7. In a case where the provider that operates the core network 7 and the provider that operates the WLAN ANa 70 are different from each other, such a structure may be operated in a case where a trust relationship is established by an operational contract or agreement between the providers. In other words, the WLAN APa 72 is an access network having reliability for the provider that operates the core network 7.

The WLAN ANb 75 includes a WLAN APb 76. The WLAN AP 76 is a wireless base station to which the UE 10A is connected in the WLAN access system, and the WLAN AN 75 includes one wireless base station or a plurality of wireless base stations.

As mentioned above, the WLAN ANb 75 is connected to the core network 7 by using the ePDG 65 which is the device included in the core network 7 as a gateway. The ePDG 65 has a security function for ensuring safety. In a case where the provider that operates the core network 7 and the provider that operates the WLAN ANa 70 are different from each other, such a configuration is operated in a case where a trust relationship is not established by an operational contract or agreement between the providers. In other words, the WLAN APa is an access network that does not have reliability for the provider that operates the core network 7, and provides safety in the ePDG 65 included in the core network 7.

In the present specifications, the UE 10A being connected to the respective wireless access networks means that this UE is connected to the base station apparatus or the access points included in the respective access networks, and data or signal to be transmitted and received passes through the base station apparatus or the access point.

For example, the UE 10A being connected to the LTE AN 80 means that the UE 10A is connected via the eNB 45, and this UE being connected to the WLAN ANa 70 means that this UE is connected via the WLAN APa 72 and/or the GW 74. The UE 10A being connected to the WLAN ANb 75 means that this UE 10A is connected to the WLAN APb 76.

### 1.2 Device Structure

Hereinafter, the structures of the respective devices will be briefly described with reference to the drawings.

### 1.2.1 Structure of UE

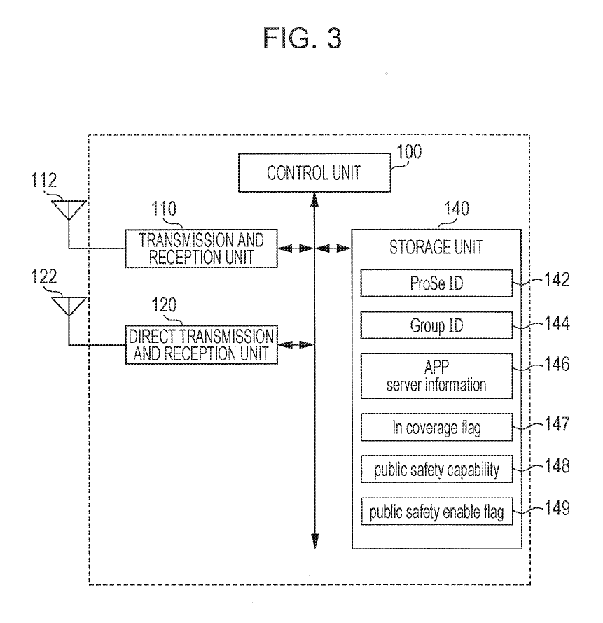

The UE may be a mobile telephone terminal that transmits and receives data through wireless communication by using an LTE access method, or may be a terminal device that mutually exchanges information with another terminal device by using a technology called Machine to Machine. Alternatively, the UE may be a communication terminal that is not limited to the aforementioned example. FIG. 3 shows the functional structure of the UE 10A according to the present embodiment. In the UE 10A, a transmission and reception unit 110, a direct transmission and reception unit 120 and a storage unit 140 are connected to a control unit 100 through a bus.

The control unit 100 is a functional unit for controlling the UE 10A. The control unit 100 realizes various processes by reading various programs stored in the storage unit 140 and executing the read program.

The transmission and reception unit 110 is a functional unit that transmits and receives data through wireless communication by using the LTE access method. Here, the transmission and reception unit 110 includes a transmission unit and a reception unit. The transmission unit can transmit data or control information via the LTE base station, and the reception unit can transmit data or control information via the LTE base station. An external antenna 112 is connected to the transmission and reception unit 110. The transmission unit transmits data and control information via the LTE base station, and the direct reception unit can receive data or control information via the LTE base station. The UE 10A is connected to the IP access network 5 by being connected to the LTE base station through the transmission and reception unit, and can perform the communication.

Here, the transmission and reception unit 110 may be separately provided as a transmission unit that transmits user data and control information which are communication data of the application and a reception unit that receives user data and control information which are communication data of the application.

The direct transmission and reception unit 120 is a functional unit that can directly communicate data or control information to another UE without using the LTE base station. Here, the direct transmission and reception unit 120 includes a direct transmission unit, and a direct reception unit. The direct transmission unit can transmit data or control information without using the LTE base station, and the direct reception unit can transmit data or control information without using the LTE base station. The external antenna 112 is connected to the direct transmission and reception unit 110. The direct transmission unit can transmit data or control information without using the LTE base station, and the direct reception unit can receive data or control information without using the LTE base station.

Here, the direct transmission and reception unit 120 may be separated provided as a transmission unit that transmits user data and control information which are communication data of the application (APP) and a reception unit that receives user data and control information which are communication data of the application (APP).

The transmission and reception unit 110 and the direct transmission and reception unit 120 may be provided as one transmission and reception unit, the transmission unit of the transmission and reception unit 110 and the transmission unit of the direct transmission and reception unit 120 may be provided as one transmission unit, and the reception unit of the transmission and reception unit 110 and the reception unit of the direct transmission and reception unit 120 may be provided as one reception unit.

The storage unit 140 is a functional unit that stores data and programs necessary for various operations of the UE 10A. For example, the storage unit 140 is a semiconductor memory or a HDD (Hard Disk Drive). The storage unit 140 stores ProSe ID 142, Group ID 144, APP server information 146, In coverage flag 147, public safety capability 148, and public safety enable flag 149.

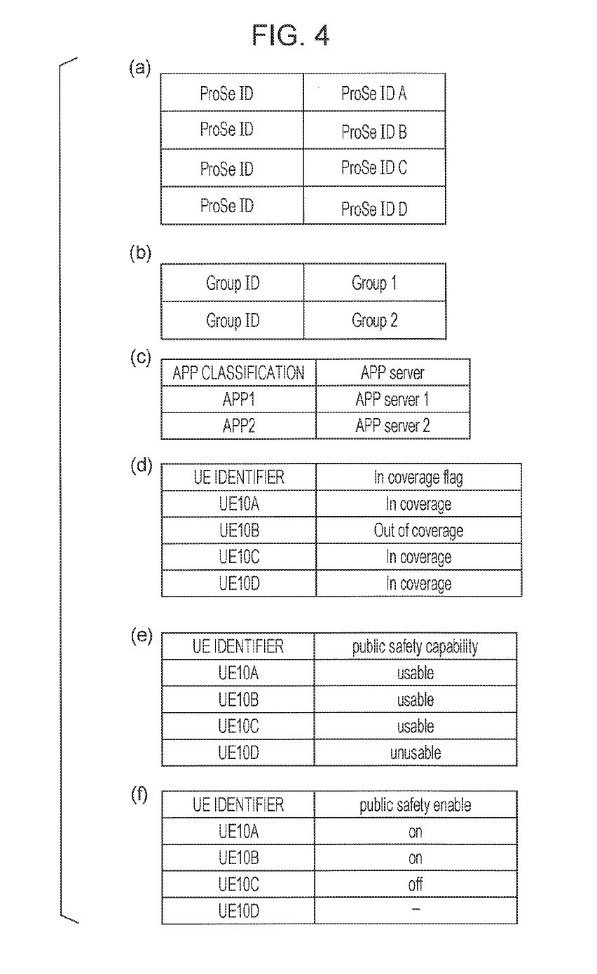

The ProSe ID 142 stores information for identifying a UE on which the UE 10A can perform proximity discovery or direct communication. FIG. 4(a) is a diagram showing an example of the ProSe ID 142. FIG. 4(a) is a diagram showing the ProSe ID 142. In FIG. 4(a), an identifier (ProSe ID A) for identifying the UE 10A and an identifier (ProSe ID B) for identifying the UE 10B which is present in proximity and on which the direct communication can be performed are managed. A UE 10C (identifier: ProSe ID C) or a UE 10D (identifier: ProSe ID D) which are not present in proximity but on which the direct communication can be performed are also managed.

The ProSe ID 142 may be managed for each application of a specific UE in addition to identifying the UE. Thus, the ProSe ID 142 can specify the application of the UE in addition to identifying the UE.

The ProSe ID 142 may be an Expression code. The Expression code is an identifier for identifying the UE. The Expression code may be assigned to the EPS or the application server. The UE 10A may use the Expression code in order to detect that the UE 10B is present in the proximity of the UE 10A by transmitting the Expression code to the UE 10B.

The Group ID 144 manages an identifier for identifying a group in which the UE 10A participates. The UE 10A can restrict the UE on which the direct communication and the proximity discovery are performed by using the Group ID 144. The Group ID 144 is not necessarily used, but the proximity discovery and the direct communication may be started without using the Group ID 144. In FIG. 4(b), in the Group ID 144, Group 1 and Group 2 are managed. A plurality of Group IDs may be managed, and the UE 10A may belong to a plurality of groups.

The APP server information 146 manages information related to the APP server associated to each application (APP). The APP server refers to a server that provides a service in the application used by the UE 10A. The UE 10A can receive information necessary for the proximity discovery or the direct communication from the APP server, and can perform the proximity discovery or the direct communication.

In the APP server information in FIG. 4(c), APP server 1 in APP 1 and APP server 2 of APP 2 of the applications used by the UE 10A is managed.

A plurality of APP server may be managed, and the UE 10A may use different APP servers for the respective applications.

The application may be managed by being identified from another application according to data classification such as VoIP, video streaming, video file or text.

Alternatively, the communication using middleware such as IMS may be managed by being identified as a single application.

Alternatively, an individual application such as Skype or LINE may be managed by being identified by an application name or an application ID.

Alternatively, the applications may be managed by being identified as different applications by combining these applications.

Here, the application that can be used by the UE 10 may be installed in the manufacturing stage thereof, or may be installed through the operation of a user.

FIG. 4(d) is a diagram showing an example of the In coverage flag 147 for the UE on which the proximity discovery and the direct communication can be performed. In FIG. 4(d), the In coverage flag 147 of the UE 10A, the In coverage flag of the UE 10B, the In coverage flag of the UE 10B and the In coverage flag of the UE 10B are managed. Here, as one example, the In coverage flag is managed as In coverage for the UE 10A, the In coverage flag is managed as Out of coverage for the UE 10B, the In coverage flag is managed as In coverage for the UE 10C, and the In coverage flag is managed as In coverage for the UE 10D.

Here, the In coverage flag may be managed as Out of coverage for the UE 10A, the In coverage flag may be managed as in coverage for the UE 10B, the In coverage flag may be managed as Out of coverage for the UE 10C, and the In coverage flag may be managed as Out of coverage for the UE 10D.

FIG. 4(e) is a diagram showing an example of the public safety capability 148. The public safety capability 148 manages information indicating that the UE can use the public safety. In FIG. 4(e), the public safety capability of the UE 10A, the public safety capability of the UE 10B, the public safety capability of the UE 10C, and the public safety capability of the UE 10D are managed. Here, as one example, the public safety capability for the UE 10A is managed to be usable, the public safety capability for the UE 10B is managed to be usable, the public safety capability for the UE 10C is managed to be usable, and the public safety capability for the UE 10D is managed to be unusable. The public safety capability being usable means that the UE retains the function of the public safety and can use the public safety, and the public safety capability being unusable means that the UE does not retain the function of the public safety and is difficult to use the public safety.

FIG. 4(f) is a diagram showing an example of the public safety enable flag 149. The public safety enable flag 149 manages information indicating that each UE enables (or turns on) the public safety. In FIG. 4(f), the public safety enable flag of the UE 10A, the public safety enable flag of the UE 10B, the public safety enable flag of the UE 10C, and the public safety enable flag of the UE 10D are managed. Here, as one example, the public safety enable flag for the UE 10A is managed to be turned on, the public safety enable flag for the UE 10B is managed to be turned on, the public safety enable flag for the UE 10C is managed to be turned off, and the public safety enable flag for the UE 10D is managed to be “-”. Here, since the UE 10D is difficult to use the public safety, the public safety is managed to be “-”, but may be managed to be turned off. In the public safety enable flag 149, the UE of which the public safety is managed to be “-” or turned “off” is managed as a UE that is difficult to use the public safety.

### 1.2.2 Structure of ProSe Server

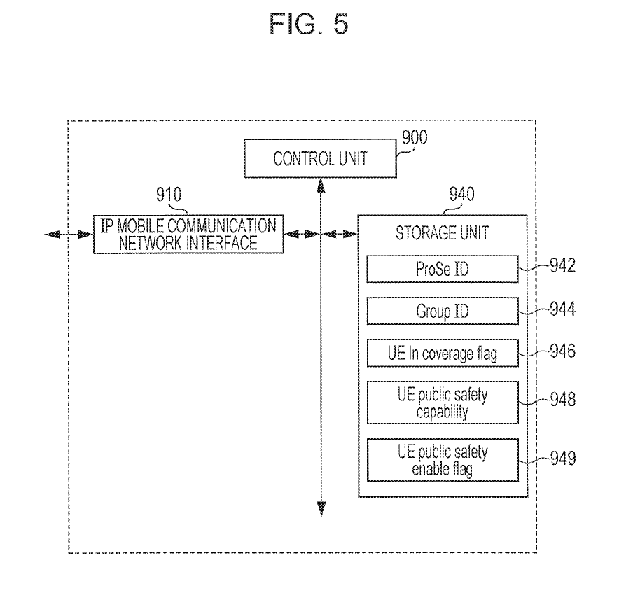

FIG. 5 shows the functional structure of the ProSe server 90. The ProSe server 90 is an authentication server managed by the mobile communication provider which performs the proximity discovery through ProSe and the communication through ProSe. In the authentication server 90, an IP mobile communication network interface 910 and a storage unit 940 are connected to a control unit 900 through a bus.

The control unit 900 is a functional unit for controlling the UE 10. The control unit 900 realizes various processes by reading various programs stored in the storage unit 940 and executing the read program.

The IP mobile communication network interface 910 is a functional unit for allowing the authentication server 90 to be connected to the IP mobile communication network 5.

The storage unit 940 is a functional unit that records programs and data required for various operations of the UE 10. For example, the storage unit 940 is a semiconductor memory, or a hard disk drive (HDD).

The storage unit 940 manages ProSe ID 942, Group ID 944, UE In coverage flag 946, UE public safety capability 948, and UE public safety flag 949.

The ProSe ID 942, the Group ID 944, the UE In coverage flag 946, the UE public safety capability 948 and the UE public safety enable flag 949, to be described below, may be stored in an external device. For example, these information items may be stored in the HSS 50, and may be updated by referring to these information items may by inquiring of the HSS 50 if necessary or registering these information items in the storage unit 940.

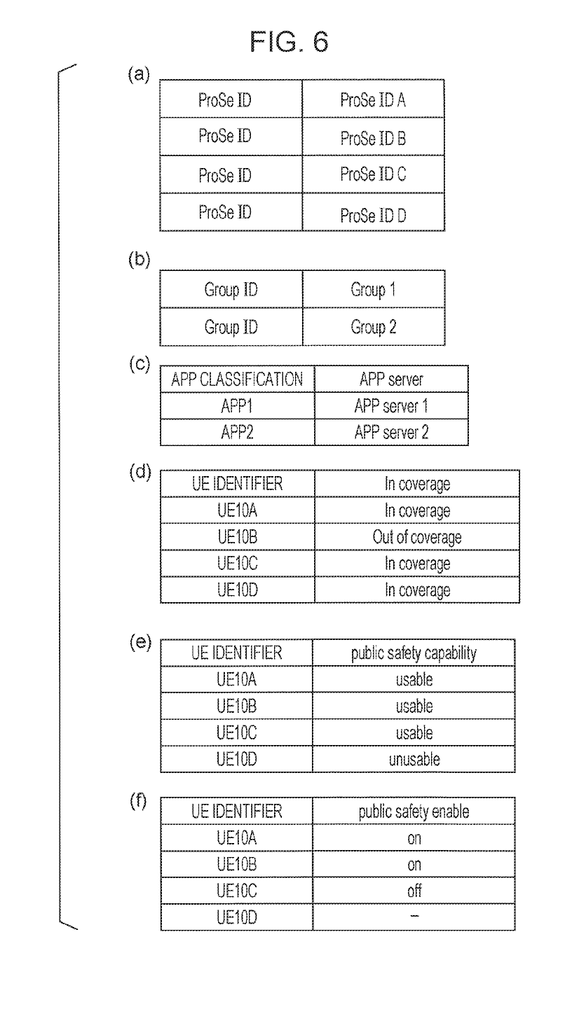

FIG. 6(a) shows an example of the ProSe ID 942 managed by the ProSe server. The ProSe ID 942 stores an identifier of the UE on which the UE 10A can perform the proximity discovery and the direct communication. In FIG. 6(a), an identifier (ProSe ID A) for identifying the UE 10A, an identifier (ProSe ID B) for identifying the UE 10B which is present in proximity and on which the direct communication can be performed, and the UE 10C (identifier: ProSe ID C) or the UE 10D (identifier: ProSe ID D) are managed.

The ProSe ID 942 may be managed for each application. That is, the ProSe ID 942 may be managed for each APP.

The ProSe ID 942 may be an Expression code as long as an identifier can identify the UE. The Expression code is an identifier for identifying the UE. The Expression code may be assigned by the EPS or the application server. The UE 10A may use the Expression code in order to detect that the UE 10B is present in the proximity of the UE 10A by transmitting the Expression code to the UE 10B.

The Group ID 944 manages an identifier for identifying a group in which the UE 10A participates. In FIG. 6(b), in the Group ID 944, Group 1 and Group 2 are managed. A plurality of Group IDs may be managed.

FIG. 6(c) is a diagram showing an example of the In coverage flag 946 for the UE on which the proximity discovery and the direct communication can be performed. In FIG. 6(c), the In coverage flag 147 of the UE 10A, the In coverage flag of the UE 10B, the In coverage flag of the UE 10B, and the In coverage flag of the UE 10B are managed. Here, as one example, the In coverage flag is managed as In coverage for the UE 10A, the In coverage flag is managed as Out of coverage for the UE 10B, the In coverage flag is managed as In coverage for the UE 10C, and the In coverage flag is managed as In coverage for the UE 10D.

Here, the In coverage flag may be managed as Out of coverage for the UE 10A, the In coverage flag may be managed as In coverage for the UE 10B, the In coverage flag may be managed as Out of coverage for the UE 10C, and the In coverage flag may be managed as Out of coverage for the UE 10D.

FIG. 6(d) is a diagram showing an example of the public safety capability 948. The public safety capability 948 manages information indicating that the UE can use the public safety. In FIG. 6(d), the public safety capability of the UE 10A, the public safety capability of the UE 10B, the public safety capability of the UE 10C and the public safety capability of the UE 10D are managed. Here, as one example, the public safety capability for the UE 10A is managed to be usable, the public safety capability for the UE 10B is managed to be usable, the public safety capability for the UE 10C is managed to be usable, and the public safety capability for the UE 10D is managed to be unusable.

FIG. 6(e) is a diagram showing an example of the public safety enable flag 949. The public safety enable flag 949 manages information indicating that each UE enables (or turns on) the public safety. In FIG. 6(e), the public safety enable flag of the UE 10A, the public safety enable flag of the UE 10B, the public safety enable flag of the UE 10C and the public safety enable flag of the UE 10D are managed. Here, as one example, the public safety enable flag for the UE 10A is managed to be turned on, the public safety enable flag for the UE 10B is managed to be turned on, the public safety enable flag for the UE 10C is managed to be turned off, and the public safety enable flag for the UE 10D is managed to be “-”. Here, since the UE 10D is difficult to use the public safety, the public safety is managed to be “-”, but may be managed to be turned off. In the public safety enable flag 149, the UE of which the public safety is managed to be “-” or turned “off” is managed as a UE that is difficult to use the public safety.

### 1.2.3 Structure of APP Server

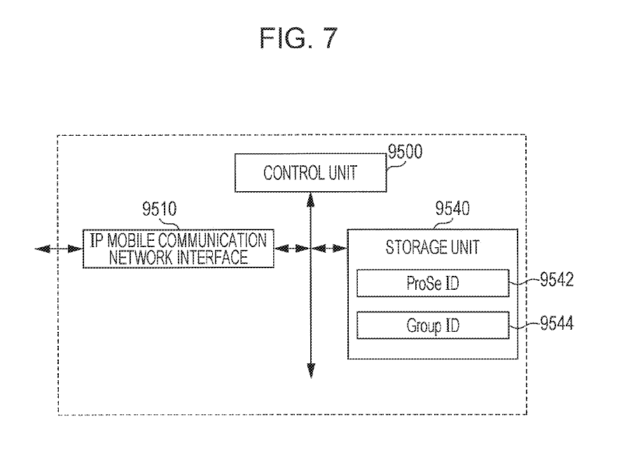

FIG. 7 shows a functional structure of the APP server 95. The APP server 95 is a server that provides a service in the application used by the UE 10A.

In the APP server 95, an IP mobile communication network interface 9510, and a storage unit 9540 are connected to a control unit 9500 through a bus.

The control unit 9500 is a functional unit for controlling the UE 10. The control unit 9500 realizes various processes by reading various programs stored in the storage unit 9540 and executing the read program.

The IP mobile communication network interface 9510 is a functional unit for allowing the APP server 95 to be connected to the IP mobile communication network 5.

The storage unit 9540 is a functional unit that records programs and data required for various operations of the UE 10. For example, the storage unit 9540 is a semiconductor memory, or a hard disk drive (HDD). The storage unit 9540 manages ProSe ID 9542, and Group ID 9544.

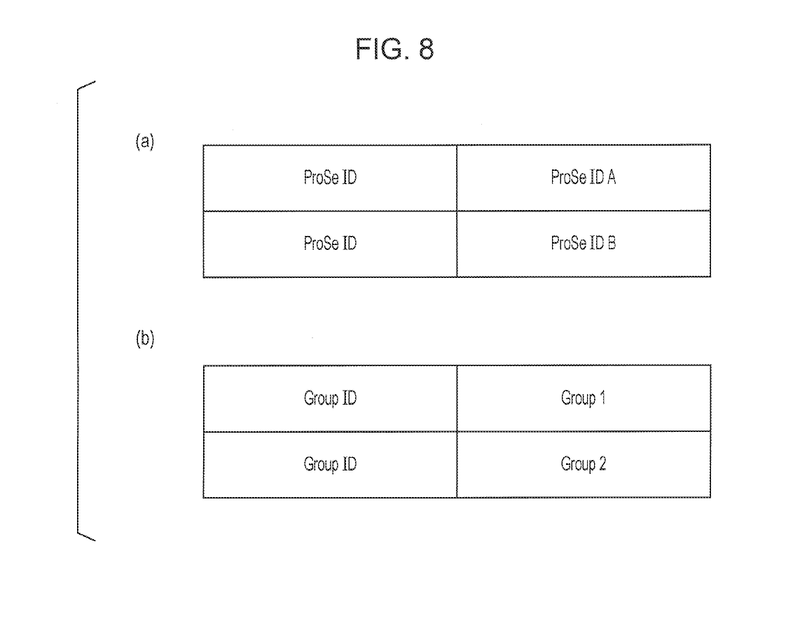

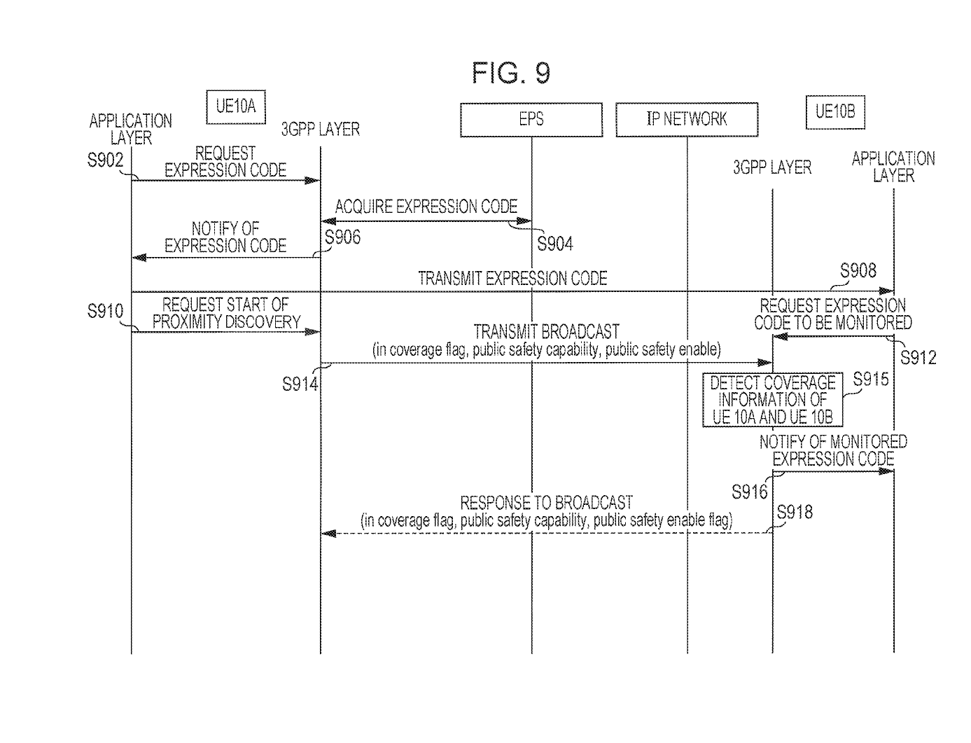

FIG. 8(a) shows an example of the ProSe ID 9542. In FIG. 9(a), an identifier of the UE that uses the APP 1 is managed. It has been described in FIG. 9(a) that the ProSe ID A and the ProSe ID B are managed by using the identifiers in the UE 10A and the UE 10B as examples of the ProSe ID 9542, but the identifiers are not limited to the ProSe ID A and the ProSe ID B. Another UE may be used.

FIG. 8(b) shows an example of the Group ID. In FIG. 8(b), the group ID that provides a service in the APP server 95 is managed. In FIG. 8(b), as an example of the Group ID 9544, Group 1 and Group 2 are managed. Here, the managed Group ID is not limited to the APP 1 and the APP 2, but may be another Group ID.

### 1.3 Description of Process

### 1.3.1 Proximity Discovery Procedure

Next, a specific procedure and a specific process in the mobile communication system will be described. By referring to FIG. 9, there will be described a procedure in which the UE 10A performs the transmission in a broadcast manner by adding the in coverage flag 147, the public safety capability 148 and the public safety enable flag 149 to the signal in order to perform the proximity discovery on the UE 10B, the UE 10B receives the signal including the in coverage flag 147, the public safety capability 148 and the public safety enable flag 149 in the broadcast manner and transmits the response of the signal (broadcast) from the UE 10A to the UE 10A in the proximity discovery from the UE 10A, and the UE 10A detects the in coverage flag 147, the public safety capability 148 and the public safety enable flag 149 of the UE 10B.

Initially, the APP 1 of the UE 10A transmits a request for the Expression code to a 3GPP layer of the UE 10A (S902). Here, the Expression code is an identifier for identifying the UE 10A. The Expression code is an identifier for allowing the UE 10B to detect that the UE 10A is present in proximity by being transmitted in a broadcast manner by the UE 10A and being received by the UE 10B.

Subsequently, the 3GPP layer of the UE 10A acquires the Expression code of the UE 10A by inquiring of the EPS (S904). Here, the UE 10A may notify of the identifier (ProSe ID A) of the UE 10A, and may acquire the Expression code used in the proximity discovery. In a case where the authentication of the Expression code is received once, a procedure of authenticating the Expression code may be skipped.

Thereafter, the 3GPP layer of the UE 10A notifies an application layer of the UE 10B of the Expression code of the UE 10A (S906). Meanwhile, the 3GPP layer of the UE 10A transmits the Expression code of the UE 10A to the UE 10B (S908). Here, the UE 10A notifies of the announced Expression code. The UE 10B receives the transmitted Expression code, and monitors the Expression code. As a method of transmitting the Expression code from the UE 10A to the UE 10B, the Expression code may be transmitted and received by the application layer, or may be transmitted and received by the 3GPP layer.

Subsequently, the application layer of the UE 10B requests the expression code monitored by the 3GPP layer of the UE 10B (S912). Here, in order to check that the Expression code of the UE 10A notified in S908 is the same as the Expression code monitored in the 3GPP layer of the UE 10B, the application layer of the UE 10B requests the Expression code. The 3GPP layer of the UE 10B may start to wait for a signal for performing the proximity discovery from the UE 10A in response of the request for the Expression code.

The application layer of the UE 10A which has received the Expression code requests that the 3GPP layer is to start the proximity discovery (S910). The 3GPP layer which has received the request for the start of the proximity discovery transmits a signal for performing the proximity discovery on the UE 10B in a broadcast manner (S914). The signal for performing the proximity discovery includes the in coverage flag 147, the public safety capability 148, and the public safety enable flag 149. Here, the in coverage flag 147 includes information indicating that the UE 10A is served in the LTE base station (In coverage) (or this UE is not served in the LTE base station (Out of coverage)).

Here, as a method of discovering that the UE 10A is served in the LTE base station, various methods are considered. For example, if information transmitted from the eNB 45 is received within a predetermined period of time, it may be determined that this UE is served in the LTE base station, and if the information transmitted from the eNB 45 is not received within a predetermined period of time, it may be determined that this UE is not served in the LTE base station.

The public safety capability 148 is information indicating that the UE retains the function of the public safety, and here, since the UE 10A retains the function of the public safety, this UE notifies that the public safety capability is “usable”.

The public safety enable flag 149 is information indicating that the UE enables the public safety, and here, since the UE 10A enables the public safety, this UE notifies that the public safety enable is turned “on”. The Expression code of the UE 10A which performs the proximity discovery may be added. As stated above, the UE 10A may transmit the Expression code as the signal for requesting to discover the UE 10A.

The UE 10A may add identification information indicating capability information of the UE 10A capable of establishing a direct communication path in the LTE Direct. The UE 10A may add identification information indicating capability information of the UE 10A capable of establishing a direct communication path in the WLAN Direct.

The signal which is transmitted from the 3GPP layer of the UE 10A in order to perform the proximity discovery may be transmitted every predetermined time interval. This signal may be transmitted whenever the in coverage flag 147 is updated. The in coverage flag 147 is transmitted by being updated and being included in a discovery request signal depending on a situation in a coverage or out of coverage at a point of time of the transmission.

The UE 10B which has received the signal (broadcast) for performing the proximity discovery detects the Expression code of the UE 10B indicating that this UE is a target of the proximity discovery included in the signal (broadcast), and determines that the UE 10B is a discovery target. The UE 10B detects the in coverage flag 147, the public safety capability 148, and the public safety enable flag 149 included in the signal (broadcast), and stores the discovery information items as information related to the UE 10A.

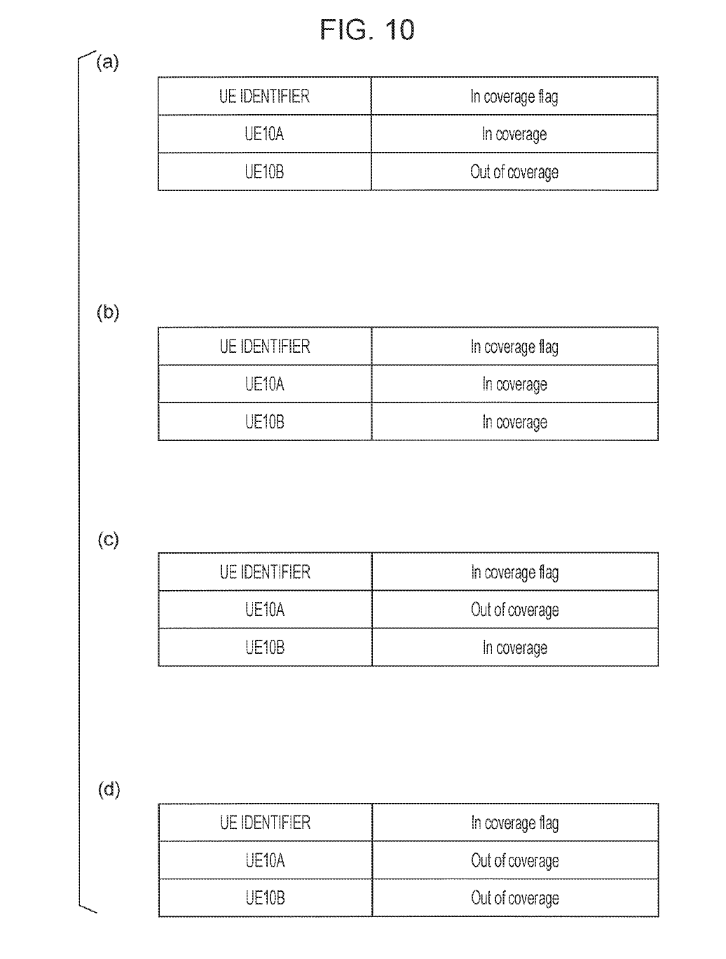

The 3GPP layer of the UE 10A detects coverage information of the UE 10A and the UE 10B (S915). FIG. 10 shows the coverage information of the UE 10A and the UE 10B. FIG. 10(a) shows a case where the UE 10A is In coverage and the UE 10B is Out of coverage. FIG. 10(b) shows a case where the UE 10A is in coverage and the UE 10B is In coverage. FIG. 10(c) shows a case where the UE 10A is Out of coverage and the UE 10B is In coverage. FIG. 10(d) shows a case where the UE 10A is Out of coverage and the UE 10B is Out of coverage. As shown in FIG. 10, it is detected whether or not the UE 10A is in coverage or out of coverage, and it is detected whether or not the UE 10B is in coverage or out of coverage by the notification from the UE 10B. Accordingly, the in coverage flag 147 in the UE 10A is any one flag of FIG. 10(a), FIG. 10(b), FIG. 10(c) and FIG. 10(d).

The communication path establishment procedure can be started by detecting that the UE 10A and the UE 10B are in any state of the four states. Specifically, different communication path establishment procedures are respectively performed in one state in which the UE 10A is in coverage and the UE 10B is in coverage, one state in which the UE 10A is out of coverage and the UE 10B is in coverage, one state in which the UE 10A is in coverage and the UE 10B is out of coverage and one state in which the UE 10A is out of coverage and the UE 10B is out of coverage.

Here, in a case where the public safety capability of the UE 10A or the UE 10B is “unusable” and the in coverage flag 147 of the UE 10A or the UE 10B is out of coverage, it may be determined that it is difficult to perform the direct communication. In a case where the public safety enable flag of the UE 10A or the UE 10B is turned “off” and the in coverage flag 147 of the UE 10A or the UE 10B is out of coverage, it may be determined that it is difficult to perform the direct communication.

The UE 10B may detect that the UE 10A can use the LTE Direct by the identification information indicating the capability information of the UE 10A capable of establishing the direct communication path in the LTE Direct. The UE 10B may detect that the UE 10A can use the WLAN Direct by the identification information indicating the capability information of the UE 10A capable of establishing the direct communication path in the WLAN Direct.

The 3GPP layer of the UE 10B which have received the signal (broadcast) from the UE 10A notifies the application layer of the UE 10B of the Expression code of the UE 10A which has detected the signal (broadcast) (S916). In this case, the UE 10B may add the in coverage flag 147, the public safety capability 148 and the public safety enable flag 149 to each notification. Here, the in coverage flag 147 may include information indicating that the UE 10B is served in the LTE base station (In coverage) (or this UE is not served in the LTE base station (Out of coverage)).

Here, as a method of discovering that the UE 10B is served in the LTE base station, various methods are considered. For example, if information transmitted from the eNB 45 is received within a predetermined period of time, it may be determined that this UE is served in the LTE base station, and if the information transmitted from the eNB 45 is not received within a predetermined period of time, it may be determined that this UE is not served in the LTE base station. The Expression code of the UE 10B which performs the proximity discovery or the Expression code of the UE 10B which is a target of the proximity discovery are added.

The public safety capability 148 is information indicating that the UE retains the function of the public safety. Here, since the UE 10B retains the function of the public safety, this UE may notify that the public safety capability is “usable”.

The public safety enable flag 149 is information indicating that the UE can use the public safety. Here, since the UE enables the public safety, the UE 10B may notify that the public safety enable is turned “on”.

Through the above-described procedure, the UE 10B can detect the coverage information in the UE 10A and the UE 10B. That is, the UE 10B can detect that these UEs are in any one state of four state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, even after the proximity discovery request is detected by the UE 10B, the UE 10A may continue to transmit the signal for the proximity discovery every predetermined time interval. This signal may be transmitted whenever the in coverage flag 147 is updated. The in coverage flag 147 is transmitted by being updated and being included in a discovery request signal depending on a situation in coverage or out of coverage at a point of time of the transmission.

Here, in a series of procedures from S902 to S916, the procedure may be started by exchanging the UE 10A and the UE 10B. That is, the application of the UE 10B requests the Expression code (S902), and acquires the Expression code of the UE 10B (S904). The 3GPP layer of the UE 10B notifies the application layer of the UE 10B of the Expression code (S906), and the application layer of the UE 10B transmits the Expression code for identifying the UE 10B (S908). The application layer of the UE 10A transmits the request for the start of the proximity discovery (S910). The 3GPP layer of the UE 10A transmits the signal (broadcast), and requests the Expression code monitored by the application layer of the UE 10A (S912). The UE 10A monitors the signal which includes the Expression code for identifying the UE 10B in order to discover the UE 10B. The 3GPP layer of the UE 10B transmits the signal (broadcast) of the proximity discovery (S914). The UE 10A detects that the UE 10B is positioned in proximity by receiving this signal. The 3GPP layer of the UE 10A may detect the coverage information of the UE 10A and the UE 10B (S915), and the 3GPP layer of the UE 10A may notify the application layer of the UE 10A of the monitored Expression code (S916). In the transmission (S914) of the signal of the proximity discovery, the Expression code of the UE 10B which performs the proximity discovery may be added. As described above, the UE 10B may transmit the signal for requesting the discovery of the UE 10B.

Through such a series of procedures, the UE 10A can detect the proximity of the UE 10B, and can detect the coverage information in the UE 10A and the UE 10B. That is, the UE 10A can detect that these UEs are in any one state of four states of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Subsequently, the 3GPP layer of the UE 10B may transmit a response of the proximity discovery to the 3GPP layer of the UE 10A in a broadcast manner (S918). Thus, the UE 10B can notify the UE 10A of the detection that the UE 10A is present in proximity. The UE 10A can detect that the UE 10B is present in the proximity of the 1 OA by receiving this response. In this case, the UE 10B may add the in coverage flag 147, the public safety capability 148, and the public safety enable flag 149 to this response. Here, the in coverage flag 147 may include information indicating that the UE 10B is served in the LTE base station (In coverage) (or this UE is not served in the LTE base station (Out of coverage)).

The UE 10B may add the identification information indicating the capability information of the UE 10B capable of establishing the direct communication path in the LTE Direct. The UE 10B may add the identification information indicating the capability information of the UE 10B capable of establishing the direct communication path in the WLAN Direct.

Here, as a method of discovering that the UE 10B is served in the LTE base station, various methods are considered. For example, if information transmitted from the eNB 45 is received within a predetermined period of time, it may be determined that this UE is served in the LTE base station, and if the information transmitted from the eNB 45 is not received within a predetermined period of time, it may be determined that this UE is not served in the LTE base station. The Expression code of the UE 10B which performs the proximity discovery or the Expression code of the UE 10B which is a target of the proximity discovery are included.

The public safety capability 148 is information indicating that the UE retains the function of the public safety. Here, since the UE 10B retains the function of the public safety, this UE may notify that the public safety capability is “usable”.

The public safety enable flag 149 is information indicating that the UE can use the public safety. Here, since the UE 10B enables the public safety, this UE may notify that the public safety enable is turned “on”.

Meanwhile, the UE 10A which has received the response of the signal (broadcast) from the UE 10B detects and stores the In coverage flag 147, the public safety capability 148 and the public safety enable flag 149 included in the response of the signal (broadcast).

The UE 10A may detect that the UE 10B can use the LTE Direct by the identification information indicating the capability information of the UE 10B capable of establishing the direct communication path in the LTE Direct. The UE 10A may detect that the UE 10B can use the WLAN Direct by the identification information indicating the capability information of the UE 10B capable of establishing the direct communication path in the WLAN Direct.

The transmission (S914) of the broadcast transmitted to the UE 10B from the UE 10A may be performed in a unicast manner by using a previously acquired communication resource. Alternatively, the transmission (S914) of the broadcast transmitted to the UE 10A from the UE 10B may be performed in a unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

The transmission (S918) of the broadcast transmitted to the UE 10A from the UE 10B may be performed in a unicast manner by using a previously acquired communication resource. Alternatively, the transmission (S918) of the broadcast transmitted to the UE 10B from the UE 10A may be performed in a unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

Through the above-described procedure, the UE 10B (and the UE 10A) can detect the coverage information in the UE 10A and the UE 10B. That is, it is possible to detect that these UEs are in any one state of four states of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

In the proximity discovery procedure, the UE 10B (and the UE 10A) detects the coverage information in the UE 10A and the UE 10B, and a communication path establishment procedure is performed based on the coverage information. Specifically, different communication path establishment procedures are performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

### 1.3.2 Communication Path Establishment Procedure

Next, the communication path establishment procedure will be described. Here, in the proximity discovery procedure, the UE 10A detects the coverage information in the UE 10A and the UE 10B. In the communication path establishment procedure, the communication path establishment procedure is performed using the coverage information of the UE 10A and the UE 10B. Specifically, different communication path establishment procedures are performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

### 1.3.2.1 Communication Path Establishment Procedure 1

Communication Path Establishment Procedure 1 will be described. In this procedure, the UE 10A is served in an eNB-A, and the eNB-A is managed by a MME-A. The UE 10B is served in an eNB-B, and the eNB-B is managed by a MME-B. Here, the MME-A or the MME-B may be the ProSe server 90 (ProSe server A or ProSe server B).

### 1.3.2.1.1 UE 10A: In Coverage UE 10B: In Coverage

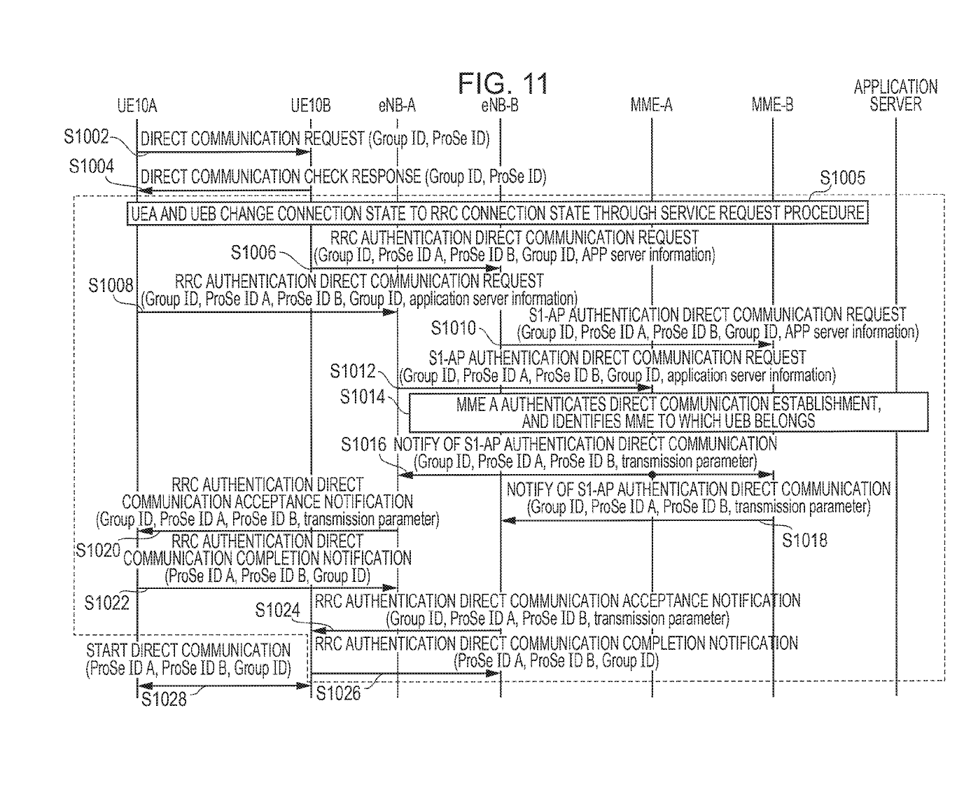

A communication path establishment procedure in one state in which the UE 10A is in coverage and the UE 10B is in coverage will be described with reference to FIG. 11.

Initially, the UE 10A transmits a direct Communication request to the UE 10B (S1002). Here, the UE 10A adds Group ID (Group 1) and ProSe ID (ProSe ID A) managed by the UE 10A.

Here, a trigger for performing the communication path establishment procedure may be a case where it is detected that the UE 10A and the UE 10B are in proximity, an application is operated such that the user performs the direct communication, and the application layer requests that the 3GPP layer is to perform the direct communication between the UE 10A and the UE 10B in the proximity discovery procedure. The trigger of the communication path establishment procedure may be a case where it is detected that the UE 10A and the UE 10B are present in proximity.

Here, the UE 10A may add the in coverage flag 147, the public safety capability 148 and the public safety enable flag 149 to the direct communication request. The in coverage flag 147 may include information indicating that the UE 10B is served in the LTE base station (In coverage) (or this UE is not served in the LTE base station (Out of coverage)).

Here, as a method of detecting that the UE 10A is served in the LTE base station, various methods are considered. For example, if information transmitted from the eNB 45 (eNB-A) is received within a predetermined period of time, it may be determined that this UE is served in the LTE base station, and if the information transmitted from the eNB 45 (eNB-A) is not received within a predetermined period of time, it may be determined that this UE is not served in the LTE base station.

The communication path establishment request may include an identifier indicating the LTE Direct or the WLAN Direct. The direct communication path may be determined based on this identifier. This identifier may be determined based on the application. For example, the identifier may be managed and determined such that if a call application such as a phone is used, the LTE Direct is used, and if an application that deals a high-capacity video file is used, the WLAN Direct is used.

The Expression code of the UE 10A which performs the proximity discovery or the Expression code of the UE 10A which is a target of the proximity discovery may be included.

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The UE 10A may request that the direct communication path in the Non-public safety is to be established. The UE 10A may request the acquisition of a resource for establishing the direct communication path. Here, in the acquisition of the resource for establishing the direct communication path, the UE 10A may notify that the UE 10A acquires the resource.

The UE 10A may add an identifier indicating that the direct communication path in the Non-public safety is established. The UE 10A may add an identifier indicating that the direct communication path in the public safety is established.

Here, in a condition in which the Public safety capability 148 is “usable” in the UE 10A and the UE 10B, the UE 10A may transmit the direct communication request for the communication path establishment of the Public safety. In a case where the Public safety enable flag 149 is turned “on” in the UE 10A and the UE 10B, the UE 10A may transmit the direct communication request for the communication path establishment of the Public safety.

In a case where the Public safety capability 148 is “unusable” in at least one of the UE 10A and the UE 10B, the UE 10A may not transmit the direct communication request for the communication path establishment of the Public safety. In a case where the Public safety enable flag 149 is turned “off” in at least one of the UE 10A and the UE 10B, the UE 10A may not transmit the direct communication request for the communication path establishment of the Public safety. In a case where it is detected that the UE 10B can use the LTE Direct, the UE 10A may add identification information indicating the capability information capable of establishing the direct communication path in the LTE Direct. In a case where it is detected that the UE 10B can use the WLAN Direct, the UE 10A may add identification information indicating the capability information capable of establishing the direct communication path in the WLAN Direct.

Here, in a case where both the UE 10A and the UE 10B have the capability by the identification information indicating the capability information capable of establishing the direct communication path in the LTE Direct, the UE 10A may transmit the communication path establishment request for the LTE Direct to the UE 10B. The establishment request may include the identification information indicating the communication path establishment request for the LTE Direct. In a case where both the UE 10A and the UE 10B have the capability by the identification information indicating the capability information capable of establishing the direct communication path in the WLAN Direct, the UE 10A may transmit the communication path establishment request for the WLAN Direct to the UE 10B. The establishment request may include the identification information indicating the communication path establishment request for the WLAN Direct.

In a case where it is detected that at least one of the UE 10A and the UE 10B does not retain the capability by the identification information indicating the capability information capable of establishing the direct communication path in the LTE Direct, the UE 10A does not transmit the communication path establishment request for the LTE Direct to the UE 10B. In a case where it is detected that at least one of the UE 10A and the UE 10B does not retain the capability by the identification information indicating the capability information capable of establishing the direct communication path in the WLAN Direct, the UE 10A does not transmit the communication path establishment request for the WLAN Direct to the UE 10B.

The UE 10B which has received the direct communication request from the UE 10A checks the Group ID (Group 1) and the ProSe ID (ProSe ID A) included in the direct communication request. In this case, the UE 10B checks that it is possible to perform the direct communication with the UE 10A by checking the Group ID and the ProSe ID of the UE 10A. In a case where the UE 10A has added the identification information indicating the capability information capable of establishing the direct communication path in the LTE Direct, the UE 10B may determine to perform the direct communication in the LTE Direct. In a case where the UE 10A has added the identification information indicating the capability information capable of establishing the direct communication path in the WLAN Direct, the UE 10B may determine to perform the direct communication in the WLAN Direct.

The UE 10B which has received the direct communication request transmits a direct communication check response (S1004). Here, the UE 10B adds the Group ID (Group 1) and the ProSe ID (ProSe ID B). In this case, the UE 10A checks that it is possible to perform the direct communication with the UE 10A by checking the Group ID and the ProSe ID of the UE 10B.

Here, the UE 10B may add the in coverage flag 147, the public safety capability 148 and the public safety enable flag 149 to the direct communication request. The in coverage flag 147 may include information indicating that the UE 10B is served in the LTE base station (In coverage) (or this UE is not served in the LTE base station (Out of coverage)).

Here, as a method of detecting that the UE 10B is served in the LTE base station, various methods are considered. For example, if information transmitted from the eNB 45 (eNB-B) is received within a predetermined period of time, it may be determined that this UE is served in the LTE base station, and if the information transmitted from the eNB 45 (eNB-B) is not received within a predetermined period of time, it may be determined that this UE is not served in the LTE base station. The Expression code of the UE 10A which performs the proximity discovery or the Expression code of the UE 10B which is a target of the proximity discovery may be included.

The public safety capability 148 is information indicating that the UE retains the function of the public safety. Here, since the UE 10B retains the function of the public safety, this UE may notify that the public safety capability is “usable”.

The public safety enable flag 149 is information indicating that the UE can use the public safety. Here, since the UE 10B enables the public safety, this UE may notify that the public safety enable is turned “on”.

The UE 10B may not transmit the direct communication check response at this time and may transmit the direct communication check response later. Specifically, the UE may transmit the direct communication check response after the UE 10B receives a RRC authentication direct communication acceptance notification (S1024), or after the UE 10B receives a RRC authentication direct communication completion notification (S1026). In a case where the direct communication check response is transmitted later, the UE 10B may transmit a RRC authentication direct communication request (S1006).

Subsequently, the UE 10A and the UE 10B change their connection state to a RRC connection state through a service request procedure (S1005). As the service request procedure, the procedure used in the related art may be used in a case where the transmission and reception of data are started in the LTE.

The UE 10B of which the connection state has changed to the RRC connection state transmits the RRC authentication direct communication request to the eNB-B (S1006). The RRC authentication direct communication request may include Group ID, ProSe ID A, ProSe ID B, Group ID (Group 1) and APP server information. The ProSe ID A is UE identifier information indicating the UE 10A, and ProSe ID B is UE identifier information indicating the UE 10B. The APP server information is information related to a server that provides a service in an application which performs direct communication.

Here, the UE 10B may request a communication resource capable of being used in the Non-public safety from an identifier indicating a communication resource in the Non-public safety from the UE 10A. As a specific requesting method, an identifier for requesting a communication resource capable of being used in the Non-public safety may be added. An identifier indicating not the communication resource capable of being used in the Non-public safety but a communication resource capable of being used in the Public safety may be added. Here, the UE 10B may previously manage whether or not to perform communication in the communication resource capable of being used in the Public safety or whether or not to perform communication in the communication resource capable of being used in the Non-public safety depending on the application. As mentioned above, this identifier may be determined depending on the application. This identifier may be determined depending on the In coverage flag 147 of the UE 10A and the In coverage flag 147 of the UE 10B.

The eNB-B or the MME-B may select a communication resource to be assigned using the identifier indicating the communication resource capable of being used in the Non-public safety or the public safety. Here, the communication resource may time, frequency or code, or may be another information for preventing interference. The communication resource may be any combination of information items such as time, frequency and code. Information related to a transmission antenna and transmission power information necessary for the transmission may be added to the communication resource.

The eNB-B which has received the RRC authentication direct communication request checks the Group ID, the ProSe ID A, the ProSe ID B, the Group ID and the APP server information. In a case where the identifier indicating the communication resource capable of being used in the Non-public safety or the public safety is included, the eNB-B may assign the communication resource based on the identification information for identifying the communication path used for the Public safety or the communication path used for the commercially available service, and may determine to notify the UE 10B of information related to the communication resource. The eNB-B may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination.

Meanwhile, the UE 10A of which the connection state has changed to the RRC connection state transmits the RRC authentication direct communication request to the eNB-A (S1008). The RRC authentication direct communication request includes Group ID, ProSe ID A, ProSe ID B, Group ID (Group 1) and APP server information.

Here, in a case where the UE 10A is in coverage and the UE 10B is in coverage, the UE 10A may request the communication resource capable of being used in the Non-public safety. As a specific requesting method, the identifier for requesting the communication resource capable of being used in the Non-public safety may be added. The identifier indicating not the communication resource capable of being used in the Non-public safety but the communication resource capable of being used in the Public safety may be added. Here, the UE 10A may previously manage whether or not to perform communication in the communication resource capable of being used in the Public safety or whether or not to perform communication in the communication resource capable of being used in the Non-public safety depending on the application. As mentioned above, this identifier may be determined depending on the application. This identifier may be determined depending on the In coverage flag 147 of the UE 10A and the In coverage flag 147 of the UE 10A.

The eNB-A or the MME-A may select a communication resource to be assigned using the identifier indicating the communication resource capable of being used in the Non-public safety or the public safety.

Here, the communication resource may time, frequency or code, or may be another information for preventing interference. The communication resource may be any combination of information items such as time, frequency and code. Information related to a transmission antenna and transmission power information necessary for the transmission may be added to the communication resource.

The eNB-B transmits a S1-AP authentication direct communication request to the MME-B (S1010). Here, the S1-AP authentication direct communication request includes Group ID, ProSe ID A, ProSe ID B, Group ID and APP server information.

Here, the eNB-B may request the communication resource capable of being used in the Non-public safety from the MME-B. As a specific requesting method, an identifier for requesting the communication resource capable of being used in the Non-public safety may be added. An identifier indicating not the communication resource capable of being used in the Non-public safety but the communication resource capable of being used in the Public safety may be added. Here, the eNB-B may previously determine whether or not to perform communication in the communication resource capable of being used in the Public safety or whether or not to perform communication in the communication resource capable of being used in the Non-public safety depending on the application, based on the notification from the UE 10B.

The MME-B may select a communication resource to be assigned using the identifier indicating the communication resource capable of being used in the Non-public safety or the public safety. Here, the communication resource may time, frequency or code, or may be another information for preventing interference. The communication resource may be any combination of information items such as time, frequency and code. Information related to a transmission antenna and transmission power information necessary for the transmission may be added to the communication resource.

The MME-B which has received the S1-AP authentication direct communication request checks the Group ID, the ProSe ID A, the ProSe ID B, the Group ID and the APP server information. In a case where the identifier indicating the communication resource capable of being used in the Non-public safety or the public safety is included, the MME-B may assign the communication resource based on the identification information for identifying the communication path used for the Public safety or the communication path used for the commercially available service, and may determine to notify the UE 10B of information related to the communication resource. The MME-B may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination.

The eNB-A which has received the RRC authentication direct communication request checks the Group ID, the ProSe ID A, the ProSe ID B, the Group ID and the APP server information. In a case where the identifier indicating the communication resource capable of being used in the Non-public safety or the public safety is included, the eNB-A may assign the communication resource based on the identification information for identifying the communication path used for the Public safety or the communication path used for the commercially available service, and may determine to notify the UE 10A of information related to the communication resource. The eNB-A may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination.

The eNB-A transmits a S1-AP authentication direct communication request to the MME-A (S1012). Here, the S1-AP authentication direct communication request includes Group ID, ProSe ID A, ProSe ID B, Group ID and APP server information.

Here, the eNB-A may request the communication resource capable of being used in the Non-public safety from the MME-A. As a specific requesting method, an identifier for requesting the communication resource capable of being used in the Non-public safety may be added. An identifier indicating not the communication resource capable of being used in the Non-public safety but the communication resource capable of being used in the Public safety may be added. Here, the eNB-A may previously determine whether or not to perform communication in the communication resource capable of being used in the Public safety or whether or not to perform communication in the communication resource capable of being used in the Non-public safety depending on the application, based on the notification from the UE 10A.

The MME-A may select a communication resource to be assigned using the identifier indicating the communication resource capable of being used in the Non-public safety or the public safety. Here, the communication resource may time, frequency or code, or may be another information for preventing interference. The communication resource may be any combination of information items such as time, frequency and code. Information related to a transmission antenna and transmission power information necessary for the transmission may be added to the communication resource.

The MME-A which has received the S1-AP authentication direct communication request checks the Group ID, the ProSe ID A, the ProSe ID B, the Group ID and the APP server information. In a case where the identifier indicating the communication resource capable of being used in the Non-public safety or the public safety is included, the MME-A may assign the communication resource based on the identification information for identifying the communication path used for the Public safety or the communication path used for the commercially available service, and may determine to notify the UE 10A of information related to the communication resource. The MME-A may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination.

Thereafter, the MMEA authenticates the establishment of the direct communication, and identifies the MME to which the UEB belongs (S1014). Here, the MMEA checks whether or not the UEA and the UEB may establish the direct communication. The MMEA discovers the MMEB to which the UEB belongs by inquiring of the MME 40 including the MMEB. As a method of discovering the UE 10B by each MME 40, various method are considered. For example, the UE may be discovered by discovering a UE identifier managed by the MME 40.

The MME-A which has discovered the MME-B to which the UEB belongs transmits the notification of the S1-AP authentication direct communication to the MME-B and the eNBA (S1016). Here, the notification of the S1-AP authentication direct communication includes Group ID, ProSe ID A, ProSe ID B, and a transmission parameter. Here, the transmission parameter is an information element necessary to perform the direct communication between the UE 10A and the UE 10B, and may include, for example, information (range class) indicating a communication range or a communication resource.

The MME-B which has received the notification of the S1-AP authentication direct communication from the MME-A transmits the notification of the S1-AP authentication direct communication (S1018). Here, the notification of the S1-AP authentication direct communication includes Group ID, ProSe ID A, ProSe ID B, and a transmission parameter.

The eNB-A which has received the notification of the S1-AP authentication direct communication transmits a RRC authentication direct communication acceptance notification to the UE 10A (S1020). Here, the RRC authentication direct communication acceptance notification includes Group ID, ProSe ID A, ProSe ID B, and a transmission parameter. Here, in addition to the transmission parameter notified from the MME-A, the transmission parameter may be added in the eNB-A, as the transmission parameter. In a case where the identifier indicating the communication resource capable of being used in the Non-public safety or the public safety is included in the RRC authentication direct communication request (S1006), the eNB-A may assign the communication resource based on the identification information for identifying the communication path used for the Public safety or the communication path used for the commercially available service, and may notify the UE 10B of the information related to the communication resource. The eNB-A may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination. The UE 10A which has received the RRC authentication direct communication acceptance notification checks the Group ID, the ProSe ID A, the ProSe ID B, and the transmission parameter used in the direct communication.

Thereafter, the UE 10A transmits a RRC authentication direct communication completion notification (S1022). Here, the RRC authentication direct communication completion notification includes ProSe ID A, ProSe ID B, and Group ID. The UE 10A which has transmitted the RRC authentication direct communication completion notification may prepare to start the direct communication with the UE 10B.

Meanwhile, the eNB-B which has received the notification of the S1-AP authentication direct communication transmits the RRC authentication direct communication acceptance notification to the UE 10B (S1024). Here, the RRC authentication direct communication acceptance notification includes Group ID, ProSe ID A, ProSe ID B, and a transmission parameter. Here, in addition to the transmission parameter notified from the MME-B, the transmission parameter may be added in the eNB-B, as the transmission parameter. In a case where the identifier indicating the communication resource capable of being used in the Non-public safety or the public safety is included in the RRC authentication direct communication request (S1008), the eNB-B may assign the communication resource based on the identification information for identifying the communication path used for the Public safety or the communication path used for the commercially available service, and may notify the UE 10B of the information related to the communication resource. The eNB-B may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination. The UE 10B which has received the RRC authentication direct communication acceptance notification checks the Group ID, the ProSe ID A, the ProSe ID B, and the transmission parameter used in the direct communication.

Thereafter, the UE 10B transmits a RRC authentication direct communication completion notification (S1026). Here, the RRC authentication direct communication completion notification includes ProSe ID A, ProSe ID B, and Group ID. The UE 10B which has received the RRC authentication direct communication completion notification may prepare to start the direct communication with the UE 10A.

The UE 10A and the UE 10B start the direct communication (S1028). In this case, the UE 10A and the UE 10B establish the direct communication path by the transmission parameter transmitted from the eNB-A or the eNB-B. The UE 10A may assign an IP address used in the direct communication to the UE 10B. Meanwhile, the UE 10B may assign an IP address used in the direct communication to the UE 10A.

Through the above-described procedure, it is possible to establish the communication path in one state in which the UE 10A is in coverage and the UE 10B is in coverage.

### 1.3.2.1.2 UE 10A: Out of Coverage UE 10B: Out of Coverage

Hereinafter, a communication path establishment procedure in one state in which the UE 10A is out of coverage and the UE 10B is out of coverage will be described with reference to FIG. 11. In a case where the UE 10A is out of coverage and the UE 10B is out of coverage, it is difficult to transmit and receive the control information with the eNB-A, the eNB-B, the MME-A, and the MME-B. That is, in FIG. 11, the communication path is established without performing the procedure from S1005 to S1026.

Initially, the UE 10A transmits the direct communication request to the UE 10B (S1002). In this case, the direct communication request includes Group ID, and ProSe ID (ProSe ID A).

Here, a trigger for performing the communication path establishment procedure may be a case where it is detected that the UE 10A and the UE 10B are in proximity, an application is operated such that the user performs the direct communication, and the application layer requests that the 3GPP layer is to perform the direct communication between the UE 10A and the UE 10B in the proximity discovery procedure. The trigger of the communication path establishment procedure may be a case where it is detected that the UE 10A and the UE 10B are present in proximity.

Here, the UE 10A may add the in coverage flag 147, the public safety capability 148 and the public safety enable flag 149 to the direct communication request. The in coverage flag 147 may include information indicating that the UE 10B is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The communication path establishment request may include an identifier indicating the LTE Direct or the WLAN Direct. The direct communication path may be determined based on this identifier.

The Expression code of the UE 10A which performs the proximity discovery or the Expression code of the UE 10A which is a target of the proximity discovery may be included.

Here, the UE 10A may previously assign the resource retained by the UE 10A to the direct communication path, may add the information related to the resource, and may transmit the direct communication path establishment request to the UE 10B.

Since the UE 10A is out of coverage and the UE 10B is out of coverage, the UE 10A may determine to establish the direct communication path in the public safety.

The UE 10A may add the identifier indicating that the direct communication path in the Public safety is established. It is detected that at least one UE is out of coverage from the coverage information, and the direct communication path establishment request used for the Non-public safety is not transmitted based on this discovery.

Here, in a condition in which the Public safety capability 148 is “usable” in the UE 10A and the UE 10B, the UE 10A may transmit the direct communication request for the communication path establishment of the Public safety. In a case where the Public safety enable flag 149 is turned “on” in the UE 10A and the UE 10B, the UE 10A may transmit the direct communication request for the communication path establishment of the Public safety.

In a case where the Public safety capability 148 is “unusable” in at least one of the UE 10A and the UE 10B, the UE 10A does not transmit the direct communication request. In a case where the Public safety enable flag 149 is turned “off” in at least one of the UE 10A and the UE 10B, the UE 10A does not transmit the direct communication request. The UE 10B which has received the direct communication request checks that it is possible to perform the direct communication with the UE 10A by checking the Group ID and the ProSe ID.

The UE 10B which has checked that it is possible to perform the direct communication with the UE 10A transmits the direct communication check response to the UE 10A (S1004). In this case, the direct communication request includes Group ID and ProSe ID (ProSe ID B). As stated above, it is detected that the UE 10A and the UE 10B are in proximity enough to perform the direct communication.

The UE 10B may determine to establish the direct communication path in the public safety by using the information indicating the communication resource in the public safety from the UE 10A.

Subsequently, the UE 10A starts the direct communication with the UE 10A (S1028).

Here, after the direct communication check response is received (S1004), the UE 10A may previously assign the resource retained by the UE 10A to the direct communication path, and may notify the UE 10B of the information related to the resource.

Through the above-described procedure, the communication path can be established in one state in which the UE 10A is out of coverage and the UE 10B is out of coverage.

### 1.3.2.1.3 UE 10A: Out of Coverage UE 10B: In Coverage

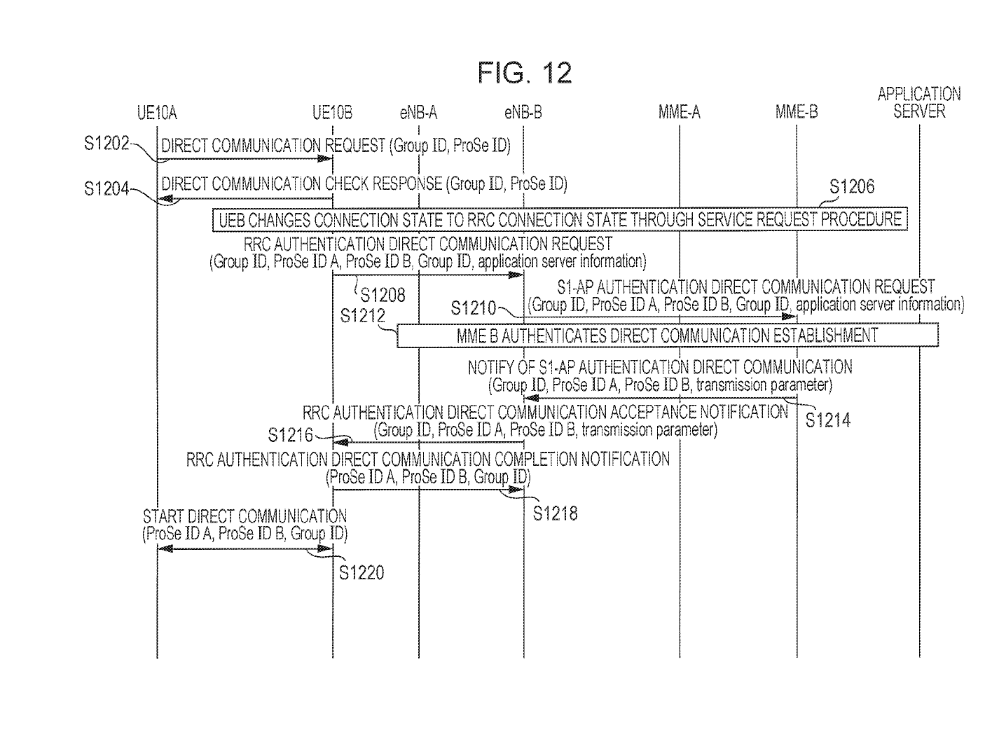

A communication path establishment procedure in one state in which the UE 10A is out of coverage and the UE 10B is in coverage will be described with reference to FIG. 12. In this procedure, the UE 10B is served in the eNB-B, and the eNB-B is managed by the MME-B. Here, the MME-A or the MME-B may be the ProSe server 90 (ProSe server A or ProSe server B).

Initially, the UE 10A transmits the direct communication request to the UE 10B (S1202). Here, the UE 10A adds the Group ID (Group 1) and the ProSe ID (ProSe ID A) managed by the UE 10A. Here, a trigger for performing the communication path establishment procedure may be a case where it is detected that the UE 10A and the UE 10B are in proximity, an application is operated such that the user performs the direct communication, and the application layer requests that the 3GPP layer is to perform the direct communication between the UE 10A and the UE 10B in the proximity discovery procedure. The trigger of the communication path establishment procedure may be a case where it is detected that the UE 10A and the UE 10B are present in proximity. Here, the UE 10A may add the in coverage flag 147, the public safety capability 148 and the public safety enable flag 149 to the direct communication request. The in coverage flag 147 may include information indicating that the UE 10B is served in the LTE base station (In coverage) (or this UE is not served in the LTE base station (Out of coverage)).

The communication path establishment request may include the identifier indicating the LTE Direct or the WLAN Direct. The direct communication path may be determined depending on this identifier.

The Expression code of the UE 10A which performs the proximity discovery or the Expression code of the UE 10A which is a target of the proximity discovery may be added.

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The UE 10A may request that the direct communication path is to be established in the Public safety. The UE 10A may request the acquisition of the resource for establishing the direct communication path. Here, in the acquisition of the resource for establishing the direct communication path, the UE 10A may notify that the UE 10A acquires the resource.

The UE 10A which has transmitted the direct communication completion request may prepare to start the direct communication with the UE 10B. Since the UE 10A is out of coverage and the UE 10B is in coverage, the UE 10A may determine to establish the direct communication path in the public safety.

The communication path establishment request may include the identifier indicating the LTE Direct or the WLAN Direct. The direct communication path may be determined depending on this identifier. This identifier may be determined depending on the application. For example, the identifier may be managed and determined such that if a call application such as a phone is used, the LTE Direct is used, and if an application that deals a high-capacity video file is used, the WLAN Direct is used.

The UE 10A may request that the direct communication path in the Public safety is to be established. The UE 10A may request the acquisition of a resource for establishing the direct communication path. The UE 10A may add the identifier indicating that the direct communication path in the Public safety is established. It is detected that at least one UE is out of coverage from the coverage information, and the direct communication path establishment request used for the Non-public safety is not transmitted based on this discovery.

Here, in a condition in which the Public safety capability 148 is “usable” in the UE 10A and the UE 10B, the UE 10A may transmit the direct communication request for the communication path establishment of the Public safety. In a case where the Public safety enable flag 149 is turned “on” in the UE 10A and the UE 10B, the UE 10A may transmit the direct communication request for the communication path establishment of the Public safety.

In a case where the Public safety capability 148 is “unusable” in at least one of the UE 10A and the UE 10B, the UE 10A does not transmit the direct communication request. In a case where the Public safety enable flag 149 is turned “off” in at least one of the UE 10A and the UE 10B, the UE 10A does not transmit the direct communication request. In a case where it is detected that the UE 10B can use the LTE Direct, the UE 10A may add the identification information indicating the capability information capable of establishing the direct communication path in the LTE Direct. In a case where it is detected that the UE 10B can use the WLAN Direct, the UE 10A may add the identification information indicating the capability information capable of establishing the direct communication path in the WLAN Direct.

The direct communication request is received from the UE 10A.

Here, in a case where both the UE 10A and the UE 10B have the capability by the identification information indicating the capability information capable of establishing the direct communication path in the LTE Direct, the UE 10A may transmit the communication path establishment request for the LTE Direct to the UE 10B. The establishment request may include the identification information indicating the communication path establishment request for the LTE Direct. In a case where both the UE 10A and the UE 10B have the capability by the identification information indicating the capability information capable of establishing the direct communication path in the WLAN Direct, the UE 10A may transmit the communication path establishment request for the WLAN Direct to the UE 10B. The establishment request may include the identification information indicating the communication path establishment request for the WLAN Direct.

In a case where it is detected that at least one of the UE 10A and the UE 10B does not retain the capability by the identification information indicating the capability information capable of establishing the direct communication path in the LTE Direct, the UE 10A does not transmit the communication path establishment request for the LTE Direct to the UE 10B. In a case where it is detected that at least one of the UE 10A and the UE 10B does not retain the capability by the identification information indicating the capability information capable of establishing the direct communication path in the WLAN Direct, the UE 10A does not transmit the communication path establishment request for the WLAN Direct to the UE 10B. The UE 10B which has received the request checks the Group ID (Group 1) and the ProSe ID (ProSe ID A) included in the direct communication request. In this case, the UE 10B checks that it is possible to perform the direct communication with the UE 10A by checking the Group ID and the ProSe ID of the UE 10A. The UE 10A which has received the direct communication request transmits a direct communication check response (S1204). Here, the UE 10B adds the Group ID (Group 1) and the ProSe ID (ProSe ID B). In this case, the UE 10A checks that it is possible to perform the direct communication with the UE 10A by checking the Group ID and the ProSe ID of the UE 10B.

The UE 10B may determine to establish the direct communication path in the public safety by using the information indicating the communication resource in the public safety from the UE 10A.

In a case where the UE 10A has added the identification information indicating the capability information capable of establishing the direct communication path in the LTE Direct, the UE 10B may determine to perform the direct communication in the LTE Direct. In a case where the UE 10A has added the identification information indicating the capability information capable of establishing the direct communication path in the WLAN Direct, the UE 10B may determine to perform the direct communication in the WLAN Direct.

Subsequently, the UE 10B changes the connection state to the RRC connection state through the service request procedure (S1206). The UE 10B of which the connection state has changed to the RRC connection state transmits the RRC authentication direct communication request to the eNB-B (S1208). The RRC authentication direct communication request includes Group ID, ProSe ID A, ProSe ID B, Group ID (Group 1), and APP server information. The ProSe ID A is UE identifier information indicating the UE 10A, and ProSe ID B is UE identifier information indicating the UE 10B. The APP server information is information related to a server that provides a service in an application which performs direct communication.

Here, in a case where the UE 10A is in coverage and the UE 10B is in coverage, the UE 10B may request the communication resource capable of being used in the public safety. As a specific requesting method, the identifier for requesting the communication resource capable of being used in the Non-public safety may be added. The identifier indicating not the communication resource capable of being used in the Non-public safety but the communication resource capable of being used in the Public safety may be added. Here, the UE 10B may previously manage whether or not to perform communication in the communication resource capable of being used in the Public safety or whether or not to perform communication in the communication resource capable of being used in the Non-public safety depending on the application. As mentioned above, this identifier may be determined depending on the application. This identifier may be determined depending on the In coverage flag 147 of the UE 10A and the In coverage flag 147 of the UE 10B.

The eNB-B or the MME-B may select a communication resource to be assigned using the identifier indicating the communication resource capable of being used in the Non-public safety or the public safety. Here, the communication resource may time, frequency or code, or may be another information for preventing interference. The communication resource may be any combination of information items such as time, frequency, and code. Information related to a transmission antenna and transmission power information necessary for the transmission may be added to the communication resource. The eNB-B which has received the RRC authentication direct communication request checks the Group ID, the ProSe ID A, the ProSe ID B, the Group ID and the APP server information. In a case where the identifier indicating the communication resource capable of being used in the Non-public safety or the public safety is included, the eNB-B may assign the communication resource based on the identification information for identifying the communication path used for the Public safety or the communication path used for the commercially available service, and may determine to notify the UE 10B of information related to the communication resource. The eNB-B may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination.

Thereafter, the eNB-B transmits a S1-AP authentication direct communication request to the MME-B (S1210). Here, the S1-AP authentication direct communication request includes Group ID, ProSe ID A, ProSe ID B, Group ID and APP server information.

Here, the eNB-B may request the communication resource capable of being used in the Public safety from the MME-B. As a specific requesting method, an identifier for requesting the communication resource capable of being used in the Non-public safety may be added. An identifier indicating not the communication resource capable of being used in the Non-public safety but the communication resource capable of being used in the Public safety may be added. Here, the eNB-B may previously determine whether or not to perform communication in the communication resource capable of being used in the Public safety or whether or not to perform communication in the communication resource capable of being used in the Non-public safety depending on the application, based on the notification from the UE 10B.

The MME-B may select a communication resource to be assigned using the identifier indicating the communication resource capable of being used in the Non-public safety or the public safety. Here, the communication resource may time, frequency or code, or may be another information for preventing interference. The communication resource may be any combination of information items such as time, frequency and code. Information related to a transmission antenna and transmission power information necessary for the transmission may be added to the communication resource.

The MME-B which has received the S1-AP authentication direct communication request checks the Group ID, the ProSe ID A, the ProSe ID B, the Group ID and the APP server information. In a case where the identifier indicating the communication resource capable of being used in the Non-public safety or the public safety is included, the MME-B may assign the communication resource based on the identification information for identifying the communication path used for the Public safety or the communication path used for the commercially available service, and may determine to notify the UE 10B of information related to the communication resource. The MME-B may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination.

Thereafter, the MME-B authenticates the establishment of the direct communication (S1212). Here, the MMEB checks whether or not the UEA and the UEB may establish the direct communication.

Subsequently, the MME-B transmits the notification of the S1-AP authentication direct communication to the eNB-B (S1214). Here, the notification of the S1-AP authentication direct communication includes Group ID, ProSe ID A, ProSe ID B, and a transmission parameter.

The eNB-B which has received the notification of the S1-AP authentication direct communication transmits a RRC authentication direct communication acceptance notification to the UE 10B (S1216). Here, the RRC authentication direct communication acceptance notification includes Group ID, ProSe ID A, ProSe ID B, and a transmission parameter. Here, in addition to the transmission parameter notified from the MME-B, the transmission parameter may be added in the eNB-B, as the transmission parameter. In a case where the identifier indicating the communication resource capable of being used in the Non-public safety or the public safety is included in the RRC authentication direct communication request (S1208), the eNB-B may assign the communication resource based on the identification information for identifying the communication path used for the Public safety or the communication path used for the commercially available service, and may notify the UE 10B of the information related to the communication resource. The eNB-B may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination. The UE 10B which has received the RRC authentication direct communication acceptance notification checks the Group ID, the ProSe ID A, the ProSe ID B, and the transmission parameter used in the direct communication.

Thereafter, the UE 10B transmits a RRC authentication direct communication completion notification (S1218). Here, the RRC authentication direct communication completion notification includes ProSe ID A, ProSe ID B, and Group ID. The UE 10A which has transmitted the RRC authentication direct communication completion notification may prepare to start the direct communication with the UE 10B.

The UE 10A and the UE 10B start the direct communication (S1220). In this case, the UE 10B may notify the UE 10A of the transmission parameter transmitted from the eNB-B. The UE 10B may assign an IP address used in the direct communication to the UE 10A.

Through the above-described procedure, it is possible to establish the communication path in one state in which the UE 10A is out of coverage and the UE 10B is in coverage.

### 1.3.2.1.4 UE 10A: In Coverage UE 10B: Out of Coverage

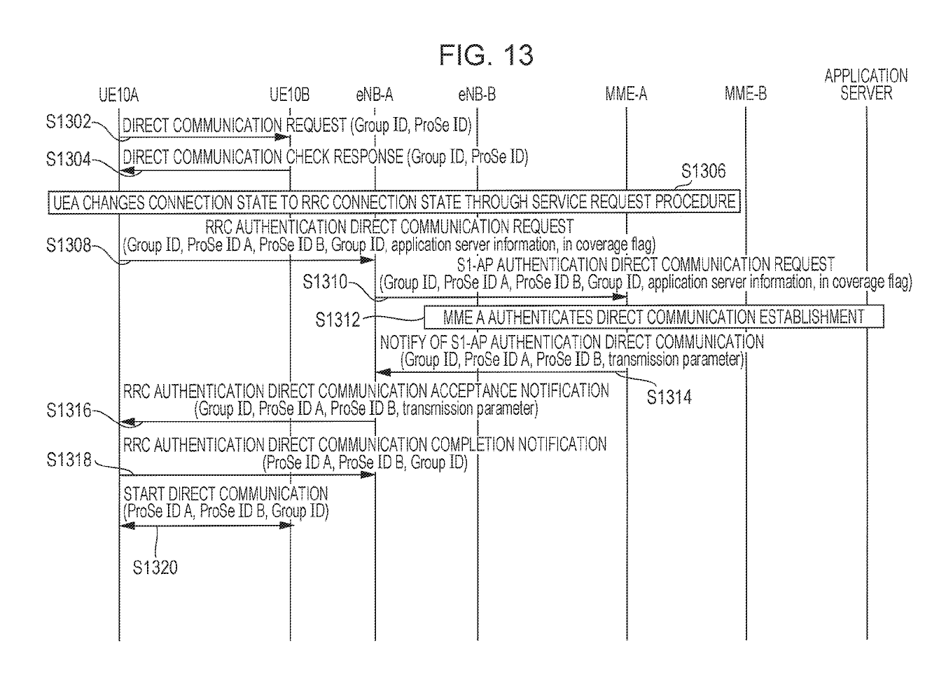

A communication path establishment procedure in one state in which the UE 10A is in coverage and the UE 10B is out of coverage will be described with reference to FIG. 13. In this procedure, the UE 10A is served in an eNB-A, and the eNB-A is managed by a MME-A. Here, the MME-A or the MME-B may be the ProSe server 90 (ProSe server A or ProSe server B).

Initially, the UE 10A transmits a direct communication request to the UE 10B (S1302). Here, the UE 10A adds Group ID (Group 1) and ProSe ID (ProSe ID A) managed by the UE 10A. Here, a trigger for performing the communication path establishment procedure may be a case where it is detected that the UE 10A and the UE 10B are in proximity, an application is operated such that the user performs the direct communication, and the application layer requests that the 3GPP layer is to perform the direct communication between the UE 10A and the UE 10B in the proximity discovery procedure. The trigger of the communication path establishment procedure may be a case where it is detected that the UE 10A and the UE 10B are present in proximity. Here, the UE 10A may add the in coverage flag 147, the public safety capability 148 and the public safety enable flag 149 to the direct communication request. The in coverage flag 147 may include information indicating that the UE 10B is served in the LTE base station (In coverage) (or this UE is not served in the LTE base station (Out of coverage)).

The communication path establishment request may include an identifier indicating the LTE Direct or the WLAN Direct. The direct communication path may be determined based on this identifier.

The Expression code of the UE 10A which performs the proximity discovery or the Expression code of the UE 10A which is a target of the proximity discovery may be included.

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The UE 10A may request that the direct communication path in the public safety is to be established. The UE 10A may request the acquisition of a resource for establishing the direct communication path. Here, in the acquisition of the resource for establishing the direct communication path, the UE 10A may notify that the UE 10A acquires the resource.

The UE 10A which has transmitted the direct communication request may prepare to start the direct communication with the UE 10B.

The communication path establishment request may include the identifier indicating the LTE Direct or the WLAN Direct. The direct communication path may be determined depending on this identifier. This identifier may be determined depending on the application. For example, the identifier may be managed and determined such that if a call application such as a phone is used, the LTE Direct is used, and if an application that deals a high-capacity video file is used, the WLAN Direct is used.

The UE 10A may request that the direct communication path in the Non-public safety is to be established. The UE 10A may notify that the UE 10A acquires a resource for establishing the direct communication path. The UE 10A may add the identifier indicating that the direct communication path in the Public safety is established. It is detected that at least one UE is out of coverage from the coverage information, and the direct communication path establishment request used for the Non-public safety is not transmitted based on this discovery.

Here, in a condition in which the Public safety capability 148 is “usable” in the UE 10A and the UE 10B, the UE 10A may transmit the direct communication request for the communication path establishment of the Public safety. In a case where the Public safety enable flag 149 is turned “on” in the UE 10A and the UE 10B, the UE 10A may transmit the direct communication request for the communication path establishment of the Public safety.

In a case where the Public safety capability 148 is “unusable” in at least one of the UE 10A and the UE 10B, the UE 10A does not transmit the direct communication request. In a case where the Public safety enable flag 149 is turned “off” in at least one of the UE 10A and the UE 10B, the UE 10A does not transmit the direct communication request.

In a case where it is detected that the UE 10B can use the LTE Direct, the UE 10A may add the identification information indicating the capability information capable of establishing the direct communication path in the LTE Direct. In a case where it is detected that the UE 10B can use the WLAN Direct, the UE 10A may add the identification information indicating the capability information capable of establishing the direct communication path in the WLAN Direct.

Here, in a case where both the UE 10A and the UE 10B have the capability by the identification information indicating the capability information capable of establishing the direct communication path in the LTE Direct, the UE 10A may transmit the communication path establishment request for the LTE Direct to the UE 10B. The establishment request may include the identification information indicating the communication path establishment request for the LTE Direct. In a case where both the UE 10A and the UE 10B have the capability by the identification information indicating the capability information capable of establishing the direct communication path in the WLAN Direct, the UE 10A may transmit the communication path establishment request for the WLAN Direct to the UE 10B. The establishment request may include the identification information indicating the communication path establishment request for the WLAN Direct.

In a case where it is detected that at least one of the UE 10A and the UE 10B does not retain the capability by the identification information indicating the capability information capable of establishing the direct communication path in the LTE Direct, the UE 10A does not transmit the communication path establishment request for the LTE Direct to the UE 10B. In a case where it is detected that at least one of the UE 10A and the UE 10B does not retain the capability by the identification information indicating the capability information capable of establishing the direct communication path in the WLAN Direct, the UE 10A does not transmit the communication path establishment request for the WLAN Direct to the UE 10B.

The UE 10B which has received the direct communication request from the UE 10A checks the Group ID (Group 1) and the ProSe ID (ProSe ID A) included in the direct communication request. In this case, the UE 10B checks that it is possible to perform the direct communication with the UE 10A by checking the Group ID and the ProSe ID of the UE 10A.

Since the UE 10A is in coverage and the UE 10B is out of coverage, the UE 10A may determine to establish the direct communication path in the public safety.

In a case where the UE 10A has added the identification information indicating the capability information capable of establishing the direct communication path in the LTE Direct, the UE 10B may determine to perform the direct communication in the LTE Direct. In a case where the UE 10A has added the identification information indicating the capability information capable of establishing the direct communication path in the WLAN Direct, the UE 10B may determine to perform the direct communication in the WLAN Direct.

The UE 10B which has received the direct communication request transmits the direct communication check response (S1304). Here, the UE 10B adds the Group ID (Group 1) and the ProSe ID (ProSe ID B). In this case, the UE 10A checks that it is possible to perform the direct communication with the UE 10A by checking the Group ID and the ProSe ID of the UE 10B.

The UE 10B may determine to establish the direct communication path in the public safety by using the information indicating the communication resource in the public safety from the UE 10A.

Subsequently, the UE 10A changes the connection state to the RRC connection state through the service request procedure (S1306). The UE 10A of which the connection state has changed to the RRC connection state transmits the RRC authentication direct communication request to the eNB-A (S1308). The RRC authentication direct communication request includes Group ID, ProSe ID A, ProSe ID B, Group ID (Group 1), and APP server information. The request for the permission for the direct communication path establishment may be performed by transmitting the RRC authentication direct communication request. The request for the resource for the direct communication path may be performed by transmitting the RRC authentication direct communication request.

Here, in a case where the UE 10A is in coverage and the UE 10B is in coverage, the UE 10A may request the communication resource capable of being used in the public safety. As a specific requesting method, the identifier for requesting the communication resource capable of being used in the Non-public safety may be added. The identifier indicating not the communication resource capable of being used in the Non-public safety but the communication resource capable of being used in the Public safety may be added. Here, the UE 10A may previously manage whether or not to perform communication in the communication resource capable of being used in the Public safety or whether or not to perform communication in the communication resource capable of being used in the Non-public safety depending on the application. As mentioned above, this identifier may be determined depending on the application. This identifier may be determined depending on the In coverage flag 147 of the UE 10A and the In coverage flag 147 of the UE 10B.

The eNB-A or the MME-A may select a communication resource to be assigned using the identifier indicating the communication resource capable of being used in the Non-public safety or the public safety. Here, the communication resource may time, frequency or code, or may be another information for preventing interference. The communication resource may be any combination of information items such as time, frequency and code. Information related to a transmission antenna and transmission power information necessary for the transmission may be added to the communication resource.

The eNB-A which has received the RRC authentication direct communication request checks the Group ID, the ProSe ID A, the ProSe ID B, the Group ID and the APP server information. In a case where the identifier indicating the communication resource capable of being used in the Non-public safety or the public safety is included, the eNB-A may assign the communication resource based on the identification information for identifying the communication path used for the Public safety or the communication path used for the commercially available service, and may determine to notify the UE 10A of information related to the communication resource. The eNB-A may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination.

Subsequently, the eNB-A transmits a S1-AP authentication direct communication request to the MME-A (S1310). Here, the S1-AP authentication direct communication request includes Group ID, ProSe ID A, ProSe ID B, Group ID and APP server information.

Here, the eNB-A may request the communication resource capable of being used in the Public safety from the MME-A. As a specific requesting method, an identifier for requesting the communication resource capable of being used in the Non-public safety may be added. An identifier indicating not the communication resource capable of being used in the Non-public safety but the communication resource capable of being used in the Public safety may be added. Here, the eNB-A may previously determine whether or not to perform communication in the communication resource capable of being used in the Public safety or whether or not to perform communication in the communication resource capable of being used in the Non-public safety depending on the application, based on the notification from the UE 10A.

The MME-A may select a communication resource to be assigned using the identifier indicating the communication resource capable of being used in the Non-public safety or the public safety. Here, the communication resource may time, frequency or code, or may be another information for preventing interference. The communication resource may be any combination of information items such as time, frequency and code. Information related to a transmission antenna and transmission power information necessary for the transmission may be added to the communication resource.

The MME-A which has received the S1-AP authentication direct communication request checks the Group ID, the ProSe ID A, the ProSe ID B, the Group ID and the APP server information. In a case where the identifier indicating the communication resource capable of being used in the Non-public safety or the public safety is included, the MME-A may assign the communication resource based on the identification information for identifying the communication path used for the Public safety or the communication path used for the commercially available service, and may determine to notify the UE 10A of information related to the communication resource. The MME-A may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination.

Thereafter, the MME-A authenticates the establishment of the direct communication (S1312). Here, the MME-A checks whether or not the UEA and the UEB may establish the direct communication.

Thereafter, the MME-A transmits the notification of the S1-AP authentication direct communication to the eNB-A (S1314). Here, the notification of the S1-AP authentication direct communication includes Group ID, ProSe ID A, ProSe ID B, and a transmission parameter.

The eNB-A which has received the notification of the S1-AP authentication direct communication transmits a RRC authentication direct communication acceptance notification to the UE 10A (S1316). Here, the RRC authentication direct communication acceptance notification includes Group ID, ProSe ID A, ProSe ID B, and a transmission parameter. Here, in addition to the transmission parameter notified from the MME-A, the transmission parameter may be added in the eNB-A, as the transmission parameter. In a case where the identifier indicating the communication resource capable of being used in the Non-public safety or the public safety is included in the RRC authentication direct communication request (S1308), the eNB-A may assign the communication resource based on the identification information for identifying the communication path used for the Public safety or the communication path used for the commercially available service, and may notify the UE 10B of the information related to the communication resource. The eNB-A may distinguishably manage the communication resource capable of being used in the Public Safety and the communication resource capable of being used in the Non-public safety in advance, and may assign the communication resource capable of being used in the Public safety or the communication resource capable of being used in the Non-public safety depending on the aforementioned determination. The UE 10A which has received the RRC authentication direct communication acceptance notification checks the Group ID, the ProSe ID A, the ProSe ID B, and the transmission parameter used in the direct communication.

Thereafter, the UE 10A transmits a RRC authentication direct communication completion notification (S1318). Here, the RRC authentication direct communication completion notification includes ProSe ID A, ProSe ID B, and Group ID. The UE 10A which has transmitted the RRC authentication direct communication completion notification may prepare to start the direct communication with the UE 10B.

The UE 10A and the UE 10B start the direct communication (S1320). In this case, the UE 10A may notify the UE 10B of the transmission parameter transmitted from the eNB-A. The UE 10A may assign an IP address used in the direct communication to the UE 10B.

In the above-described procedure, in a case where the MME 40 and the ProSe server 90 are different devices, the processes of the MME 40 (MME-A or MME-B) may be performed in the ProSe server 90.

Through the above-described procedure, it is possible to establish the communication path in one state in which the UE 10A is in coverage and the UE 10B is out of coverage.

### 1.3.2.2 Communication Path Establishment Procedure 2

Hereinafter, Communication Path Establishment Procedure 2 different from Communication Path Establishment Procedure 1 will be described. A difference from Communication Path Establishment Procedure 1 is that the UE assigns a direct communication ID for identifying the direct communication. In Communication Path Establishment Procedure 2, different communication path establishment procedures are also performed in one state in which the UE 10A is in coverage and the UE 10B is in coverage, one state in which the UE 10A is out of coverage and the UE 10B is in coverage, one state in which the UE 10A is in coverage and the UE 10B is out of coverage and one state in which the UE 10A is out of coverage and the UE 10B is out of coverage.

### 1.3.2.2.1 UE 10A: In Coverage UE 10B: In Coverage UE 10A: In Coverage UE 10B: Out of Coverage

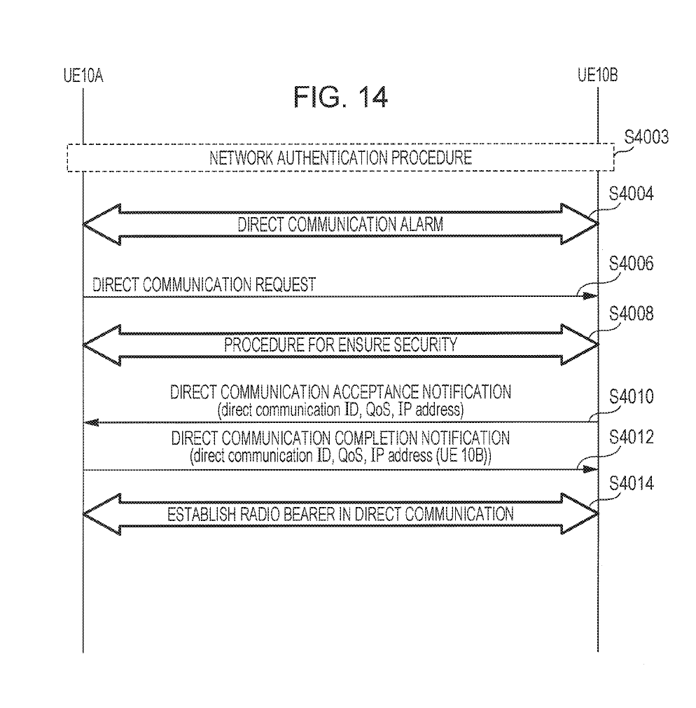

A communication path establishment procedure in a case where the UE 10A is in coverage and the UE 10B is in coverage will be described with reference to FIG. 14.

This procedure can be similarly used in the communication path establishment procedure in the case where the UE 10A is in coverage and the UE 10B is out of coverage. Here, a trigger for performing the communication path establishment procedure may be a case where it is detected that the UE 10A and the UE 10B are in proximity, an application is operated such that the user performs the direct communication, and the application layer requests that the 3GPP layer is to perform the direct communication between the UE 10A and the UE 10B in the proximity discovery procedure. The trigger of the communication path establishment procedure may be a case where it is detected that the UE 10A and the UE 10B are present in proximity.

In a case where the UE 10A is in coverage and the UE 10B is in coverage, the UE 10A may determine to establish the direct communication path in the non-public safety, and may determine to request the resource for establishing the communication path in the non-public safety.

In a case where the UE 10A is in coverage and the UE 10B is out of coverage, the UE 10A may determine to establish the direct communication path in the public safety, and may determine to request the resource for establishing the communication path in the public safety.

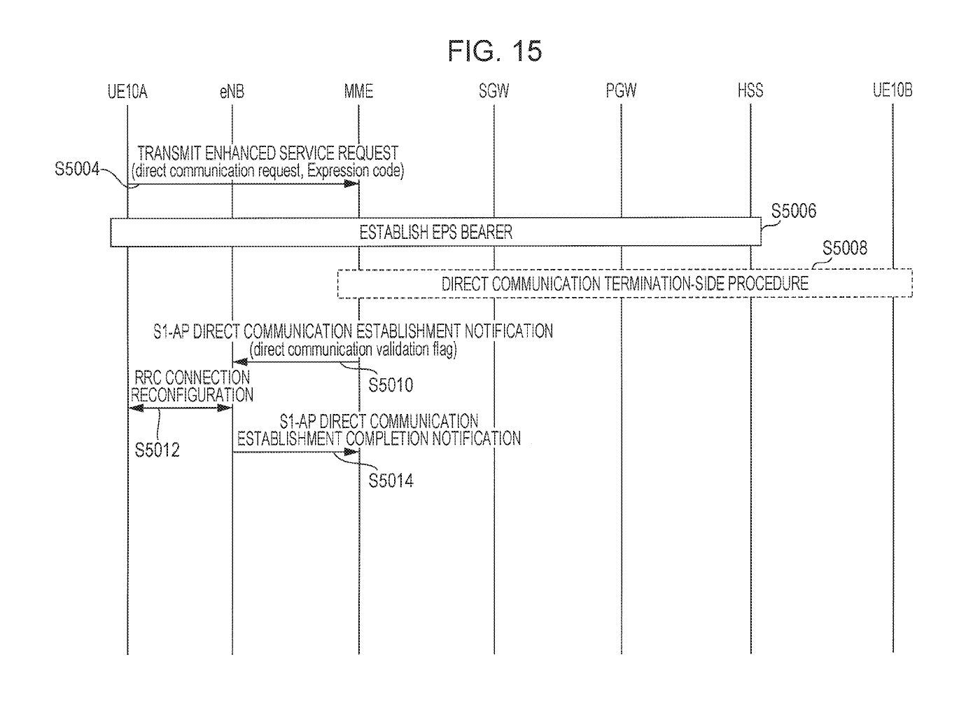

Initially, the UE 10A performs a network authentication procedure (S4003). The network authentication procedure will be described with reference to FIG. 15. Initially, the UE 10A transmits an enhanced service request (S5004). Here, the UE 10A notifies of the enhanced service request by adding the direct communication request and the expression code to the enhanced service request.

Here, the UE 10A may add the in coverage flag 147, the public safety capability 148, and the public safety enable flag 149 to the enhanced service request. The in coverage flag 147 may include information indicating that the UE 10B is served in the LTE base station (In coverage) (or this UE is not served in the LTE base station (Out of coverage)).

Here, as a method of detecting that the UE 10A is served in the LTE base station, various methods are considered. For example, if information transmitted from the eNB 45 (eNB-A) is received within a predetermined period of time, it may be determined that this UE is served in the LTE base station, and if the information transmitted from the eNB 45 (eNB-A) is not received within a predetermined period of time, it may be determined that this UE is not served in the LTE base station.

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

In a case where the UE 10A is in coverage and the UE 10B is in coverage, the UE 10A may determine to establish the direct communication path in the non-public safety, and may request the resource for establishing the communication path in the non-public safety.

In a case where the UE 10A is in coverage and the UE 10B is out of coverage, the UE 10A may determine to establish the direct communication path in the public safety, and may request the resource for establishing the communication path in the public safety.

The UE 10A may add the identifier indicating the capability information of the UE 10A capable of establishing the direct communication path in the LTE Direct. The UE 10A may add the identifier indicating the capability information of the UE 10A capable of establishing the direct communication path in the WLAN Direct.

Here, in a case where both the UE 10A and the UE 10B have the capability by the identification information indicating the capability information capable of establishing the direct communication path in the LTE Direct, the UE 10A may transmit the communication path establishment request for the LTE Direct to the MME 40. The establishment request may include the identification information indicating the communication path establishment request for the LTE Direct. In a case where both the UE 10A and the UE 10B have the capability by the identification information indicating the capability information capable of establishing the direct communication path in the WLAN Direct, the UE 10A may transmit the communication path establishment request for the WLAN Direct to the MME 40. The establishment request may include the identification information indicating the communication path establishment request for the WLAN Direct.

In a case where it is detected that at least one of the UE 10A and the UE 10B does not retain the capability by the identification information indicating the capability information capable of establishing the direct communication path in the LTE Direct, the UE 10A does not transmit the communication path establishment request for the LTE Direct to the MME 40. In a case where it is detected that at least one of the UE 10A and the UE 10B does not retain the capability by the identification information indicating the capability information capable of establishing the direct communication path in the WLAN Direct, the UE 10A does not transmit the communication path establishment request for the WLAN Direct to the MME 40.

The MME 40 which has received the enhanced service request checks the direct communication request and the expression code from the enhanced service request. In a case where the in coverage flag 147 is included, the in coverage flag 147 is checked. Here, as the in coverage flag 147, there are a case where the UE 10A is in coverage and the UE 10B is in coverage, and a case where the 10A is in coverage and the UE 10B is out of coverage.

The MME 40 may detect that the UE 10A can use the LTE Direct by the identification information indicating the capability information of the UE 10A capable of establishing the direct communication path in the LTE Direct. The MME 40 may detect that the UE 10A can use the WLAN Direct by the identification information indicating the capability information of the UE 10A capable of establishing the direct communication path in the WLAN Direct.

Thereafter, the MME 40 establishes an EPS bearer from the UE 10A to the PGW 30 (S5006). The establishment of the EPS bearer means that the bearers are established between the UE 10A and the eNB 45, between the eNB 45 and the SGW 35, and between the SGW 35 and the PGW 30 by using the procedure that has been used in the related art.

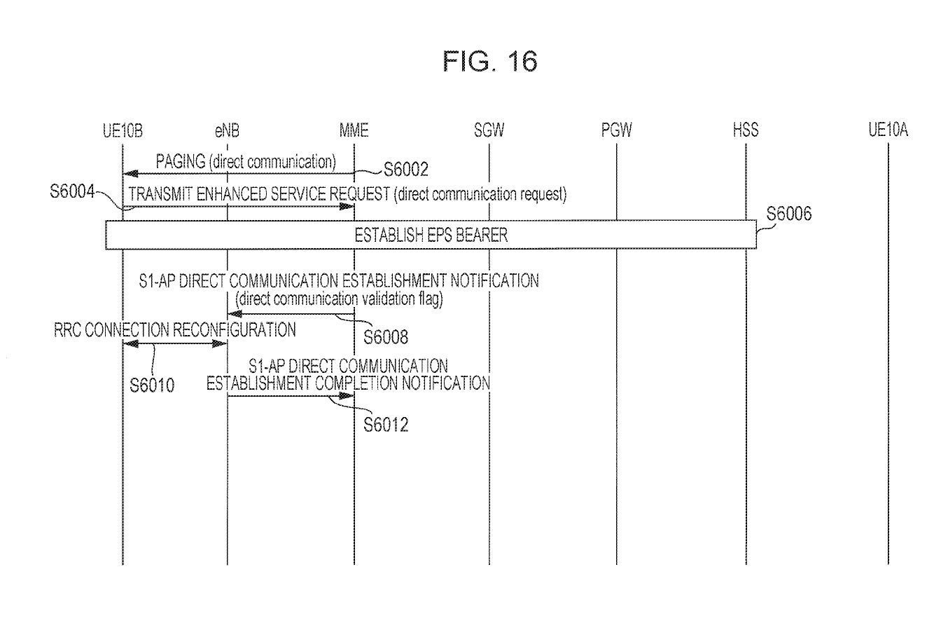

Subsequently, the MME 40 performs a direct communication termination-side procedure on the UE 10B (S5008). Here, the MME 40 may not perform the direct communication termination-side procedure in a case where the in coverage flag is included and also in a case where the UE 10B is out of coverage. Meanwhile, in a case where the in coverage flag 147 is included and the UE 10A is in coverage and the UE 10B is in the In coverage, the direct communication termination-side procedure is performed. The direct communication termination-side procedure will be described with reference to FIG. 16. Initially, the MME 40 transmits paging to the UE 10B (S6002). Here, the paging includes an identifier indicating the direct communication. The UE 10B which has received the paging detects that the paging is addressed to the UE 10B and the request for the direct communication is performed.

Subsequently, the UE 10B transmits the enhanced service request (S6004). Here, since the identifier indicating the direct communication is included, the UE 10B adds information indicating the direct communication request. The MME 40 which has received the enhanced service request authenticates that the UE 10B performs the direct communication with the UE 10A. Here, in a case where it is difficult to detect the enhanced service request as a response of the paging from the UE 10B within a predetermined period of time, the MME 40 may determine that the UE 10B is out of coverage. In a case where it is determined that the UE 10B is out of coverage, the procedure is returned to S5008 in FIG. 15 without performing the subsequent procedures and the procedure of S5010 may be started. Subsequently, the MME 40 establishes an EPS bearer from the UE 10B to the PGW 30 (S6006). The establishment of the EPS bearer means that the bearers are established between the UE 10B and the eNB 45, between the eNB 45 and the SGW 35, and between the SGW 35 and the PGW 30 by using the procedure that has been used in the related art.

Subsequently, the MME 40 transmits a S1-AP direct communication establishment notification to the eNB 45 (S6008). The S1-AP direct communication establishment notification includes a direct communication validation flag.

The eNB 45 which has received the S1-AP direct communication establishment notification performs the RRC connection reconfiguration with the UE 10 (S6010). The eNB 45 checks that the RRC connection reconfiguration with the UE 10 is performed, and transmits a S1-AP direct communication establishment completion notification to the MME 40 (S6012).

Through the above-described procedure, the direct communication termination-side procedure can be performed. The MME 40 which has received the S1-AP direct communication establishment completion notification transmits the S1-AP direct communication establishment notification to the eNB 45 (S5010). The S1-AP direct communication establishment notification includes the direct communication validation flag.

The eNB 45 which has received the S1-AP direct communication establishment notification performs the RRC connection reconfiguration with the UE 10B (55012). The eNB 45 checks that the RRC connection reconfiguration with the UE 10 is performed, and transmits the S1-AP direct communication establishment completion notification to the MME 40 (55014).

Through the above-described procedure, the UE 10A and the UE 10B can perform the network authentication procedure for starting the direct communication.

Thereafter, the UE 10A and the UE 10B which have completed the network authentication procedure transmit a direct communication alarm to each other (S4004). The UE 10A and the UE 10B detect that the direct communication is started based on this notification.

Subsequently, the UE 10A transmits the direct communication request to the UE 10B (S4006).

Here, the UE 10A may add the in coverage flag 147, the public safety capability 148 and the public safety enable flag 149 to the direct communication request. The in coverage flag 147 may include information indicating that the UE 10B is served in the LTE base station (In coverage) (or this UE is not served in the LTE base station (Out of coverage)).

The Expression code of the UE 10A which performs the proximity discovery or the Expression code of the UE 10A which is a target of the proximity discovery may be included.

Here, the UE 10A may add the in coverage flag 147, the public safety capability 148 and the public safety enable flag 149 to the direct communication request. The in coverage flag 147 may include information indicating that the UE 10B is served in the LTE base station (In coverage) (or this UE is not served in the LTE base station (Out of coverage)).

Here, as a method of detecting that the UE 10A is served in the LTE base station, various methods are considered. For example, if information transmitted from the eNB 45 (eNB-A) is received within a predetermined period of time, it may be determined that this UE is served in the LTE base station, and if the information transmitted from the eNB 45 (eNB-A) is not received within a predetermined period of time, it may be determined that this UE is not served in the LTE base station.

The communication path establishment request may include an identifier indicating the LTE Direct or the WLAN Direct. The direct communication path may be determined based on this identifier. This identifier may be determined based on the application. For example, the identifier may be managed and determined such that if a call application such as a phone is used, the LTE Direct is used, and if an application that deals a high-capacity video file is used, the WLAN Direct is used.

The Expression code of the UE 10A which performs the proximity discovery or the Expression code of the UE 10A which is a target of the proximity discovery may be included.

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The direct communication request may include an identifier indicating the LTE Direct or the WLAN Direct. The direct communication path may be determined based on this identifier. This identifier may be determined based on the application. For example, the identifier may be managed and determined such that if a call application such as a phone is used, the LTE Direct is used, and if an application that deals a high-capacity video file is used, the WLAN Direct is used.

The UE 10A may add the identifier indicating the capability information of the UE 10A capable of establishing the direct communication path in the LTE Direct. The UE 10A may add the identifier indicating the capability information of the UE 10A capable of establishing the direct communication path in the WLAN Direct.

Here, in a case where both the UE 10A and the UE 10B have the capability by the identification information indicating the capability information capable of establishing the direct communication path in the LTE Direct, the UE 10A may transmit the communication path establishment request for the LTE Direct to the UE 10B. The establishment request may include the identification information indicating the communication path establishment request for the LTE Direct. In a case where both the UE 10A and the UE 10B have the capability by the identification information indicating the capability information capable of establishing the direct communication path in the WLAN Direct, the UE 10A may transmit the communication path establishment request for the WLAN Direct to the UE 10B. The establishment request may include the identification information indicating the communication path establishment request for the WLAN Direct.

In a case where it is detected that at least one of the UE 10A and the UE 10B does not retain the capability by the identification information indicating the capability information capable of establishing the direct communication path in the LTE Direct, the UE 10A does not transmit the communication path establishment request for the LTE Direct to the UE 10B. In a case where it is detected that at least one of the UE 10A and the UE 10B does not retain the capability by the identification information indicating the capability information capable of establishing the direct communication path in the WLAN Direct, the UE 10A does not transmit the communication path establishment request for the WLAN Direct to the UE 10B.

The UE 10B may detect that the UE 10A can use the LTE Direct by the identification information indicating the capability information of the UE 10A capable of establishing the direct communication path in the LTE Direct, based on the direct communication request. The UE 10B may detect that the UE 10A can use the WLAN Direct by the identification information indicating the capability information of the UE 10A capable of establishing the direct communication path in the WLAN Direct.

Thereafter, the UE 10A and the UE 10B perform a procedure for ensuring security (S4008). Here, a method of ensuring the security between the UE 10A and the UE 10B, various methods are considered. For example, an encryption key is previously retained between the UE 10A and the UE 10B, and IPsec is used.

After the security between the UE 10A and the UE 10B is ensured, the UE 10B transmits a direct communication acceptance notification to the UE 10A (S4010). The direct communication acceptance notification includes a direct communication ID, QoS, and an IP address. Here, the direct communication ID is an identifier for identifying the direct communication established between the UE 10A and the UE 10B. A predetermined QoS may be notified, or QoS selected from a plurality of QoS candidates may be notified. The IP address may be generated by various methods. For example, in the UE 10B, an IPv6 link local address may be generated and notified. The generated IPv6 link local address may be notified as an IP address used by the UE 10B, or may be notified as an IP address used by the UE 10A. The UE 10A which has received the direct communication acceptance notification checks the direct communication ID, the QoS and the IP address of the UE 10A included in the direct communication acceptance notification.

Thereafter, the UE 10A transmits the direct communication completion notification to the UE 10B. The direct communication completion notification includes the direct communication ID, the QoS and the IP address of the UE 10B. Here, the direct communication ID is a direct communication ID notified from the UE 10B. The QoS is QoS notified from the UE 10B. In UE 10A, an IPv6 link local address is generated and is notified as the IP address. The generated IPv6 link local address may be notified as an IP address used by the UE 10B, or may be notified as an IP address used by the UE 10A. However, in a case where the UE 10B notifies of the IP address of the UE 10A, the UE 10A notifies of the IP address of the UE 10B. In a case where the UE 10B notifies of the IP address of the UEB, the UE 10A notifies of the IP address of the UE 10A.

Subsequently, the UE 10A and the UE 10B establish a radio bearer of the direct communication (S4014).

Through the above-described procedure, it is possible to establish the communication path in one state in which the UE 10A is in coverage and the UE 10B is in coverage. It is possible to establish the communication path in one state in which the UE 10A is in coverage and the UE 10B is out of coverage.

### 1.3.2.2.2 UE 10A: Out of Coverage, UE 10B: Out of Coverage

A communication path establishment procedure in one state in which the UE 10A is out of coverage and the UE 10B is out of coverage will be described with reference to FIG. 14. In a case where the UE 10A is out of coverage and the UE 10B is out of coverage, a procedure is started with a direct communication alarm without performing the network authentication procedure (S4003) (S4004).

Here, the UE 10A may previously assign the resource retained by the UE 10A to the direct communication path, may add the information related to the resource, and may transmit the direct communication path establishment request to the UE 10B.

Since the UE 10A is out of coverage and the UE 10B is out of coverage, the UE 10A may determine to establish the direct communication path in the public safety. Other procedures may be performed by the same method as the method described in [1.3.2.2.1 UE 10A: In coverage, UE 10B: In coverage].

Through the above-described procedure, the communication path can be established in one state in which the UE 10A is out of coverage and the UE 10B is out of coverage.

### 1.3.2.2.3 UE 10A: Out of Coverage, UE 10B: In Coverage

A communication path establishment procedure in one state in which the UE 10A is out of coverage and the UE 10B is in coverage will be described. A communication path establishment procedure in one state in which the UE 10A is out of coverage and the UE 10B is in coverage will be described with reference to FIGS. 14 and 15. A difference from the case where the UE 10A is in coverage and the UE 10B is out of coverage is that the UE 10A of FIG. 15 may be operated as the UE 10B and the UE 10A may be operated as the UE 10B. Here, in a case where the UE 10A is out of coverage and the UE 10B is in coverage, the UE 10A may determine to establish the direct communication path in the public safety, and may request the resource for establishing the communication path in the public safety.

Through the above-described procedure, the communication path can be established in one state in which the UE 10A is out of coverage and the UE 10B is in coverage.

As stated above, it can be detected that a communication source UE and a communication destination UE are served in the LTE base station. In a case where the communication source UE or the communication destination UE is served in the LTE station, it is possible to perform the communication path establishment procedure under the control of the mobile communication provider.

In a case where the communication source UE and the communication destination UE are not served in the LTE base station, it is possible to perform the communication path establishment procedure without obtaining the authentication of the mobile communication provider whenever the communication path is established.

### 2. Second Embodiment

Hereinafter, a second embodiment will be described. In the second embodiment, a different proximity discovery procedure is performed. In the present embodiment, the structure of the mobile communication system of FIG. 1 can be used, and thus, the detailed description thereof will be omitted. Since the structure of the UE, the structure of the ProSe server and the structure of the APP server are the same as those in the mobile station device, and the detailed description thereof will be omitted.

### 2.3 Description of Process

### 2.3.1 Proximity Discovery Procedure

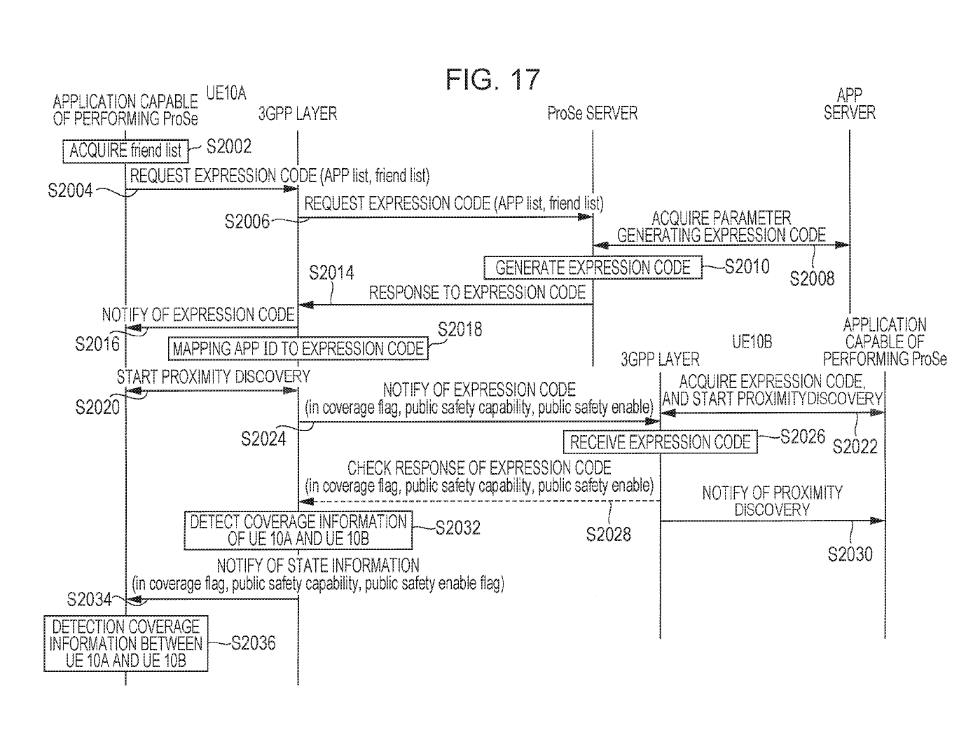

A proximity discovery procedure according to the present embodiment will be described with reference to FIG. 17. Here, the ProSe server 90 may be the MME 40.

Initially, the UE 10A acquires a friend list (S2002). Here, the UE 10A may previously retain the friend list by the configuration of the user, and may acquire the friend list from the APP server 95 by communicating with the APP server 95. The acquired friend list is identification information managed by the application layer. As an example of the identification information, a user ID of an individual application such as Skype or LINE may be used.

Thereafter, the application of the UE 10A requests the Expression code from the 3GPP layer of the UE 10A (S2004). This request may be an authentication request message for allowing the UE 10 to perform a ProSe service, may be a service request message for allowing the UE 10 to perform the ProSe service, or may be a registration request message for registering the UE 10 in the ProSe service. The ProSe service to be performed may be a service for proximity terminal discovery, may be a service for establishing a direct communication path with a proximity communication terminal, or may be a service including both the services.

The request for the Expression code may be transmitted by adding an APP list, a friend list or a UE ID to the request for the Expression code. The UE ID may be IMSI (International Mobile Subscriber Identity) for identifying the UE 10, or may be user identification information used in the application. Here, since the UE 10 performs the communication through ProSe (or proximity discovery) with a UE 10a in APP 1, the APP 1 is included in the APP list, and the UE 10B is included in the friend list. Here, in a case where the communication through ProSe is performed in a plurality of applications, the plurality of applications may be notified. In a case where the communication through ProSe with a plurality of UEs is performed, identification information items of the plurality of UEs may be included in the friend list.

The APP list and the friend list may be identification information items managed by the application.

The 3GPP layer of the UE 10A requests the Expression code from the ProSe server 90 (S2006). The request for the Expression code includes the APP list and the friend list. Here, the APP list and the friend list are the APP list and the friend list notified from the application of the UE 10A in S2004.

The ProSe server 90 which has received the request for the Expression code extracts the APP list (APP 1) and the friend list included in the request for the Expression code. Thereafter, the ProSe server 90 searches for the APP server 95 based on the APP list. The ProSe server 90 which has searched for the APP server 95 acquires a parameter which generates the Expression code by communicating with the APP server 95 (S2008). Here, as the parameter which generates the Expression code, for example, an encryption key for encrypting the Expression code may be acquired, and an algorithm for generating the Expression code may be acquired.

Subsequently, the ProSe server 90 generates the Expression code (S2010). As the Expression code, an Expression code is generated using the APP list 142 and the friend list 144 received from the UE 10 or the information acquired from the APP server 95. Here, the Expression code of the UE 10A which has transmitted the request for the Expression code is generated in addition to generating the Expression code for a communication target UE included in the friend list.

Subsequently, the ProSe server 90 transmits the response of the Expression code to the UE 10 (S2014). Here, the ProSe server 90 adds the Expression code generated in S2010. The ProSe server 90 may transmit a signal for allowing the UE 10 to discover the proximity terminal or information related to time or frequency for transmitting the signal for allowing the UE 10 to discover the proximity terminal. For example, some candidates of frequency information or time information capable of being used in the communication using ProSe or the proximity discovery in ProSe may be previously assigned, and information indicating the candidate to be used may be notified.

The ProSe server 90 also notifies the UE 10B which is a communication target of the UE 10A as well as the UE 10A of the Expression code (S2022). Here, the UE 10A notifies of the announced Expression code. The UE 10B receives the transmitted Expression code, and monitors the Expression code. As a method of transmitting the Expression code from the UE 10A to the UE 10B, the Expression code may be transmitted and received by the application layer, and may be transmitted and received by the 3GPP layer. As mentioned above, the UE 10A transmits a signal for requesting the discovery of the UE 10A.

The signal transmitted from the 3GPP layer of the UE 10A so as to perform the proximity discovery may be transmitted every predetermined time interval. This signal may be transmitted whenever the in coverage flag 147 is updated. The in coverage flag 147 is transmitted by being updated and being included in a discovery request signal depending on a situation in coverage or out of coverage at a point of time of the transmission.

The ProSe server 90 may transmit a signal for allowing the UE 10B to discover the proximity terminal or information related to time or frequency for transmitting the signal for allowing the UE 10A to discover the proximity terminal. For example, some candidates of frequency information or time information capable of being used in the communication using ProSe or the proximity discovery in ProSe may be previously assigned, and information indicating the candidate to be used may be notified.

The UE 10A receives the response corresponding to the request transmitted to the authentication server, and receives the Expression code. The UE 10A causes the application layer to detect that the Expression code is received (S2016), and manages the Expression code and the APP ID indicating the application classification by mapping these information items (S2018).

Thereafter, the UE 10A notifies the UE 10B of the Expression code (S2024). The Expression code for the proximity discovery includes the in coverage flag 147, the public safety capability 148 and the public safety enable flag 149. The Expression code is an identifier for allowing the UE 10B to detect that the UE 10A is present in proximity by being transmitted from the UE 10A in a broadcast manner and being received by the UE 10B.

Here, the in coverage flag 147 may include information indicating that the UE 10A is served in the LTE base station (In coverage) (or this UE is not served in the LTE base station (Out of coverage)).

Here, the in coverage flag 147 may include information indicating that the UE 10A is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The UE 10A may detect whether or not the network supports the service related to ProSe based on the received information. Based on the result of this detection, the ProSe service to be performed may be a service for the proximity terminal discovery, may be a service for establishing the direct communication path with the proximity communication terminal, or may be a service including both the services.

As mentioned above, the UE 10A may receive information indicating whether or not a network to be connected supports a service related to ProSe, such as the proximity discovery and the communication path establishment between the proximity terminals, from the network, and may transmit the request message in a case where the network supports the ProSe service, and the UE 10A may determine not to transmit the request message in a case where the network does not support the ProSe service.

The notification of the Expression code transmitted from the 3GPP layer of the UE 10A may be transmitted every predetermined time interval. This notification may be transmitted whenever the in coverage flag 147 is updated.

The UE 10A may add identification information indicating capability information of the UE 10A capable of establishing the direct communication path in the LTE Direct. The UE 10A may add identification information indicating capability information of the UE 10A capable of establishing the direct communication path in the WLAN Direct.

Thereafter, the UE 10B receives the Expression code of the UE 10A (S2026). The UE 10B checks that the direct communication with the UE 10A is performed. Here, the UE 10B checks the public safety enable flag 149, the public safety capability 148 and the in coverage flag 147 of the UE 10A.

It is possible to detect that the UE 10A and the UE 10B are in any one state of the four states. Specifically, it is possible to detect that these UEs are in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

The UE 10B may detect that the UE 10A can use the LTE Direct by the identification information indicating the capability information of the UE 10A capable of establishing the direct communication path in the LTE Direct. The UE 10B may detect that the UE 10A can use the WLAN Direct by the identification information indicating the capability information of the UE 10A capable of establishing the direct communication path in the WLAN Direct.

The UE 10B which has checked that the direct communication with the UE 10A is performed may transmit the check response of the Expression code to the UE 10A (S2028). Accordingly, the UE 10B can notify the UE 10A that it is detected that the UE 10A is present in proximity. The UE 10A can detect that the UE 10B is present in proximity of the UE 10A by receiving this response. This response includes the public safety enable flag 149, the public safety capability 148 and the in coverage flag 147 of the UE 10B. The in coverage flag 147 may include information indicating that the UE 10A is served in the LTE base station (In coverage) (or this UE is not served in the LTE base station (Out of coverage)).

The in coverage flag 147 may include information indicating that the UE 10A is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

Meanwhile, the UE 10B notifies the application that the proximity discovery is performed by the UE 10A (S2030).

The UE 10A which has received the check response of the Expression code detects the coverage information between the UE 10A and the UE 10B (S2032). In this case, as shown in FIG. 10, it is possible to select the communication path establishment procedure by detecting that the coverage information of the UE 10A and the UE 10B detected in the UE 10A is in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

Subsequently, the 3GPP layer of the UE 10A notifies the application layer of the coverage information of the UE 10A and the UE 10B (S2034). Here, the in coverage flag 147, the public safety capability 148, and the public safety enable flag 149 are included. The included In coverage flag 147 is in coverage flag 147 included in the check response of the Expression code in the UE 10B or the In coverage flag 147 detected in the UE 10A. The application layer which has received from the 3GPP layer of the UE 10A detects the coverage information between the UE 10A and the UE 10B (S2036). In this case, as shown in FIG. 10, it is possible to select the communication path establishment procedure by detecting that the coverage information of the UE 10A and the UE 10B detected in the application layer is in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage and one state in which the UE 10A is out of coverage and the UE 10B is out of coverage.

Here, even after the proximity discovery request is detected by the UE 10B, the UE 10A may continue to transmit the signal for the proximity discovery every predetermined time interval. This signal may be transmitted whenever the in coverage flag 147 is updated. The in coverage flag 147 is transmitted by being updated and being included in a discovery request signal depending on a situation in a coverage or out of coverage at a point of time of the transmission.

Here, in a case where the public safety capability of the UE 10A is “unusable” and the in coverage flag of the UE 10A is out of coverage, it may be determined that it is difficult to perform the direct communication. In a case where the public safety enable flag of this UE is turned “off” and the in coverage flag of this UE is out of coverage, it may be determined that it is difficult to perform the direct communication.

Through the above-described procedure, the UE 10B can detect the coverage information in the UE 10A and the UE 10B.

Here, in a series of procedures S2002 to S2026 and S2030, the procedure may be started by exchanging the UE 10A and the UE 10B. That is, the application of the UE 10A may acquire the friend list (S2002), and may request the Expression code (S2004). The 3GPP layer of the UE 10A may request the Expression code (S2006). The ProSe server 90 may acquire the parameter which generates the Expression code (S2008), may generate the Expression code (S2010), and may transmit the response of the Expression code (S2014). The 3GPP layer of the UE 10B may notify of the Expression code (S2016), and may map the APP ID to the Expression code (S2018). The application of the UE 10B may request the start of the proximity discovery (S2020), and the UE 10A may acquire the Expression code and may start the proximity discovery (S2022). The 3GPP layer of the UE 10B may notify the 3GPP layer of the UE 10A of the Expression code (S2024), may receive the Expression code (S2026), and may notify of the proximity discovery (S2030).

The transmission (S2024) of the broadcast transmitted to the UE 10B from the UE 10A may be performed in a unicast manner by using a previously acquired communication resource. Alternatively, the transmission (S2024) of the broadcast transmitted to the UE 10A from the UE 10B may be performed in a unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

The transmission (S2028) of the broadcast transmitted to the UE 10A from the UE 10B may be performed in a unicast manner by using a previously acquired communication resource. Alternatively, the transmission (S2028) of the broadcast transmitted to the UE 10B from the UE 10A may be performed in a unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

Through the above-described procedure, the UE 10A can detect the coverage information in the UE 10A and the UE 10B. That is, it is possible to detect that these UEs are in any one state of four states of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

In the proximity discovery procedure, the UE 10A detects the coverage information in the UE 10A and the UE 10B, and a communication path establishment procedure is performed based on the coverage information. Specifically, different communication path establishment procedures are performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage. The communication path establishment procedure is the same method as the method described in the first embodiment, and thus, the detailed description will be omitted.

Through the above description, it is possible to detect that the communication source UE and the communication destination UE are served in the LTE base station. In a case where the communication source UE or the communication destination UE is served in the LTE base station, it is possible to perform the communication path establishment procedure under the control of the mobile communication provider.

In a case where the communication source UE and the communication destination UE are not served in the LTE base station, it is possible to perform the communication path establishment procedure without obtaining the authentication of the mobile communication provider whenever the communication path is established.

### 3. Third Embodiment

A third embodiment will be described. The third embodiment is different from the first embodiment and the second embodiment in that identification information managed in the UE is different. Identification information managed in the ProSe server is different. A proximity discovery procedure is different.

### 3.2 Device Structure

### 3.2.1 Structure of UE

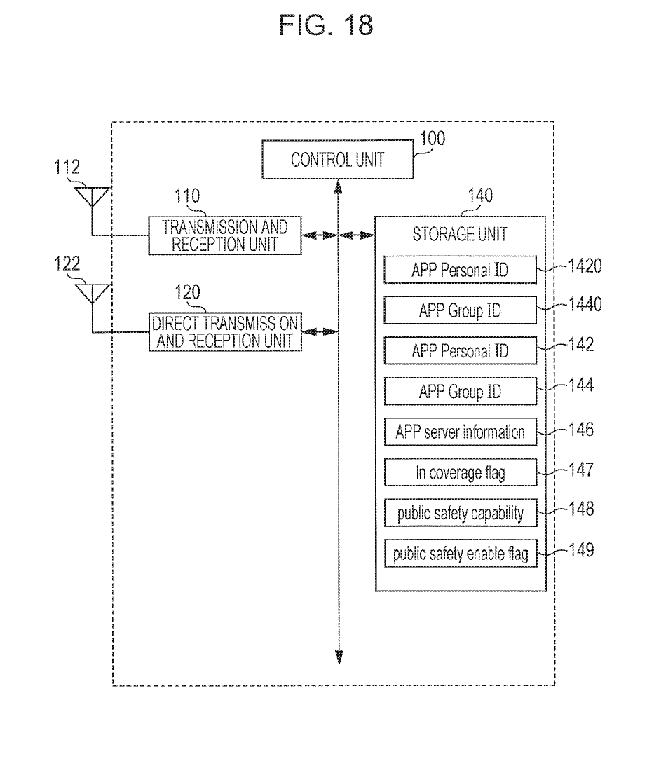

The structure of the UE 10A according to the third embodiment will be described with reference to FIG. 18. In the third embodiment, in the UE 10A, an identifier managed in the storage unit 140 is different. Specifically, the storage unit 140 adds and manages APP Personal ID 1420, and APP Group ID 1440. Except for the APP Personal ID 1420 and the APP Group ID 1440 in the storage unit 140, the third embodiment is the same structure as those of the first embodiment and the second embodiment, and thus, the detailed description thereof will be omitted.

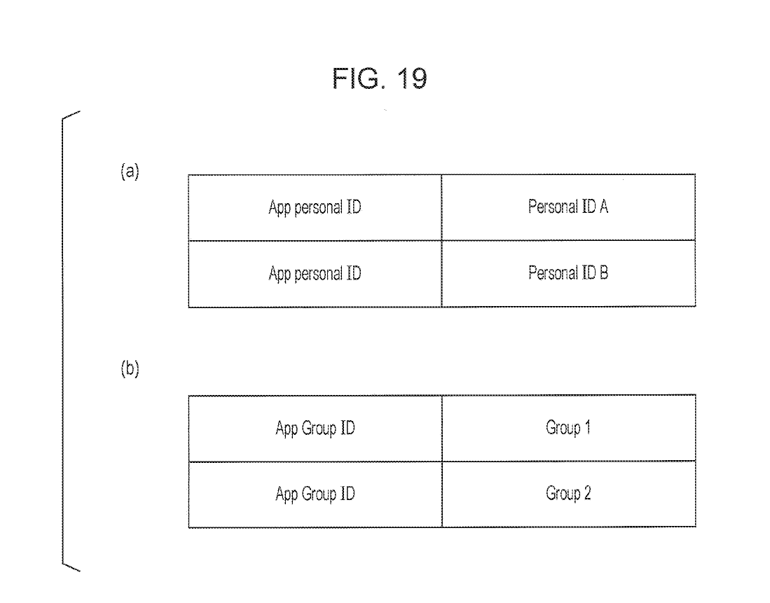

FIG. 19(a) shows an example of the APP Personal ID 1420. In FIG. 19(a), an identifier (APP Personal ID A) for identifying the UE 10A and an identifier (APP Personal ID B) for identifying the UE 10B are managed. The APP Personal ID 1420 may be managed for each application. That is, the APP Personal ID 1420 may be managed for each APP.

FIG. 19(b) shows an example of the APP Group ID 1440. The APP Group ID 1440 manages an identifier for identifying a group in which the UE 10A participates. The UE 10A can restrict the UE on which the proximity discovery and the direct communication are performed by the APP Group ID 1440. In FIG. 19(b), the APP Group ID 1440 manages Group 1 and Group 2. A plurality of APP Group IDs may be managed, and the UE 10A may belong to a plurality of groups.

### 3.2.2 Structure of ProSe Server

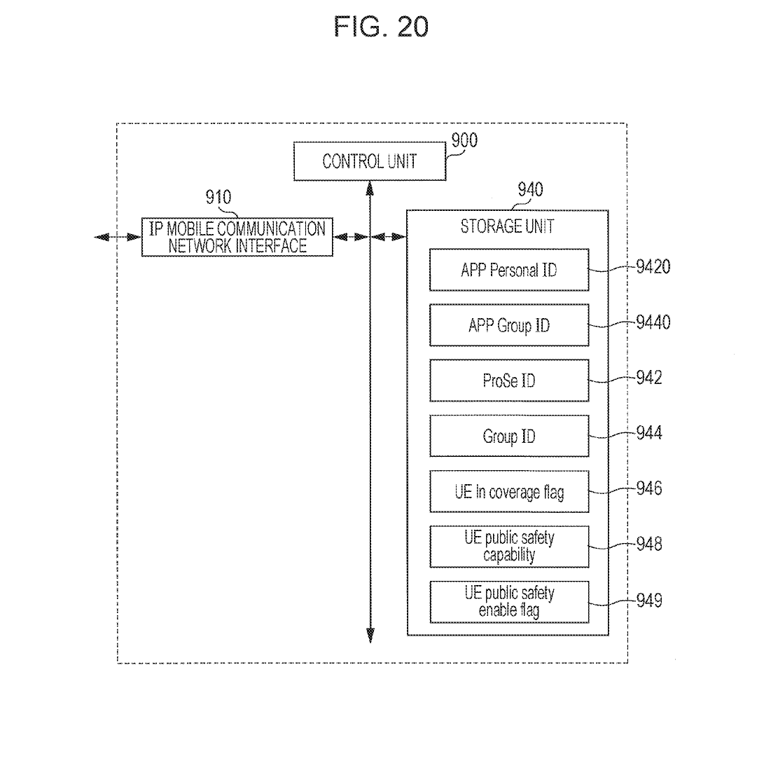

FIG. 20 shows the structure of the ProSe server 90 according to the third embodiment. In the third embodiment, in the ProSe server 90, a different identifier is managed in the storage unit 140. Specifically, the storage unit 140 adds and manages APP Personal ID 9420, and APP group ID 9440. Except for the APP Personal ID 9420 and the APP Group ID 9440 in the storage unit 140, the third embodiment is the same structure as those of the first embodiment and the second embodiment, and thus, the detailed description thereof will be omitted.

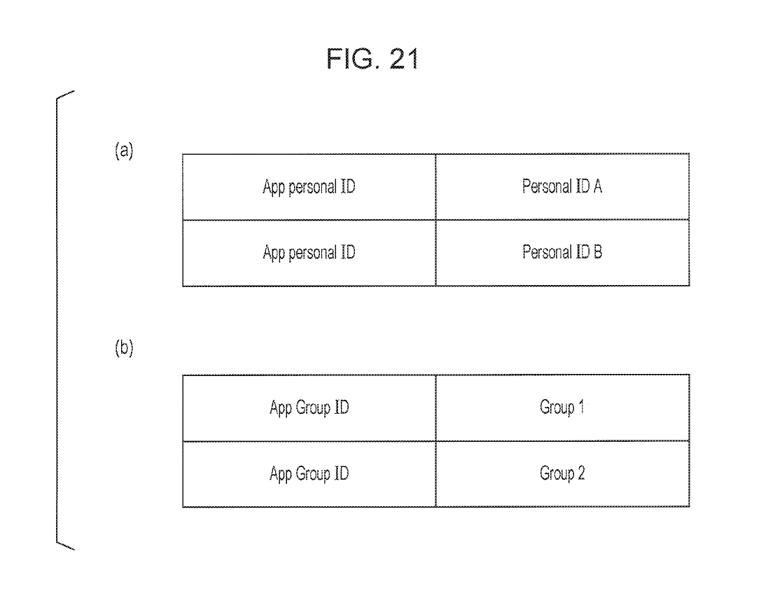

FIG. 21(a) shows an example of the APP Personal ID 9420. In FIG. 21(a), an identifier (APP Personal ID A) for identifying the UE 10A, and an identifier (APP Personal ID B) for identifying the UE 10B are managed. The APP Personal ID 9420 may be managed for each application. That is, the APP Personal ID 9420 may be managed for each APP.

FIG. 21(b) shows an example of the APP Group ID 9440. The APP Group ID 9440 manages an identifier for identifying a group managed by the ProSe server 90. The ProSe server 90 can restrict the UE which performs the proximity discovery or the direct communication by the APP Group ID 9440. In FIG. 21(b), the APP Group ID 9440 manages Group 1 and Group 2. A plurality of APP Group IDs may be managed.

### 3.3 Description of Process

### 3.3.1 Proximity Discovery Procedure

### 3.3.1.1 Proximity Discovery Procedure 1

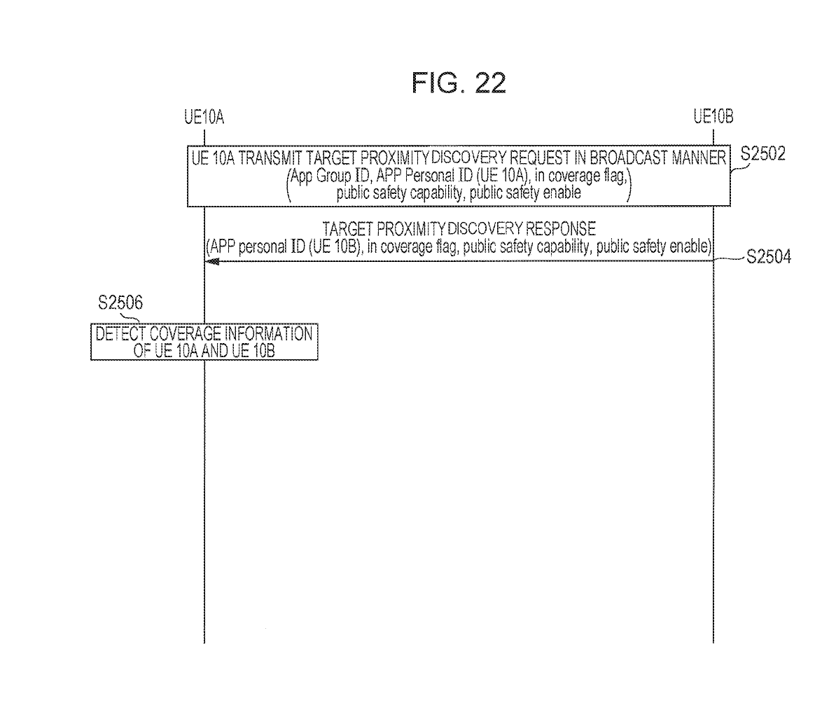

A proximity discovery procedure according to the third embodiment will be described with reference to FIG. 22. Initially, The UE 10A as a communication source transmits a target proximity discovery request to the UE 10B in a broadcast manner (S2502). The proximity discovery request includes APP Group ID 1420, APP Personal ID (UE 10A), in coverage flag 147, public safety capability 148, and public safety enable 149.

Here, the in coverage flag 147 includes information indicating that the UE 10A is served in the LTE base station (In coverage) (or this UE is not served in the LTE base station (Out of coverage)).

Here, the in coverage flag 147 includes information indicating that the UE 10A is served in the LTE base station (In coverage) (or this UE is not served in the LTE base station (Out of coverage)).

The public safety capability 148 is information indicating that the UE retains the function of the public safety, and here, since the UE 10A retains the function of the public safety, this UE notifies that the public safety capability is “usable”.

The public safety enable flag 149 is information indicating that the UE enables the public safety, and here, since the UE 10A enables the public safety, this UE notifies that the public safety enable is turned “on”.

The UE 10B which has received the target proximity discovery request checks the in coverage flag 147, the public safety capability 148 and the public safety enable flag 149 of the UE 10A.

The UE 10B can detect that this UE and the UE 10A are in any one of four states. Specifically, it is possible to detect that these UEs are in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

The proximity discovery request transmitted from the UE 10A may be continuously transmitted every predetermined time interval. The proximity discovery request may be transmitted whenever the in coverage flag 147 is updated. Here, even after the proximity discovery request is detected by the UE 10B, the UE 10A may continue to transmit the signal for the proximity discovery every predetermined time interval. The in coverage flag 147 is transmitted by being updated and being included in a discovery request signal depending on a situation in coverage or out of coverage at a point of time of the transmission.

The UE 10B may add the identification information indicating the capability information of the UE 10B capable of establishing the direct communication path in the LTE Direct. The UE 10B may add the identification information indicating the capability information of the UE 10B capable of establishing the direct communication path in the WLAN Direct.

The UE 10B which has checked that the direct communication with the UE 10A is performed transmits the target proximity discovery response to the UE 10A (S2504). This response includes the in coverage flag 147, the public safety capability 148 and the public safety enable flag 149 of the UE 10B. The in coverage flag 147 includes information indicating that the UE 10A is served in the LTE base station (In coverage) (or this UE is not served in the LTE base station (Out of coverage)).

Here, the in coverage flag 147 includes information indicating that the UE 10A is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”. The UE 10A may detect that the UE 10B can use the LTE Direct by the identification information indicating the capability information of the UE 10B capable of establishing the direct communication path in the LTE Direct. The UE 10A may detect that the UE 10B can use the WLAN Direct by the identification information indicating the capability information of the UE 10B capable of establishing the direct communication path in the WLAN Direct.

The UE 10A which has received the target proximity discovery response detects the coverage information between the UE 10A and the UE 10B (S2506). In this case, as shown in FIG. 10, it is possible to select the communication path establishment procedure by detecting that the coverage information of the UE 10A and the UE 10B detected in the UE 10A is in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

The transmission (S2502) of the broadcast transmitted to the UE 10B from the UE 10A may be performed in a unicast manner by using a previously acquired communication resource. Alternatively, the transmission (S2502) of the broadcast transmitted to the UE 10A from the UE 10B may be performed in a unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

The transmission (S2504) of the broadcast transmitted to the UE 10A from the UE 10B may be performed in a unicast manner by using a previously acquired communication resource. Alternatively, the transmission (S2504) of the broadcast transmitted to the UE 10B from the UE 10A may be performed in a unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

Through the above-described procedure, the UE 10A can detect the coverage information in the UE 10A and the UE 10B. That is, it is possible to detect that these UEs are in any one state of four states of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

In the proximity discovery procedure, the UE 10A detects the coverage information in the UE 10A and the UE 10B, and a communication path establishment procedure is performed based on the coverage information. Specifically, different communication path establishment procedures are performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

### 3.3.1.2 Proximity Discovery Procedure 2

Proximity Discovery Procedure 2 will be described. A difference from Proximity Discovery Procedure 1 is that the authentication of challenge and response is used. In the second embodiment, it is possible to authenticate the communication source UE and the communication destination UE by using the challenge and response.

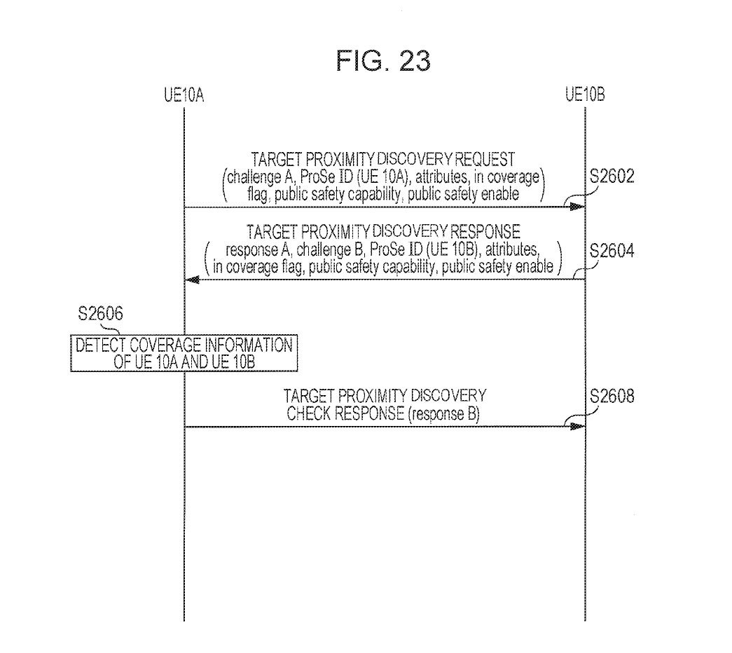

Proximity discovery Procedure 2 will be described with reference to FIG. 23. Initially, the UE 10A transmits a target proximity discovery request to the UE 10B (S2602). The target proximity discovery request includes challenge A, ProSe ID (UE 10A) 142, information indicating attributes, in coverage flag 147, public safety capability 148 and public safety enable 149.

Here, the challenge A is authentication request information for authenticating the challenge and response. The information indicating attributes is information indicating the classification of the application which performs the direct communication.

The in coverage flag 147 includes information indicating that the UE 10A is served in the LTE base station (In coverage) (or this UE is not served in the LTE base station (Out of coverage)).

The in coverage flag 147 includes information indicating that the UE 10A is served in the LTE base station (In coverage) (or this UE is not served in the LTE base station (Out of coverage)).

The public safety capability 148 is information indicating that the UE retains the function of the public safety, and here, since the UE 10A retains the function of the public safety, this UE notifies that the public safety capability is “usable”.

The public safety enable flag 149 is information indicating that the UE enables the public safety, and here, since the UE 10A enables the public safety, this UE notifies that the public safety enable is turned “on”.

The UE 10B which has received the target proximity discovery request checks the challenge A, the ProSe ID (UE 10A), the information indicating attributes, the in coverage flag 147, the public safety capability 148 and the public safety enable flag 149 of the UE 10A.

The UE 10B can detect that this UE and the UE 10A are in any one of four states. Specifically, it is possible to detect that these UEs are in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

The UE 10B authenticates the challenge A from the UE 10A, and checks that the direct communication is performed. This UE detects the classification of the application by using the information indicating attributes.

The target proximity discovery request transmitted from the UE 10A may be continuously transmitted every predetermined time interval. The target proximity discovery request may be transmitted whenever the in coverage flag 147 is updated. Here, even after the target proximity discovery request is detected by the UE 10B, the UE 10A may continue to transmit the signal for the proximity discovery every predetermined time interval. The in coverage flag 147 is transmitted by being updated and being included in a discovery request signal depending on a situation in coverage or out of coverage at a point of time of the transmission.

The UE 10B may add the identification information indicating the capability information of the UE 10B capable of establishing the direct communication path in the LTE Direct. The UE 10B may add the identification information indicating the capability information of the UE 10B capable of establishing the direct communication path in the WLAN Direct.

The UE 10B which has checked that the direct communication with the UE 10A is performed transmits the target proximity discovery response to the UE 10A (S2604). This response includes response A, challenge B, ProSe ID (UE 10B), information indicating attributes, the in coverage flag 147, the public safety capability 148 and the public safety enable flag 149 of the UE 10B.

Here, the response A is a response of the challenge A transmitted from the UE 10A, and is information indicating that the authentication request from the UE 10A is authenticated. The challenge B is authentication request information for authenticating the challenge and response. The information indicating attributes is information indicating the classification of the application which performs the direct communication, and information transmitted from the UE 10A may be used as the information indicating attributes.

The in coverage flag 147 includes information indicating that the UE 10A is served in the LTE base station (In coverage) (or this UE is not served in the LTE base station (Out of coverage)).

The in coverage flag 147 includes information indicating that the UE 10A is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The UE 10A may detect that the UE 10B can use the LTE Direct by the identification information indicating the capability information of the UE 10B capable of establishing the direct communication path in the LTE Direct. The UE 10A may detect that the UE 10B can use the WLAN Direct by the identification information indicating the capability information of the UE 10B capable of establishing the direct communication path in the WLAN Direct.

The UE 10A which has received the target proximity discovery response detects the coverage information between the UE 10A and the UE 10B (S2606). In this case, as shown in FIG. 10, it is possible to select the communication path establishment procedure by detecting that the coverage information of the UE 10A and the UE 10B detected in the UE 10A is in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

The UE 10A receives the response A, and checks that the authentication is obtained from the UE 10B. This UE receives the challenge B, checks that the direct communication with the UE 10B is performed, and performs authentication.

Subsequently, the UE 10A which has authenticated the challenge B transmits a target proximity discovery check response to the UE 10B (S2608). Here, the UE 10A adds the response B to the target proximity discovery check response. The response B is a response of the challenge B transmitted from the UE 10B.

The UE 10B which has received the target proximity discovery response from the UE 10A checks that the UE 10B can perform the direct communication with the UE 10A by receiving the response B which is a target of the challenge B.

The target proximity discovery request (S2602) transmitted to the UE 10B from the UE 10A may be transmitted in a broadcast or unicast manner by using the acquired resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

The target proximity discovery request (S2604) transmitted to the UE 10A from the UE 10B may be performed in a broadcast or unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B. Through the above-described procedure, the UE 10A can detect the coverage information in the UE 10A and the UE 10B. That is, it is possible to detect that these UEs are in any one state of four states of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

In the proximity discovery procedure, the UE 10A detects the coverage information in the UE 10A and the UE 10B, and a communication path establishment procedure is performed based on the coverage information. Specifically, different communication path establishment procedures are performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

### 3.3.1.3 Proximity Discovery Procedure 3

Proximity Discovery Procedure 3 will be described. The target proximity discovery request for performing the proximity discovery on the specific UE is used in Proximity Discovery Procedure 1 and Proximity Discovery Procedure 2, whereas a non-target proximity discovery request for performing the proximity discovery on a specific UE is used in this proximity discovery procedure.

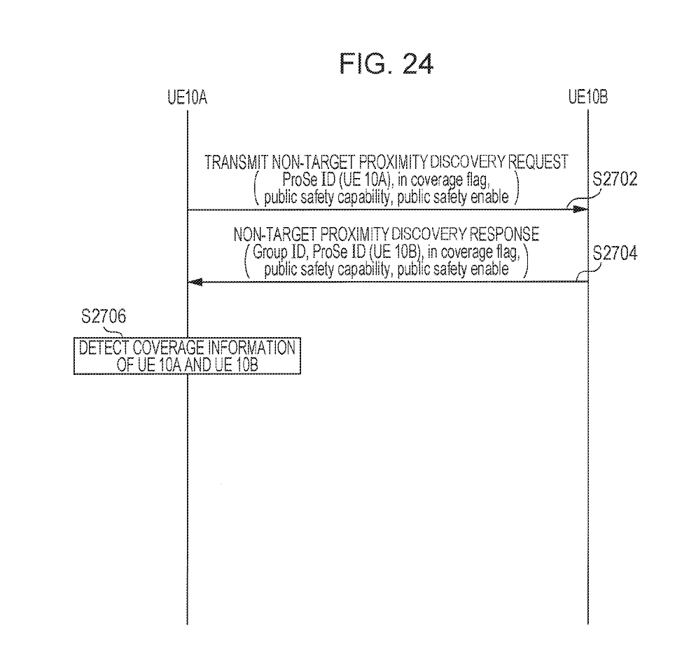

Proximity Discovery Procedure 3 according to the third embodiment will be described with reference to FIG. 24. Initially, The UE 10A as a communication source transmits a non-target proximity discovery request to proximity terminals including the UE 10B in a broadcast manner (S2702). The proximity discovery request includes ProSe ID (UE 10A), in coverage flag 147, public safety capability 148, and public safety enable 149.

Here, the in coverage flag 147 includes information indicating that the UE 10A is served in the LTE base station (In coverage) (or this UE is not served in the LTE base station (Out of coverage)).

Here, the in coverage flag 147 includes information indicating that the UE 10A is served in the LTE base station (In coverage) (or this UE is not served in the LTE base station (Out of coverage)).

The public safety capability 148 is information indicating that the UE retains the function of the public safety, and here, since the UE 10A retains the function of the public safety, this UE notifies that the public safety capability is “usable”.

The public safety enable flag 149 is information indicating that the UE enables the public safety, and here, since the UE 10A enables the public safety, this UE notifies that the public safety enable is turned “on”.

The UE 10B which has received the non-target proximity discovery request checks the in coverage flag 147, the public safety capability 148 and the public safety enable flag 149 of the UE 10A.

The UE 10B can detect that this UE and the UE 10A are in any one of four states. Specifically, it is possible to detect that these UEs are in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

The non-target proximity discovery request transmitted from the UE 10A may be continuously transmitted every predetermined time interval. The non-target proximity discovery request may be transmitted whenever the in coverage flag 147 is updated. Here, even after the non-target proximity discovery request is detected by the UE 10B, the UE 10A may continue to transmit the signal for the proximity discovery every predetermined time interval. The in coverage flag 147 is transmitted by being updated and being included in a discovery request signal depending on a situation in coverage or out of coverage at a point of time of the transmission.

The UE 10A may add the identification information indicating the capability information of the UE 10A capable of establishing the direct communication path in the LTE Direct. The UE 10A may add the identification information indicating the capability information of the UE 10A capable of establishing the direct communication path in the WLAN Direct.

The UE 10B which has checked that the direct communication with the UE 10A is performed transmits the target proximity discovery response to the UE 10A (S2704). This response includes the in coverage flag 147, the public safety capability 148 and the public safety enable flag 149 of the UE 10B. The in coverage flag 147 includes information indicating that the UE 10A is served in the LTE base station (In coverage) (or this UE is not served in the LTE base station (Out of coverage)).

The in coverage flag 147 includes information indicating that the UE 10A is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The UE 10B may detect that the UE 10A can use the LTE Direct by the identification information indicating the capability information of the UE 10A capable of establishing the direct communication path in the LTE Direct. The UE 10B may detect that the UE 10A can use the WLAN Direct by the identification information indicating the capability information of the UE 10A capable of establishing the direct communication path in the WLAN Direct.

The UE 10A which has received the non-target proximity discovery response detects the coverage information between the UE 10A and the UE 10B (S2706). In this case, as shown in FIG. 10, it is possible to select the communication path establishment procedure by detecting that the coverage information of the UE 10A and the UE 10B detected in the UE 10A is in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

The non-target proximity discovery request (S2602) transmitted to the UE 10B from the UE 10A may be performed in a broadcast or unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

The non-target proximity discovery request (S2604) transmitted to the UE 10A from the UE 10B may be performed in a broadcast or unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

Through the above-described procedure, the UE 10A can detect the coverage information in the UE 10A and the UE 10B. That is, it is possible to detect that these UEs are in any one state of four states of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

In the proximity discovery procedure, the UE 10A detects the coverage information in the UE 10A and the UE 10B, and a communication path establishment procedure is performed based on the coverage information. Specifically, different communication path establishment procedures are respectively performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage. The communication path establishment procedure is performed by the same method as the method described in the first embodiment, and thus, the detailed description thereof will be omitted.

As stated above, it can be detected that the communication source UE and the communication destination UE are served in the LTE base station. In a case where the communication source UE or the communication destination UE is served in the LTE station, it is possible to perform the communication path establishment procedure under the control of the mobile communication provider.

In a case where the communication source UE and the communication destination UE are not served in the LTE base station, it is possible to perform the communication path establishment procedure without obtaining the authentication of the mobile communication provider whenever the communication path is established.

### 4. Fourth Embodiment

Hereinafter, a fourth embodiment will be described. The fourth embodiment is different from the first embodiment, the second embodiment and the third embodiment in that the structure of the device is different. In order to perform the proximity discovery, not a method of performing proximity discovery on another UE in the UE but a method of performing proximity discovery in the network of the mobile communication provider and notifying the UE is used.

### 4.1 Outline of Mobile Communication System

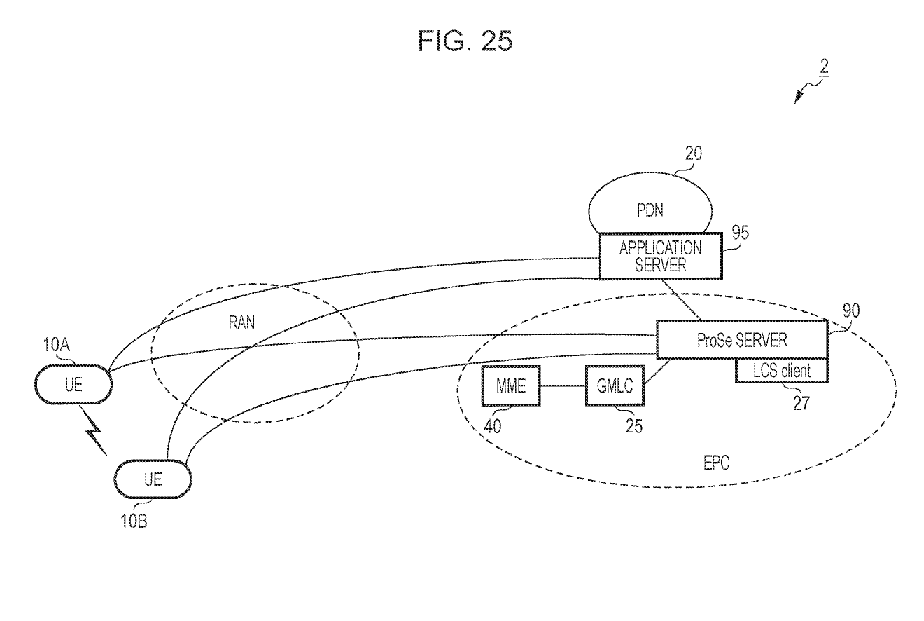

The outline of a mobile communication system according to the fourth embodiment will be described with reference to FIG. 25. As shown in this drawing, a mobile communication system 1 includes a UE (mobile station device) 10A, a UE (mobile station device) 10B, and a PDN (Packet Data Network) 20, which are connected via a RAN or an EPC. The RAN and the EPC are established by ADSL (Asymmetric Digital Subscriber Line) or optical fiber. The RAN and the EPC is not limited to the above example, but may be a wireless access network such as LTE (Long Term Evolution), WLAN (Wireless WLAN), or WiMAX (Worldwide Interoperability for Microwave Access).

Here, in the EPC, a GMLC 25, a MME 40 and a ProSe server 90 are arranged. The GMLC (Gateway Mobile Location Center) 25 is a device which acquires and manages positional information of the UE.

The ProSe server 90 retains the function of a LCS client 27. In the PDN 20, an application server 95 is disposed. Here, the ProSe server 90 is an authentication server managed by the mobile communication provider of the network in which the UE 10A or the UE 10B performs proximity discovery. The ProSe server 90 may be a part of the function of the MME 40.

Since the ProSe server 90 retains the LCS Client, the ProSe server can request the positional information from the GMLC 25, and can acquire the positional information from the GMLC 25.

The application server 95 is a server that provides a service of an application (APP 1) used by the UE 10A or the UE 10B.

The ProSe server 90 and the application server 95 may be included in the PDN 20, or may be included in a core network 7.

The UE 10A and the UE 10B may be connected to a network of the same mobile communication provider, or may be connected to networks of different mobile communication providers within a unitary state.

The PDN 20 refers to a network that provides a network service for transmitting and receiving data in packets, and is, for example, the internet or an IMS.

The PDN 20 is connected to the EPC by using a wired line. For example, the PDN is established by ADSL (Asymmetric Digital Subscriber Line) or an optical fiber. However, the PDN is not limited to the above example, but may be a wireless access network such as LTE (Long Term Evolution), WLAN (Wireless LAN), or WiMAX (Worldwide Interoperability for Microwave Access).

The UE 10A, the UE 10B, the ProSe server 90, the application server 95 and the MME 40 have the same structures as those described in the first embodiment, and thus, the description thereof will be omitted. The GMLC 25 and the LCS client 27 are devices which have been used in the related art, and thus, the detailed description thereof will be omitted.

### 4.3.1 Proximity Discovery Procedure

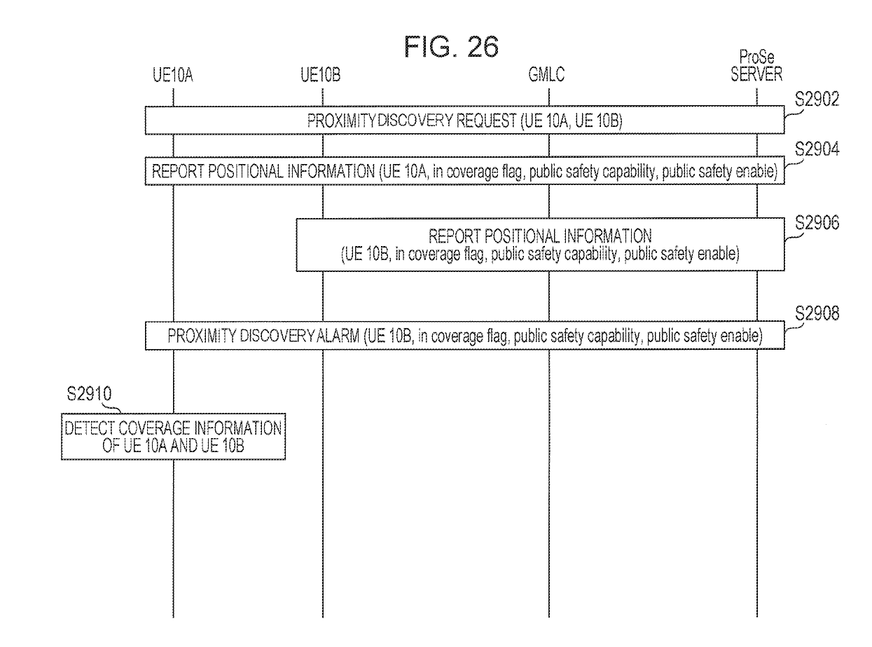

A proximity discovery procedure according to the present embodiment will be described with reference to FIG. 26. The ProSe server 90 may be the MME 40. Initially, the UE 10A performs a proximity discovery request to the ProSe server 90 (S2902). Here, the UE 10A adds identifiers of the UE 10A and the UE 10B to the proximity discovery request. The identifiers of the UE 10A and the UE 10B may be ProSe ID 142 or APP Personal ID 1420.

Subsequently, the UE 10A reports the positional information to the GMLC 25 (S2904). Here, the report of the positional information includes public safety enable 149, public safety capability 148, in coverage flag 147, and the identifier of the UE 10A. The report of the positional information may be transmitted at a predetermined timing, or may be notified by detecting that the UE 10A moves.

The UE 10A may add identification information indicating capability information of the UE 10A capable of establishing a direct communication path in the LTE Direct. The UE 10A may add identification information indicating capability information of the UE 10A capable of establishing a direct communication path in the WLAN Direct.

Meanwhile, the GMLC 25 which has received the report of the positional information may detect that the UE 10A can use the LTE Direct by the identification information indicating the capability information of the UE 10A capable of establishing a direct communication path in the LTE Direct. The GMLC 25 may detect that the UE 10A can use the LTE Direct by the identification information indicating the capability information of the UE 10A capable of establishing the direct communication path in the WLAN Direct.

Thereafter, the UE 10B reports the positional information to the GMLC 25 (S2906). Here, The public safety enable 149, the public safety capability 148, the in coverage flag 147, and the identifier of the UE 10B are added. The report of the positional information may be transmitted at the predetermined timing, or may be notified by detecting that the UE 10B moves. The positional information may be notified by the inquiry from the ProSe server 90. The GMLC 25 manages the positional information by the report from the UE 10A and the UE 10B.

The UE 10B may add identification information indicating capability information of the UE 10B capable of establishing a direct communication path in the LTE Direct. The UE 10B may add identification information indicating capability information of the UE 10B capable of establishing a direct communication path in the WLAN Direct.

The ProSe server 90 which has received the proximity discovery request from the UE 10A in S2902 transmits a proximity discovery alarm to the UE 10A (S2908). Here, the ProSe server 90 requests the positional information of the UE 10A and the UE 10B from the GMLC 25, and detects the positional information of the UE 10A and the UE 10B from the GMLC 25. The ProSe server 90 may detect that the UE 10A and the UE 10B are in proximity by using the positional information of the UE 10A and the UE 10B, and may notify the UE 10A that the UE 10A and the UE 10B are in proximity. Here, the ProSe server 90 may detect that the UE 10A and the UE 10B are in proximity, and may notify the UE 10B. Here, the proximity discovery alarm includes the public safety enable flag 149, the public safety capability 148 and the in coverage flag 147 of the UE 10B. The in coverage flag 147 may include information indicating that the UE 10A is served in the LTE base station (In coverage) (or this UE is not served in the LTE base station (Out of coverage)).

Here, the in coverage flag 147 may include information indicating that the UE 10A is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The GMLC 25 which has received the report of the positional information may detect that the UE 10B can use the LTE Direct by the identification information indicating capability information of the UE 10B capable of establishing a direct communication path in the LTE Direct. The GMLC 25 may detect that the UE 10B can use the WLAN Direct by the identification information indicating capability information of the UE 10B capable of establishing a direct communication path in the WLAN Direct.

The UE 10A which has received the proximity discovery alarm detects the coverage information between the UE 10A and the UE 10B (S2910). In this case, as shown in FIG. 10, it is possible to select the communication path establishment procedure by detecting that the coverage information of the UE 10A and the UE 10B detected in the UE 10A is in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

Through the above-described procedure, the UE 10A can detect the coverage information in the UE 10A and the UE 10B. That is, it is possible to detect that these UEs are in any one state of four states of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

In the proximity discovery procedure, the UE 10A detects the coverage information in the UE 10A and the UE 10B, and a communication path establishment procedure is performed based on the coverage information. Specifically, different communication path establishment procedures are performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage. The communication path establishment procedure is the same method as the method described in the first embodiment, and thus, the detailed description will be omitted.

Through the above description, it is possible to detect that the communication source UE and the communication destination UE are served in the LTE base station. In a case where the communication source UE or the communication destination UE is served in the LTE base station, it is possible to perform the communication path establishment procedure under the control of the mobile communication provider.

In a case where the communication source UE and the communication destination UE are not served in the LTE base station, it is possible to perform the communication path establishment procedure without obtaining the authentication of the mobile communication provider whenever the communication path is established.

### 5. Fifth Embodiment

Hereinafter, a fifth embodiment will be described. The fifth embodiment is different from the first embodiment, the second embodiment, the third embodiment and the fourth embodiment in that a proximity discovery procedure is different. In the proximity discovery procedure according to the fifth embodiment, in order to transmit a proximity discovery request, a radio resource of the proximity discovery is acquired. In order to transmit to the response of the proximity discovery request, a radio resource of the proximity discovery is acquired. In the present embodiment, since the structure of the mobile communication system of FIG. 1 is used, and thus, the detailed description thereof will be omitted. The structure of the UE, the structure of the ProSe server or the structure of the APP server are the same those in the mobile communication system, and thus, the detailed description thereof will be omitted.

### 5.3 Description of Process

### 5.3.1 Proximity Discovery Procedure

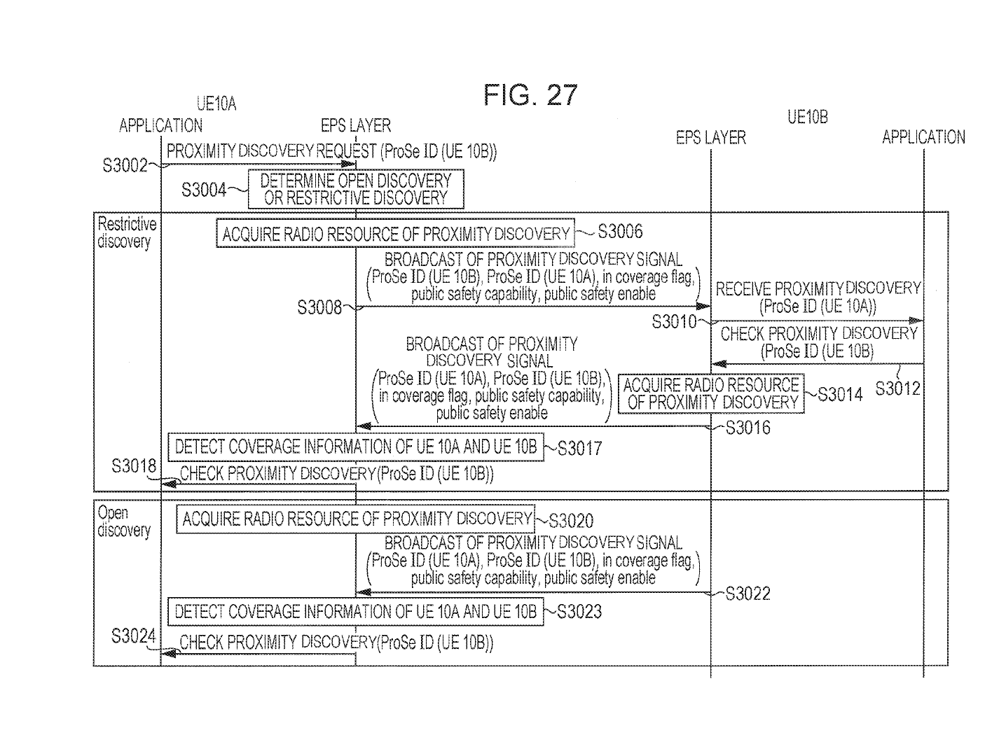

A proximity discovery procedure will be described with reference to FIG. 27. Initially, the application of the UE 10A notifies the EPS layer of the proximity discovery request (S3002). Here, the proximity discovery request notifies of an identifier indicating the UE 10B which is a target subjected to the proximity discovery.

Subsequently, the EPS layer of the UE 10A determines whether or not to perform Open discovery or Restrictive discovery (S3004). This determination may be performed depending on the target subjected to the proximity discovery.

### 5.3.1.1 Restrictivity Discovery

Initially, the Restrictivity discovery will be described. The UE 10A which has detected that the Restrictivity discovery is performed initially acquires the radio resource for performing the proximity discovery (S3006). As a method of acquiring the radio resource, various methods are considered. For example, the radio resource may be acquired from information included in the information transmitted from the eNB 45. Alternatively, the UE 10A may inquire of the eNB 45, and thus, the radio resource may be acquired.

Subsequently, the UE 10A transmits a proximity discovery signal in a broadcast manner (S3008). Here, the proximity discovery signal includes ProSe ID (UE 10B), ProSe ID (UE 10A), in coverage flag 147, public safety capability 148, and public safety enable 149.

Here, the in coverage flag 147 may include information indicating that the UE 10A is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE can use the public safety. Here, since the UE 10A enables the public safety, this UE may notify that the public safety enable is turned “on”.

The UE 10B which has received the target proximity discovery request checks the public safety enable flag 149, the public safety capability 148, and the in coverage flag 147 of the UE 10A.

The UE 10B can detect that this UE and the UE 10A are in any one of four states. Specifically, it is possible to detect that these UEs are in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

The proximity discovery signal transmitted from the UE 10A may be continuously transmitted every predetermined time interval. The proximity discovery signal may be transmitted whenever the in coverage flag 147 is updated. Here, even after the proximity discovery signal is detected by the UE 10B, the UE 10A may continue to transmit the signal for the proximity discovery every predetermined time interval. The in coverage flag 147 is transmitted by being updated and being included in a discovery request signal depending on a situation in coverage or out of coverage at a point of time of the transmission.

The UE 10A may add the identification information indicating the capability information of the UE 10A capable of establishing the direct communication path in the LTE Direct. The UE 10A may add the identification information indicating the capability information of the UE 10A capable of establishing the direct communication path in the WLAN Direct.

Meanwhile, the UE 10B may detect that the UE 10A can use the LTE Direct by the identification information indicating the capability information of the UE 10A capable of establishing the direct communication path in the LTE Direct. The UE 10B may detect that the UE 10A can use the WLAN Direct by the identification information indicating the capability information of the UE 10A capable of establishing the direct communication path in the WLAN Direct.

Subsequently, the EPS layer of the UE 10B notifies the application that the proximity discovery is performed (S3010). The application of the UE 10B checks whether or not the response of the proximity discovery may be transmitted, and notifies the EPS layer of the UE 10B of the check of the proximity discovery (S3012).

The EPS layer of the UE 10 which has been notified of the check of the proximity discovery acquires the radio resource for transmitting the response of the proximity discovery (S3014). As a method of acquiring the radio resource, various methods are considered. For example, the radio resource may be acquired from information included in the information regularly transmitted from the eNB 45. Alternatively, the UE 10A may inquire of the eNB 45, and thus, the radio resource may be acquired.

Thereafter, the UE 10B transmits a proximity discovery signal in a broadcast manner (S3016). Here, the proximity discovery signal includes ProSe ID (UE 10B), ProSe ID (UE 10A), in coverage flag 147, public safety capability 148, and public safety enable 149.

Here, the in coverage flag 147 includes information indicating that the UE 10A is served in the LTE base station (In coverage) (or this UE is not served in the LTE base station (Out of coverage)).

The public safety capability 148 is information indicating that the UE retains the function of the public safety, and here, since the UE 10A retains the function of the public safety, this UE notifies that the public safety capability is “usable”.

The public safety enable flag 149 is information indicating that the UE enables the public safety, and here, since the UE 10A enables the public safety, this UE notifies that the public safety enable is turned “on”.

The proximity discovery signal transmitted from the UE 10B may be transmitted every predetermined time interval. The proximity discovery signal may be transmitted whenever the in coverage flag 147 is updated. Here, even after the proximity discovery signal is detected by the UE 10B, the UE 10A may continue to transmit the signal for the proximity discovery every predetermined time interval. The in coverage flag 147 is transmitted by being updated and being included in a discovery request signal depending on a situation in coverage or out of coverage at a point of time of the transmission.

The UE 10B may add the identification information indicating the capability information of the UE 10B capable of establishing the direct communication path in the LTE Direct. The UE 10B may add the identification information indicating the capability information of the UE 10B capable of establishing the direct communication path in the WLAN Direct.

Meanwhile, the UE 10A may discover that the UE 10B can use the LTE Direct by the identification information indicating the capability information of the UE 10B capable of establishing the direct communication path in the LTE Direct. The UE 10A may discover that the UE 10B can use the WLAN Direct by the identification information indicating the capability information of the UE 10B capable of establishing the direct communication path in the WLAN Direct.

The UE 10A which has received the proximity discovery signal in the broadcast detects the coverage information of the UE 10A and the UE 10B (S3017). That is, this UE checks the public safety enable flag 149, the public safety capability 148, and the in coverage flag 147 of the UE 10A.

The UE 10A can detect that this UE and the UE 10A are in any one state of the four states. Specifically, it is possible to detect that these UEs are in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

Thereafter, the EPS layer of the UE 10A notifies the application of the UE 10A of the check of the proximity discovery (S3018). Here, the check of the proximity discovery includes ProSe ID (UE 10B).

The transmission (S3008) of the broadcast transmitted to the UE 10B from the UE 10A may be performed in a unicast manner by using a previously acquired communication resource. Alternatively, the transmission (S3008) of the broadcast transmitted to the UE 10A from the UE 10B may be performed in a unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

The transmission (S3016) of the broadcast transmitted to the UE 10A from the UE 10B may be performed in a unicast manner by using a previously acquired communication resource. Alternatively, the transmission (S3016) of the broadcast transmitted to the UE 10B from the UE 10A may be performed in a unicast manner by using a previously acquired communication resource. Here, the acquired communication resource is a communication resource capable of being used to allow a specific UE to perform the discovery, and may be assigned by being explicitly notified from the eNB 45 or the MME 40 or may be used by being previously notified to the UE 10A or the UE 10B.

Through the above-described procedure, the UE 10A can detect the coverage information in the UE 10A and the UE 10B. That is, it is possible to detect that these UEs are in any one state of four states of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

In the proximity discovery procedure, the UE 10A detects the coverage information in the UE 10A and the UE 10B, and a communication path establishment procedure is performed based on the coverage information. Specifically, different communication path establishment procedures are performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage. The communication path establishment procedure is the same method as the method described in the first embodiment, and thus, the detailed description will be omitted.

### 5.3.1.2 Open Discovery

The Open discovery will be described. In the Open discovery, the proximity discovery can be performed not in a such a manner that the proximity discovery signal is transmitted in the broadcast manner by acquiring of the UE which is a target of the proximity discovery but in such a manner that the proximity discovery signal is regularly transmitted from the UE which is a target of the proximity discovery and the proximity discovery signal is received. The EPS layer of the UE 10A which has determined to perform the Open discover acquires the radio resource of the proximity discovery (S3020). Here, the radio resource of the proximity discovery is information related to the proximity discovery signal regularly transmitted from the UE 10B. As a method of acquiring the radio resource, various methods are considered. For example, the radio resource may be acquired from information included in the information transmitted from the eNB 45. Alternatively, the UE 10A may inquire of the eNB 45, and thus, the radio resource may be acquired.

Subsequently, the UE 10A detects the UE 10B which is a target of the proximity discovery by using the radio resource received in S3020 (S3022). Here, the proximity discovery signal transmitted from the UE 10B includes ProSe ID (UE 10B), in coverage flag 147, public safety capability 148, and public safety enable 149.

Here, the in coverage flag 147 may include information indicating that the UE 10A is served in the LTE base station (In coverage) (or this UE is not served in the LTE base station (Out of coverage)).

Here, the in coverage flag 147 may include information indicating that the UE 10A is served in the LTE base station (In coverage) (or this UE is not served in the LTE base station (Out of coverage)).

The public safety capability 148 is information indicating that the UE retains the function of the public safety. Here, since the UE 10A retains the function of the public safety, this UE may notify that the public safety capability is “usable”.

The public safety enable flag 149 is information indicating that the UE enables the public safety, and here, since the UE 10A enables the public safety, this UE notifies that the public safety enable is turned “on”.

The UE 10A which has received the proximity discovery signal (broadcast) detects the coverage information of the UE 10A and the UE 10B (S3017). That is, this UE checks the public safety enable flag 149, the public safety capability 148, and the in coverage flag 147 of the UE 10B.

The UE 10A can detect that this UE and the UE 10B are in any one of four states. Specifically, it is possible to detect that these UEs are in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, it may be determined that it is difficult to perform the direct communication in a case where the public safety capability of the UE 10B is “unusable” and the in coverage flag of the UE 10B is out of coverage. It may be determined that it is difficult to perform the direct communication in a case where the public safety enable flag of this UE is turned “off” and the in coverage flag of this UE is out of coverage.

The UE 10B may add the identification information indicating the capability information of the UE 10B capable of establishing the direct communication path in the LTE Direct. The UE 10B may add the identification information indicating the capability information of the UE 10B capable of establishing the direct communication path in the WLAN Direct.

Meanwhile, the UE 10A may detect that the UE 10B can use the LTE Direct by the identification information indicating the capability information of the UE 10B capable of establishing the direct communication path in the LTE Direct. The UE 10A may detect that the UE 10B can use the WLAN Direct by the identification information indicating the capability information of the UE 10B capable of establishing the direct communication path in the WLAN Direct.

The UE 10A which has received the proximity discovery signal in the broadcast detects the coverage information of the UE 10A and the UE 10B (S3023). That is, this UE checks the public safety enable flag 149, the public safety capability 148, and the in coverage flag 147 of the UE 10A.

The UE 10A can detect that this UE and the UE 10A are in any one state of the four states. Specifically, it is possible to detect that these UEs are in any one state of one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

Here, it may be determined that it is difficult to perform the direct communication in a case where the public safety capability of the UE 10A is “unusable” and the in coverage flag of the UE 10A is out of coverage. It may be determined that it is difficult to perform the direct communication in a case where the public safety enable flag of this UE is turned “off” and the in coverage flag of this UE is out of coverage.

Thereafter, the EPS layer of the UE 10A notifies the application of the UE 10A of the check of the proximity discovery (S3024). Here, the check of the proximity discovery includes ProSe ID (UE 10B).

Through the above-described procedure, the UE 10A can detect the coverage information in the UE 10A and the UE 10B. That is, it is possible to detect that these UEs are in any one state of four states one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage.

In the proximity discovery procedure, the UE 10A detects the coverage information in the UE 10A and the UE 10B, and a communication path establishment procedure is performed based on the coverage information. Specifically, different communication path establishment procedures are performed in one state in which the UE 10A is in coverage and the UE 10B is in coverage, one state in which the UE 10A is out of coverage and the UE 10B is in coverage, one state in which the UE 10A is in coverage and the UE 10B is out of coverage, and one state in which the UE 10A is out of coverage and the UE 10B is out of coverage. The communication path establishment procedure is the same method as the method described in the first embodiment, and thus, the detailed description will be omitted.

As stated above, it can be detected that a communication source UE and a communication destination UE are served in the LTE base station. In a case where the communication source UE or the communication destination UE is served in the LTE station, it is possible to perform the communication path establishment procedure under the control of the mobile communication provider.

In a case where the communication source UE and the communication destination UE are not served in the LTE base station, it is possible to perform the communication path establishment procedure without obtaining the authentication of the mobile communication provider whenever the communication path is established.

### 6.1.1 Modification Example 1

Although the embodiments of the present invention have been described with reference to the drawings, the specific structures are not limited to the embodiments, but designs within the scope without departing from the gist of the present invention are included in the claims.

The programs which run on the devices according to the present embodiments may be programs which control a CPU (programs causing a computer to function) such that the functions of the above-described embodiments are implemented. The information handled by these devices is temporarily stored in a temporary storage device (for example, a RAM) during the process, and then is stored in a storage device of HDD or various ROMs. The information is read, corrected, and written by the CPU if necessary.

Here, as a recording medium that stores the programs, any one of a semiconductor medium (for example, ROM, or non-volatile memory card), an optical recording medium and a magneto-optical recording medium (for example, DVD (Digital Versatile Disc), MO (Magneto Optical Disc), MD (Mini Disc), CD (Compact Disc), or BD), or a magnetic recording medium (for example, magnetic tape, or flexible disc) may be used. The functions of the present invention may be realized by performing the process in cooperation with other application programs or an operating system based on the instruction of the program, in addition to realizing the functions of the aforementioned embodiments by executing the loaded program.

When the programs are distributed on the market, the programs may be distributed by being stored in a portable recording medium, or may be transmitted to a server computer connected via a network such as the Internet. In this case, a storage device of the server computer may be included in the present invention.

Some or all of the devices used in the aforementioned embodiments may be realized as LSIs (Large Scale Integrations) which are typical integrated circuits. Each functional block of each device may be individually integrated into a chip, or some or all of the functional blocks may be integrated into a chip. A method for achieving the integrated circuit is not limited to the LSI, but may be realized by a dedicated circuit or a general-purpose processor. In addition, in a case where a technique for achieving an integrated circuit which replaces the LSI technique will be developed with the progress of a semiconductor technique, the integrated circuit manufactured by the developed technique can also be used.

Although it has been described in the aforementioned embodiments that the LTE and the WLAN (for example, IEEE802.11a/b/n) are used as the wireless access network, WiMAX may be connected in place of the WLAN.

### REFERENCE SIGNS LIST

1 Mobile communication system
2 Mobile communication system 2
5 IP mobile communication network
10 UE
20 PDN
25 GMLC
27 LCS client
30 PGW
35 SGW
40 MME
45 eNB
50 HSS
55 AAA
60 PCRF
65 ePDG
70 WLAN ANa
72 WLAN APa
74 GW
75 WLAN ANb
76 WLAN APb
80 LTE AN
90 ProSe server
95 APP server

1. A communication control method of a first terminal device for causing the first terminal device and a second terminal device which is positioned in the proximity of the first terminal device to establish a direct communication path, the method comprising:
a step of monitoring a signal which is transmitted from the second terminal device so as to allow a proximity terminal device to discover the second terminal device;
a step of receiving the signal to detect that the second terminal device is positioned in proximity;
a step of acquiring coverage information which is included in the signal and indicates whether or not the second terminal device is served in a LTE base station; and
a step of detecting whether or not the second terminal device is served based on the coverage information.

2. The communication control method according to claim 1, further comprising:
in a case where it is detected that the second terminal device is served based on the coverage information,
a step of transmitting an establishment request for the direct communication path including information for requesting the acquisition of a resource of the direct communication path to the second terminal device.

3. The communication control method according to claim 1, further comprising:
in a case where it is detected that the second terminal device is not served based on the coverage information,
a step of transmitting an establishment request for the direct communication path to the second terminal device; and
a step of transmitting a request for a resource of the direction communication path to the LTE base station.

4. The communication control method according to claim 1, further comprising:
in a case where it is detected that the second terminal device is not served based on the coverage information,
a step of transmitting an establishment request for the direct communication path to the second terminal device; and
a step of transmitting a request for a resource of the direction communication path to a core network to which the serving LTE base station is connected.

5. The communication control method according to claim 1, further comprising:
a step of detecting whether or not the first terminal device is served in the LTE base station,
wherein, in a case where it is detected that both the first terminal device and the second terminal device are not served,
the communication control method further includes:
a step of assigning a resource previously retained in the first terminal device to the direct communication path; and
a step of transmitting an establishment request for the direct communication path including information related to the resource to the second terminal device.

6. The communication control method according to claim 1, further comprising:
a step of transmitting a signal for allowing a proximity terminal device to detect the first terminal device.

7. The communication control method according to claim 1,
wherein the request for the establishment of the direct communication path indicates that a direct communication path based on LTE is to be established.

8. The communication control method according to claim 1,
wherein the request for the establishment of the direct communication path indicates that a direct communication path based on a wireless LAN is to be established.

9. A terminal device that is a first terminal device for establishing a direct communication path with a second terminal device positioned in the proximity of the first terminal device, the first terminal device adapted to:
monitor a signal which is transmitted from the second terminal device to allow a proximity terminal device to discover the second terminal device;
receive the signal to detect that the second terminal device is positioned in proximity;
acquire coverage information which is included in the signal and indicates whether or not the second terminal device is served in a LTE base station; and
detect whether or not the second terminal device is served based on the coverage information.

10. The terminal device according to claim 9,
wherein, in a case where it is detected that the second terminal device is served based on the coverage information,
the first terminal device is adapted to transmit an establishment request for the direct communication path including information for requesting the acquisition of a resource of the direct communication path to the second terminal device.

11. The terminal device according to claim 9,
wherein, in a case where it is detected that the second terminal device is not served based on the coverage information,
the first terminal device is adapted to:
transmit an establishment request for the direct communication path to the second terminal device; and
transmit a request for a resource of the direct communication path to the LTE base station.

12. The terminal device according to claim 9,
wherein, in a case where it is detected that the second terminal device is not served based on the coverage information,
the first terminal device is adapted to:
transmit an establishment request for the direct communication path to the second terminal device; and
transmit a request for a resource of the direct communication path to a core network to which the serving LTE base station is connected.

13. The terminal device according to claim 9,
wherein the first terminal device is adapted to:
detect whether or not the first terminal device is served in a LTE base station,
wherein, in a case where it is detected that the first terminal device and the second terminal device are not served,
the first terminal device is adapted to:
assign a resource previously retained in the first terminal device to the direct communication path; and
transmit an establishment request for the direct communication path including information related to the resource to the second terminal device.

14. The terminal device according to claim 9,
wherein the first terminal device is adapted to transmit a signal for allowing a proximity terminal device to discover the first terminal device.

15. The terminal device according to claim 9,
wherein the request for establishing the direct communication path indicates that a direct communication path based on LTE is to be established.

16. The terminal device according to claim 9,
wherein the request for establishing the direct communication path indicates that a direct communication path based on a wireless LAN is to be established.

17. A base station apparatus included in a LTE access network, the base station apparatus adapted to:
manage a communication resource used for public safety and a communication resource used for commercially available service;
assign a communication resource based on identification information which is included in a message which is transmitted from a terminal device to request the permission for the establishment of the direct communication path and identifies whether or not to request the permission for the establishment of a communication path used for the public safety or whether or not to request the permission for the establishment of a communication path used for the commercially available service; and
notify the terminal device of information related to the communication resource.

18. The base station apparatus according to claim 17,
wherein, in a case where the identification information requests the establishment of the communication path used for the public safety,
the base station apparatus is adapted to assign a resource from the communication resource used for the public safety, and notify the terminal device of information related to the resource.

19. The base station apparatus according to claim 17,
wherein, in a case where the identification information requests the establishment of the communication path used for the commercially available service,
the base station apparatus is adapted to assign a resource from the communication resource used for the commercially available service, and notify the terminal device of information related to the resource.
